(19) United States
(12) Patent Application Publication
(10) Pub. No.: US 2013/0198466 A1
(43) Pub. Date: Aug. 1, 2013

(54) COMPUTER SYSTEM

(71) Applicants: Yasutaka Kono, Kawasaki (JP); Junichi Hara, Sagamihara (JP)

(72) Inventors: Yasutaka Kono, Kawasaki (JP); Junichi Hara, Sagamihara (JP)

(73) Assignee: Hitachi, Ltd.

(21) Appl. No.: 13/576,089

(22) PCT Filed: Jan. 27, 2012
(86) PCT No.: PCT/JP2012/051853

§ 371 Date: Jul. 30, 2012

(51) Int. Cl. G06F 12/16

(52) U.S. Cl. 711/161; 711/E12.103

(57) ABSTRACT

An embodiment of the invention is a computer system including one or more storage arrays providing a plurality of storage resources and a management system managing the one or more storage arrays. The management system stores configuration information of the plurality of storage resources. The management system specifies a non-applicable free storage resource for a configuration condition including one or more predesignated condition items in response to a predesignated event and records information of the specified free storage resource and a non-applicable reason in condition non-applicable storage resource information. The management system repeats the specifying and the recording in response to the predesignated event. The management system selects a free storage resource applicable to a predesignated unnecessary storage resource condition from the condition non-applicable storage resource information after the repetition as an unnecessary storage resource candidate.

### BACKGROUND

The present invention relates to a computer system and particularly to management of storage resources in a computer system.

An amount of data used by companies and individuals has been rapidly increasing in recent years. Thus, a computer system including a plurality of storage arrays in which technologies such as SAN (Storage Area Network) and NAS (Network Attached Storage) are used so as to connect storage arrays and host computers by switches or hubs and to enable flexible data management is widely used.

Moreover, with complication of the computer system, reduction of an operating cost of a computer system has become an important problem in recent years. As a method of solving this problem, integrated management of a configuration of a computer system such as a storage array, a host computer, a switch, a hub and the like by management software can be cited.

Such methods include one disclosed in Patent Literature 1, for example. By using this kind of technologies, an administrator of a storage system can perform a management operation such as search for a storage resource meeting a condition from storage resources (hereinafter also referred to simply as a resource) owned by a plurality of storage arrays, and assignment thereof to a host computer.
Patent Literature 1: Japanese Unexamined Patent Application Publication No. 2002-63063
Patent Literature 2: Japanese Unexamined Patent Application Publication No. 2004-5370
Patent Literature 3: Japanese Unexamined Patent Application Publication No. 2005-250925

### SUMMARY

On the other hand, in recent years, the number of storage arrays and host computers installed in a data center of a company and the like is increasing, and the size of a computer system is getting bigger. In such a large-scale storage environment, with the purpose of reduction of its administration cost, a storage resource having some typical configurations may be generated in advance so that it can be used later as necessary.

Particularly, such an operation is often performed in a storage array used as applications including a storage destination of data with a low usage or a backup destination of data. Moreover, a resource of this type of storage array generally has a lower frequency of maintenance by an administrator (deletion of unnecessary storage resources and the like) than that of a storage array used as a storage destination of data with a high usage.

The resources of such storage arrays include a storage resource that was considered to have a high usage at the time of generation, for example, but has gradually become unable to satisfy a requirement in continuation of an operation of the computer system and is hardly used in the end.

However, with methods according to prior art, a storage resource meeting a condition can be efficiently found but a storage resource not meeting a condition any longer cannot be found efficiently. Thus, storage resources which hardly matches the condition designated by a user and is hardly used (that is, unnecessary) remain in the system, and that causes a problem that utilization efficiency of the storage resources lowers. Moreover, the larger the system becomes, the more difficult for an administrator to specify an unnecessary storage resource comes to be.

Therefore, a technology for efficiently using a storage resource even in a large-scale system is desired.

An aspect of the invention is a computer system including one or more storage arrays providing a plurality of storage resources and a management system managing the one or more storage arrays. The management system stores configuration information of the plurality of storage resources. The management system specifies a non-applicable free storage resource for a configuration condition including one or more predesignated condition items in response to a predesignated event and records information of the specified free storage resource and a non-applicable reason in condition non-applicable storage resource information. The management system repeats the specifying and the recording in response to the predesignated event. The management system selects a free storage resource applicable to a predesignated unnecessary storage resource condition from the condition non-applicable storage resource information after the repetition as an unnecessary storage resource candidate.

Other features of the present invention will be partly specified by the following description, partly more apparent from the following description or learned from exploitation of the present invention. Aspects of the present invention are achieved and realized by elements and a combination of various elements, and the following detailed description and attached aspects of the claims.

It should be understood that the above and following description is for typical explanation and do not limit the claims and applications of the present invention in any sense.

According to the present invention, a storage resource can be used efficiently even in a large-scale system.

### BRIEF DESCRIPTION OF THE DRAWINGS

FIG. 1 is a diagram illustrating a schematic configuration of a computer system in a first embodiment.

FIG. 2 is a diagram illustrating a configuration example of a storage configuration information table group in the first embodiment.

FIG. 3 is a diagram illustrating a configuration example of a volume assignment table in the first embodiment.

FIG. 4 is a diagram illustrating a configuration example of a physical resource assignment table in the first embodiment.

FIG. 5 is a diagram illustrating a configuration example of a configuration information table group in the first embodiment.

FIG. 6 is a diagram illustrating a configuration example of a storage information table in the first embodiment.

FIG. 7 is a diagram illustrating a configuration example of a volume information table in the first embodiment.

FIG. 8 is a diagram illustrating a configuration example of a pool information table in the first embodiment.

FIG. 9 is a diagram illustrating a configuration example of a physical resource information table in the first embodiment.

FIG. 10 is a diagram illustrating a configuration example of a pool/resource related information table in the first embodiment.

FIG. 11 is a diagram illustrating a configuration example of a host information table in the first embodiment.

FIG. 12 is a diagram illustrating a configuration example of a volume assignment information table in the first embodiment.

FIG. 13 is a diagram illustrating a configuration example of a table group for unnecessary resource specification in the first embodiment.

FIG. 14 is a diagram illustrating a configuration example of a condition non-applicable resource information table in the first embodiment.

FIG. 15 is a flowchart for explaining processing of registering a storage array or a host computer in the first embodiment as a management target of management software.

FIG. 16 is a flowchart for explaining processing of search for a free resource by the management software from resources of the storage array in the first embodiment.

FIG. 17 is a flowchart for explaining another processing of search for a free resource by the management software from resources of the storage array in the first embodiment.

FIG. 18 is a flowchart for explaining another processing of search for a free resource by the management software from resources of the storage array in the first embodiment.

FIG. 19 is a flowchart for explaining another processing of search for a free resource by the management software from resources of the storage array in the first embodiment.

FIG. 20 is a diagram illustrating a configuration example of a user interface (search for a free resource) in the first embodiment.

FIG. 21 is a diagram illustrating a configuration example of the user interface (search result of a logical volume) in the first embodiment.

FIG. 22 is a diagram illustrating a configuration example of the user interface (search result of a pool) in the first embodiment.

FIG. 23 is a diagram illustrating a configuration example of the user interface (search result of a physical resource) according to the present invention.

FIG. 24 is a flowchart for explaining processing of specification by the management software a resource hardly matching a condition designated by a user from the resources of the storage array in the first embodiment.

FIG. 25 is a diagram illustrating a configuration example of the user interface (list display of unnecessary resource candidates) in the first embodiment.

FIG. 26 is a diagram illustrating a configuration example of the user interface (detailed display of unnecessary resource candidates) in the first embodiment.

FIG. 27 is a diagram illustrating a configuration example of the user interface (display of unnecessary resource candidates in a resource list) in the first embodiment.

FIG. 28 is a diagram illustrating a schematic configuration of a computer system in a second embodiment.

FIG. 29 is a diagram illustrating a configuration example of a table group for unnecessary resource specification in the second embodiment.

FIG. 30 is a diagram illustrating a configuration example of management operation execution frequency table in the second embodiment.

FIG. 31 is a diagram illustrating a configuration example of condition non-applicable times table for each management operation in the second embodiment.

FIG. 32 is a diagram illustrating a configuration example of an unnecessary resource determination threshold value table in the second embodiment.

FIG. 33 is a flowchart for explaining processing of search for a free resource by the management software from the resources of the storage array in the second embodiment.

FIG. 34 is a flowchart for explaining processing of update of an unnecessary resource determination threshold value by the management software in the second embodiment.

FIG. 35 is a flowchart for explaining processing of calculation of a condition non-applicable score by the management software in the light of an execution frequency of a management operation in the second embodiment.

FIG. 36 is a flowchart for explaining processing of identification by the management software of a resource hardly matching a condition designated by a user from the resources of the storage array in the second embodiment.

FIG. 37 is a diagram illustrating a schematic configuration of a computer system in a third embodiment.

FIG. 38 is a diagram illustrating a configuration example of a management authority information table group in the third embodiment.

FIG. 39 is a diagram illustrating a configuration example of a user information table in the third embodiment.

FIG. 40 is a diagram illustrating a configuration example of a resource group information table in the third embodiment.

FIG. 41 is a diagram illustrating a configuration example of a resource/resource group correspondence information table in the third embodiment.

FIG. 42 is a diagram illustrating a configuration example of a user/resource group correspondence information table in the third embodiment.

FIG. 43 is a flowchart for explaining processing of identification by the management software of a resource hardly matching a condition designated by a user from the resources of the storage array in the third embodiment.

FIG. 44 is a flowchart for explaining processing of presentation of information of a resource hardly matching a condition designated by the user to a user by the management software in the third embodiment.

FIG. 45 is a diagram illustrating a schematic configuration of a computer system in a fourth embodiment.

FIG. 46 is a flowchart for explaining processing of search of a free resource from the resources of the storage array by the management software in the fourth embodiment.

FIG. 47 is a diagram illustrating a configuration example of the user interface (search result of a logical volume) in the fourth embodiment according to the present invention.

FIG. 48 is a diagram illustrating a schematic configuration of a computer system in a fifth embodiment.

FIG. 49 is a diagram illustrating a configuration example of a frequent appearance condition table group in the fifth embodiment.

FIG. 50 is a diagram illustrating a configuration example of a volume frequent appearance condition table in the fifth embodiment.

FIG. 51 is a diagram illustrating a configuration example of a pool frequent appearance condition table in the fifth embodiment.

FIG. 52 is a diagram illustrating a configuration example of a physical resource frequent appearance condition table in the fifth embodiment.

FIG. 53 is a flowchart for explaining processing of identification of a resource hardly matching a condition designated by a user from the resources of the storage array by the management software in the fifth embodiment.

FIG. 54 is a flowchart for explaining processing of determination of a measure for improving utilization efficiency of the resource hardly matching a condition designated by a user by the management software in the fifth embodiment.

FIG. 55 is a flowchart for explaining processing of determination of remaking of a configuration of the resource for improving utilization efficiency of the resource hardly matching a condition designated by a user by the management software in the fifth embodiment.

FIG. 56 is a diagram illustrating a configuration example of the user interface (detailed display of unnecessary resource candidates) according to the present invention in the fifth embodiment.

### DETAILED DESCRIPTION OF EMBODIMENTS

Embodiments of the present invention will be described below with reference to the attached drawings. In the attached drawings, the functionally same elements might be indicated by the same numerals. The attached drawings illustrate specific embodiments and implementation examples in compliance with the principle of the present invention but they are for understanding of the present invention and not to be used for interpreting the present invention in a limited manner at all.

In this embodiment, sufficiently detailed explanation is given for those skilled in the art to put the present invention into practice but it should be understood that other implementations/forms are possible and changes in the configuration/structures and replacement of various elements are possible without departing from the scope and the spirit of the technical idea of the present invention. Therefore, the following description should not be interpreted as a limitation

Moreover, the embodiments of the present invention may be implemented by software running on a general-purpose computer or may be implemented by dedicated hardware or a combination of software and hardware as will be described later.

In the following explanation, each piece of information of the present invention will be described in a “table” format but the information does not necessarily have to be expressed in a data structure using a table and may be expressed in a data structure using a list, a DB, a queue and the like or any other formats. Thus, in order to indicate that information does not depend on the data structure, “table”, “list”, “DB”, “queue” and the like might be referred to simply as “information”. Moreover, when explaining contents of each piece of the information, expressions like “identification information”, “identifier”, “name”, and “ID” can be used, and they can be replaced with each other.

In the following, each processing in the embodiment of the present invention will be described by using a term of a “program” as a subject (subject of action), but since the program is executed by a processor so as to perform predetermined processing by using a memory and a communication port (communication controller), the processor may be used as the subject in the explanation.

Moreover, the processing disclosed by using the program as the subject may be considered as processing executed by a computer such as a management computer or an information processor. A part of or the whole of the program may be realized by dedicated hardware or may be modularized. Various programs may be installed in the computer or the information processor by using a program distribution server or non-temporary memory medium.

The processor operates in compliance with the program so as to be a functional unit realizing a predetermined function. For example, the processor functions as a control unit by operating in compliance with a control program and functions as a management unit by operating in compliance with a management program. A device and a system including the processor is a device and a system including these functional units.

A configuration example in this embodiment records a score indicating a degree of a storage resource not matching a condition (the number of times not matching the condition as the result of search, for example) and a reason thereof (the condition not matching at the search) when a storage resource matching the condition is searched from the storage resources included in the computer system by a management system.

On the other hand, for the storage resource matching the condition, time and date determined to match the condition are recorded. The management system detects a resource which has been hardly used in a period determined in advance prior to the current time and date on the basis of the information and presents the information of the storage resource (configuration information, the above-described score, and the above-described reason, for example) to an administrator who is a user.

Moreover, the management system records the condition designated by the administrator along with the designation number of times and a ratio at which the storage resource satisfying the condition is not found in every time the storage resource is searched. The management system determines a measure for improving utilization efficiency of the storage resource for the storage resource determined to hardly match the condition designated by the user on the basis of the information, and presents the measure to the user.

### A. First Embodiment

### Configuration of Computer System

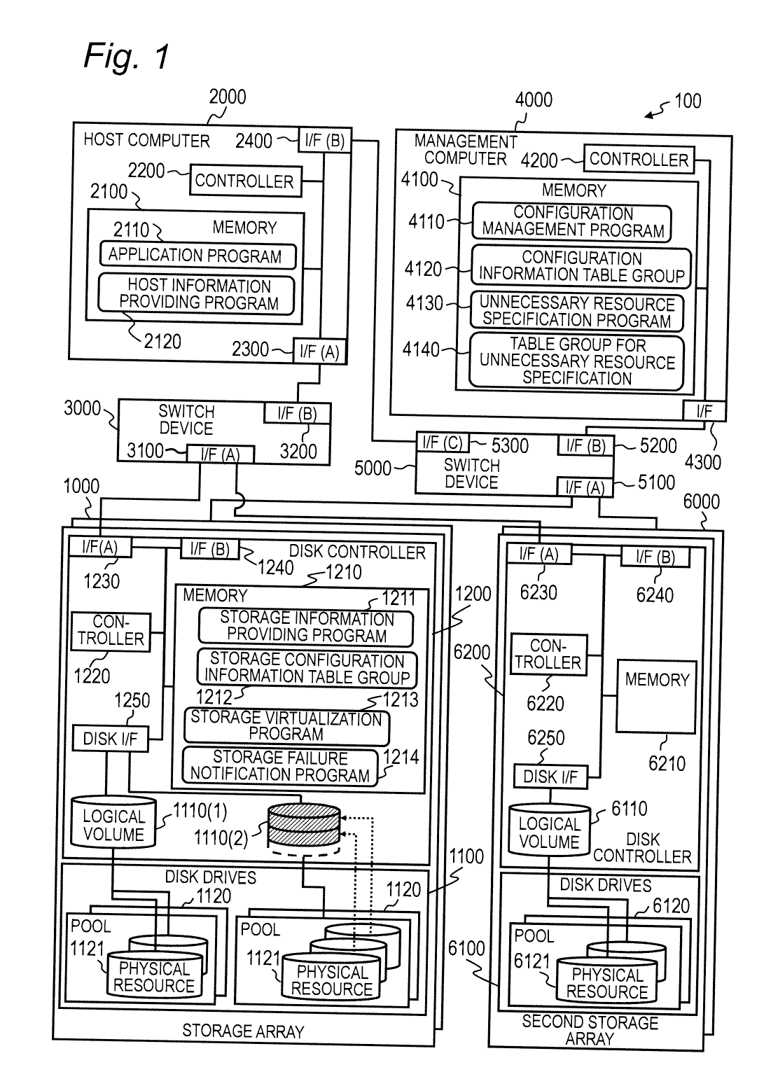

FIG. 1 is a diagram illustrating a schematic configuration of a computer system according to a first embodiment of the present invention. The computer system 100 includes a storage array 1000, a host computer 2000, a switch device 3000, a management computer 4000, a switch device 5000, and a second storage array 6000.

In FIG. 1, there are two storage arrays 1000 and one host computer 2000, one switch device 3000, one management computer 4000, and one switch device 5000, but the number of the devices is not limited as above and may be any as long as there is one or more each. Moreover, in FIG. 1, there are two storage arrays 6000, but the number of the device is not limited as such and may be three or more.

The storage array 1000, the second storage array 6000, and the host computer 2000 are connected to a network via the switch device 3000. Moreover, the storage array 1000, the second storage array 6000, the host computer 2000, and the management computer 4000 are connected to the network via the switch device 5000.

The switch device 3000 and the switch device 5000 may be the same device. Moreover, the switch device 5000 may be divided into an device for connecting the storage array 1000, the second storage array 6000, and the management computer 4000 and a device for connecting the host computer 2000 and the management computer 4000.

The switch device 5000 includes an I/F (Interface) (A) 5100 for connection with the storage array 1000 and the second storage array 6000, an I/F (B) 5200 for connection with the management computer 4000, and an I/F (C) 5300 for connection with the host computer 2000.

A network protocol used among the storage array 1000, the second storage array 6000, the management computer 4000, the host computer 2000, and the switch device 5000 for connecting them includes, but is not particularly limited to, TCP/IP and the like. Moreover, there are one I/F (A) 5100, one I/F (B) 5200, and one I/F (C) 5300 in the figure, but the number of each of them does not necessarily have to be such but they may be provided one or more for each.

Moreover, in FIG. 1, the management computer 4000 and the storage array 1000 are illustrated as devices including respective housings, but that does not intend limiting, and the management computer 4000 and the storage array 1000 may be present in the same housing. Similarly, the management computer 4000 and the second storage array 6000 may be present in the same housing.

(i) Storage Array

The storage array 1000 includes disk drives 1100 and a disk controller 1200. The disk drives 1100 include a physical resource 1121 and a pool 1120. Here, the physical resource 1121 represents a resource of a storage area provided by a physical device such as an HDD (Hard Disk Drive), an SSD (Solid State Drive) and the like. However, the type of the physical device providing the physical resource 1121 is not particularly limited. The pool 1120 is a group of the physical resources 1121.

In general, the pool 1120 is comprised by making the physical resource 1121 redundant by using a technology called RAID (Redundant Array of Independent Disks), but this does not intend limiting, and it is only necessary that one or more physical resources 1121 are grouped. In the figure, there are four pools 1120 and five physical resources 1121 but the numbers are not limited as above and it is only necessary that they are provided one or more of each.

For example, the pool 1120 connected to the logical volume 1110 (1) is comprised of the RAID, and the pool 1120 connected to the logical volume 1110 (2) is comprised to provide a virtual volume by using Thin Provisioning technology or Automated Tiering technology. However, it does not intend limiting, and both may comprise the RAID or both may be configured to provide the virtual volumes.

Moreover, the pool 1120 providing a virtual volume may be comprised not of the physical resource 121 but of the logical volume 1110 depending on hardware designation of the storage array 1000. In this case, the physical resource 1121 configures the pool 1120 comprising the RAID, the logical volume 1110 (1) cut out of the pool 1120 comprising the RAID configures the pool 1120 providing a virtual volume, and the logical volume 1110 (2) is cut out of the pool 1120 providing the virtual volume. The configuration of the pool 1120 providing a virtual volume is not particularly limited.

The disk controller 1200 includes a memory 1210, a controller (also referred to as a processor) 1220, an I/F (A) 1230 for connection with the switch device 3000, an I/F (B) 1240 for connection with the switch device 5000, and a disk I/F 1250 for connection with the disk drives 1100. These constituent elements are connected to each other via a bus.

The disk controller 1200 further includes the logical volume 1110. The logical volume 1110 represents a logical storage area comprising one or more physical resources and is provided to the host computer 2000 by the disk controller 1200.

Here, the logical volume 1110 (1) is comprised of one or more physical resources 1121 which are assigned in advance, and the capacity of the logical volume 1110 (1) is equal to the total capacity of the physical resources 1121 configuring it. However, if the physical resource has been made redundant by the RAID, the capacity of the logical volume 1110 (1) might be smaller than the total capacity of the physical resources 1121 configuring it.

On the other hand, the logical volume 1110 (2) is a virtual logical volume provided to the host computer 2000 and the physical resource 1121 is assigned thereto in response to a writing request from the host computer 2000. Specifically, when the disk controller 1200 receives a request of writing data in the logical volume 1110 (2), if a physical resource has not been assigned to a target area of the writing request, the disc controller 1200 assigns a storage area of the physical resource 1121 to the logical volume 1110 (2) and writes the data in the storage area of the assigned physical resource.

As a result, the storage capacity of the logical volume 1110 (2) provided to the host computer 2000 can be made larger than a total capacity of the actually assigned physical resource 1121. A technology to realize this is called the Thin Provisioning technology.

Moreover, if the logical volume 1110 (2) is comprised of a plurality of the physical resources 1121, the type of the physical device (HDD, SSD or the like) which is the providing source of the physical resource 1121 may be different. Furthermore, the physical resource which is a storage destination of the data written in the logical volume 1110 (2) can be dynamically changed in accordance with an access frequency from the host computer 2000 or the like by the Automated Tiering function of the storage array 1000.

As a result, such control can be made that data with a high access frequency from the host computer 2000 is stored in the physical resource provided from a high-speed but expensive physical media (physical storage drive) such as an SSD and data with a low access frequency from the host computer 2000 is stored in the physical resource provided from a low-speed but inexpensive physical media such as SATA, for example.

In FIG. 1, the above-described two types of the logical volumes 1110 are present one each, but this does not intend limiting, and there may be only one of them or may be both of them in a mixed manner as long as there are one or more logical volumes 1110.

The memory 1210 stores a program and data used by the controller 1220. Particularly, the memory 1210 includes a storage information providing program 1211, a storage configuration information table group 1212, a storage virtualization program 1213, and a storage failure notification program 1214.

The storage information providing program 1211 is a program which collects configuration information of the storage array 1000 and transmits the information to another program (configuration management program 4110).

The storage configuration information table group 1212 is a collection of tables which store configuration information of the storage array 1000.

The storage virtualization program 1213 is a program for realizing a virtualization function. Specifically, the storage virtualization program 1213 has a function of mapping a logical volume 6110 in the second storage array 6000 connected via the switch device 3000 in the logical volume 1110 in the first storage array 1000. As a result, the logical volume 6110 of the second storage array 6000 can be provided to the host computer 2000 as a logical volume of the first storage array 1000.

In this embodiment, the virtualization function disclosed in Patent Literatures 2 and 3 can be used, for example. When the logical volume 6110 of the second storage array 6000 is mapped in the logical volume 1110 of the first storage array 1000, the logical volume 6110 may be mapped as the logical volume 1110 or the logical volume 6110 is mapped as the pool 1120 and then, the logical volume 1110 may be cut out of the pool.

Moreover, the logical volume 6110 may be mapped as the physical resource 1121, and a pool may be configured from the physical resource and then, the logical volume 1110 may be cut out. Moreover, the virtualization function may be realized by the switch device 3000. Moreover, the first storage array 1000 and the second storage array 6000 may have one-to-one relationship or a relationship of one-to-many, many-to-one or many-to-many.

The storage failure notification program 1214 is a program which notifies information of a failure occurring in the storage array 1000 to another program (configuration management program 4110). The type of the failure includes, but is not limited to, a failure of the physical device providing the physical resource 1121, for example.

The controller 1220 controls execution of a program in the memory 1210 and input/output of data and input/output of data and a control command via each I/F of the disk controller 1200. In addition to the above, the storage array 1000 has general functions as a storage array such as a function of configuring the pool 1120 from the physical resource 1121, a function of generating the logical volume 1110 from the pool 1120, a function of assigning the logical volume to the host computer 2000 via the I/F (A) 1230, a function of receiving a request of changing a configuration or setting of the storage array 1000 from the management computer 4000 and the like.

Moreover, the storage array 1000 may also include an input device for a user of the storage array 1000 to input data and an output device to present information to the user of the storage array 1000, but since they are not directly related to the present invention, they are not shown in the figures. The configuration of the second storage array 6000 is similar to the storage array 1000 and explanation thereof is omitted.

(ii) Host Computer

The host computer 2000 includes a memory 2100, a controller (also referred to as a processor) 2200, an I/F (A) 2300 for connection with the switch device 3000, and an I/F (B) 2400 for connection with the switch device 5000. These constituent elements are connected to each other via a bus. The memory 2100 stores a program and data used by the controller 2200. Particularly the memory 2100 includes an application program 2110 and a host information providing program 2120.

The application program 2110 may be any program. The host information providing program 2120 is a program which collects configuration information of the host computer 2000 and transmits the information to another program (configuration management program 4110). The host information providing program may be a separate program from the OS (Operating System) or may be realized as a function of the OS itself. The controller 2200 controls execution of the program in the memory 2100 and input/output of data, and input/output of data and a control command via the I/F (A) 2300 and the I/F (B) 2400.

The host computer 2000 may include an input device for a user of the host computer 2000 to input data (a keyboard, a pointing device such as a mouse and the like, a sound input device and the like), an output device for presenting information to the user of the host computer 2000 (a display device, a printer, a sound output device and the like), and a secondary memory device for storing data other than the above but since they are not directly related to the present invention, they are not shown in the figures.

The switch device 3000 includes an I/F (A) 3100 for connection with the storage array 1000 and the second storage array 6000 and an I/F (B) 3200 for connection with the host computer 2000. A network protocol used among the storage array 1000, the second storage array 6000, the host computer 2000, and the switch device 3000 which connects them includes, but is not particularly limited to, FC (Fibre Channel) and iSCSI. Moreover, in the figure, there are one unit of the I/F (A) 3100 and one I/F (B) 3200, but the number of the devices is not limited as above and may be any as long as there is one or more each.

(iii) Management Computer

The management computer 4000 includes a memory 4100, a controller (also referred to as a processor) 4200, and an I/F 4300 for connection with the switch device 5000. The memory 4100 stores a program and data used by the controller 4200.

For example, the memory 4100 includes a configuration management program 4110, a configuration information table group 4120, an unnecessary resource specification program 4130, and a table group 4140 for unnecessary resource specification.

The configuration management program 4110 is a program for managing configurations of the storage array 1000, the second storage array 6000, and the host computer 2000. The configuration management program 4110 has a function of obtaining configuration information of the storage array 1000 by communicating with the storage information providing program 1211 of the storage array 1000, for example.

Other than the above, the configuration management program 4110 has a function of obtaining configuration information of the host computer 2000 by communicating with the host information providing program 2120 of the host computer 2000 and a function of receiving information relating to a failure having occurred in the storage subsystem 1000 or the host computer 2000 from the storage failure notification program 1213 or a host failure notification program 2130, for example.

The configuration management program 4110 may obtain other information such as performance information other than the configuration information of the storage array 1000 and the host computer 2000. The configuration management program 4110 also has general functions as the management computer.

Specifically, they are a function of configuring the pool 1120 by the physical resource 1121, a function of generating the logical volume 1110 from the pool 1120, a function of assigning the logical volume 1110 to the host computer 2000 via the I/F (A) 1230, a scheduler function of executing specific processing at specific time, a function of searching a resource such as a logical volume of the storage array, and the like.

The configuration management program 4110 provides a user interface for performing display of the configuration information of the storage array 1000 and the host computer 2000 and a management operation to the storage array 1000 and the host computer 2000.

The configuration information table group 4120 is a collection of tables storing the configuration information of the storage array 1000 and the host computer 2000.

The unnecessary resource specification program 4130 is a program for identifying a resource which is hardly used any longer in the resources of the storage array 1000 and the second storage array 6000.

The table group 4140 for unnecessary resource specification is collection of tables storing information used by the unnecessary resource specification program 4130 for identifying a resource which is hardly used any longer in the resources of the storage array 1000 and the second storage array 6000.

The management computer 4000 may include an input device for a user of the management computer 4000 to input data, an output device for presenting information to the user of the management computer 4000, and a secondary memory device for storing data. Moreover, each table of the management computer 4000 may be held not only on the memory but also on the secondary memory device.

Instead of the input device and a display device (output device) of the management computer 4000, a serial interface or Ethernet interface may be used as an input/output device, and a computer for display including a display, a keyboard or a pointer device may be connected to the interface so that display is made on the computer for display by transmitting information for display thereto or by receiving information for input therefrom and thus, input and display of the input/output device can be substituted.

Moreover, by providing a program in the memory 4100 of the management computer 4000 into the memory 1210 of the storage array 1000 and by having the controller 1220 execute the program, the function similar to the management computer 4000 may be realized. Furthermore, the management computer 4000 may also include a program for managing the switch device 3000 and the switch device 5000.

In the following, a collection of one or more computers, each managing the computer system 100 and indicating information for display of the invention of this application, will be referred to as a management system in some cases. If the management computer 4000 displays the information for display, the management computer 4000 is the management system, and a combination of the management computer 4000 and the computer for display is also the management system. Furthermore, the processing similar to that by the management computer may be realized by a plurality of computers for higher speed and higher reliability of management processing, and in this case, the plurality of computers (if the display is made by the computer for display, the computer for display is included) are the management system.

<Storage Configuration Information Table Group>

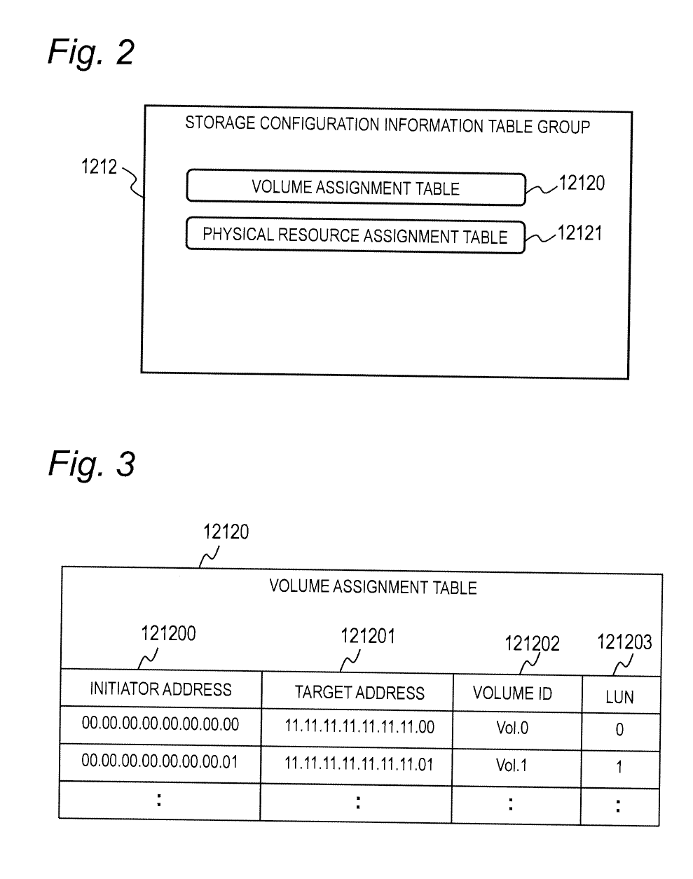

FIG. 2 is a diagram illustrating a configuration example of the storage configuration information table group 1212. In this embodiment, the storage configuration information table group 1212 includes a volume assignment table 12120 and a physical resource assignment table 12121.

The volume assignment table 12120 is a table for storing information of the logical volume 1110 assigned to the host computer 2000. The physical resource assignment table 12121 is a table for storing information of assignment of the physical resource to each segment of the logical volume 1110.

<Configuration Example of Volume Assignment Table>

FIG. 3 is a diagram illustrating a specific configuration example of the volume assignment table 12120. The volume assignment table 12120 has, as configuration items, an initiator address 121200 for identifying the I/F (A) 2300 of the host computer, a target address 121201 for identifying the I/F (A) 1230 of the storage array 1000, a volume ID 121202 for identifying the logical volume 1110, and a LUN (Logical Unit Number) 121203 for identifying a set of the I/F (A) 1230 and the logical volume 1110.

In FIG. 3, in order to express the initiator address 121200 and the target address 121201, the WWN (World Wide Name) of the I/F (A) 2300 of the host computer 2000 and the WWN of the I/F (A) 1230 of the storage array 1000 are used, respectively, but this does not intend limiting and any information may be used as long as it can uniquely identify the I/F (A) 2300 of the host computer 2000 and the I/F (A) 1230 of the storage array 1000.

Moreover, in FIG. 3, the LUN 121202 is used as an identifier for specifying the set of the I/F (A) 1230 and the logical volume 1110, but this is not limiting and any information may be used as long as it can uniquely identify the set of the I/F (A) 1230 and the logical volume 1110.

<Configuration Example of Physical Resource Assignment Table>

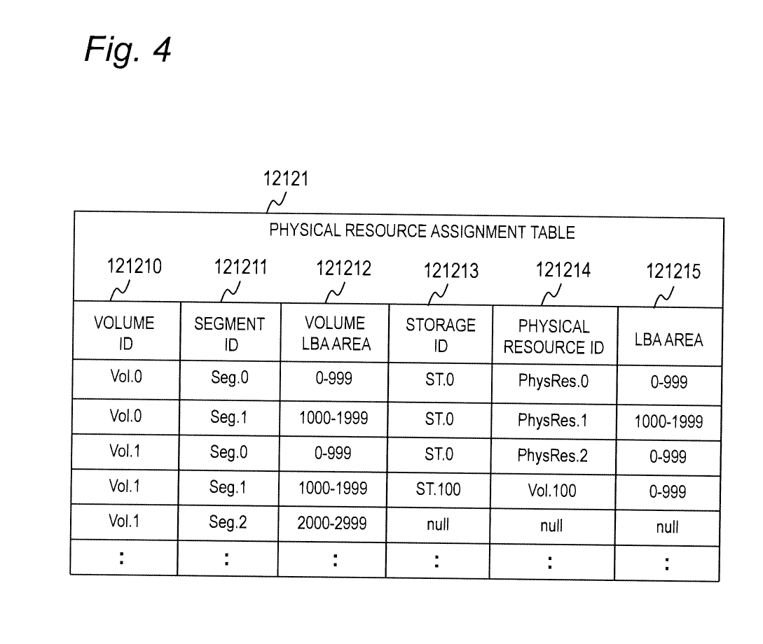

FIG. 4 is a diagram illustrating a configuration example of the physical resource assignment table 12121 in this embodiment. The physical resource assignment table 12121 has, as configuration items, a volume ID 121210 for identifying the logical volume 1110, a segment ID 121211 for identifying a segment in the logical volume, and a volume LBA (Logical Block Address) area 121212 for identifying each segment area in the logical volume 1110.

The physical resource assignment table 12121 further has, as configuration items, a storage ID 121213 for identifying the storage array which is a providing source of the physical resource, a physical resource ID 121214 for identifying a physical resource assigned to each segment of the logical volume 1110, and an LBA area 121215 for identifying a storage area of the physical resource 1121 assigned to each segment of the logical volume 1110.

In this embodiment, not only the storage area of the physical resource 1121 of the first storage array 1000 itself but also the storage area of the logical volume 6110 of the second storage array 6000 can be assigned to the segment of the logical volume 1110.

Thus, if the storage area of the logical volume 6110 of the second storage array 6000 is assigned to the segment of the logical volume 1110 (the row in which the volume ID 121210 is “Vol. 1” and the segment ID 121211 is “Seg. 1” in FIG. 4, for example), information identifying the second storage array 6000 is stored in the storage ID 121213 and information identifying the logical volume 6110 of the second storage array 6000 is stored in the physical resource ID 121214, respectively.

On the other hand, if the storage area of the physical resource 1121 of the storage array 1000 itself is assigned to the segment of the logical volume 1110, information identifying the first storage array 1000 is stored in the storage ID 121213 and information identifying the physical resource 1121 is stored in the physical resource ID 121214, respectively. A method indicating the relationship of virtualizing/being virtualized by the storage virtualization program is not limited to the expressions in FIG. 4 but may be other methods.

The volume ID 121210, the segment ID 121211, the storage array ID 121213, and the physical resource ID 121214 are information that can uniquely identify the logical volume 1110, the segment in the logical volume 1110, the storage array 1000 or the second storage array 6000, and the physical resource 1121 or the logical volume 6110 of the second storage array 6000, respectively. Therefore, they are not limited to the notation in FIG. 4 but may be other types of information.

Moreover, the volume LBA area 121212 and the LBA area 121215 are not limited to the notation in FIG. 4 but may be other types of information as long as the information can uniquely identify the area of each segment in the logical volume 1110 and the storage area in the physical resource 1121, respectively.

In FIG. 4, the row in which “null” is stored in the columns of the physical resource ID 121214 and the LBA area 121215 (the row in which the volume ID 121210 is indicated as “Vol. 1” and the segment ID 121211 is indicated as “Seg. 2”) indicates that a writing request from the host computer 2000 has not been made yet to a part of the segments of the virtual logical volume 1110 (2) provided to the host computer 2000, and therefore, a storage area of the physical resource 1121 has not been assigned yet to the segment.

<Configuration Information Table Group>

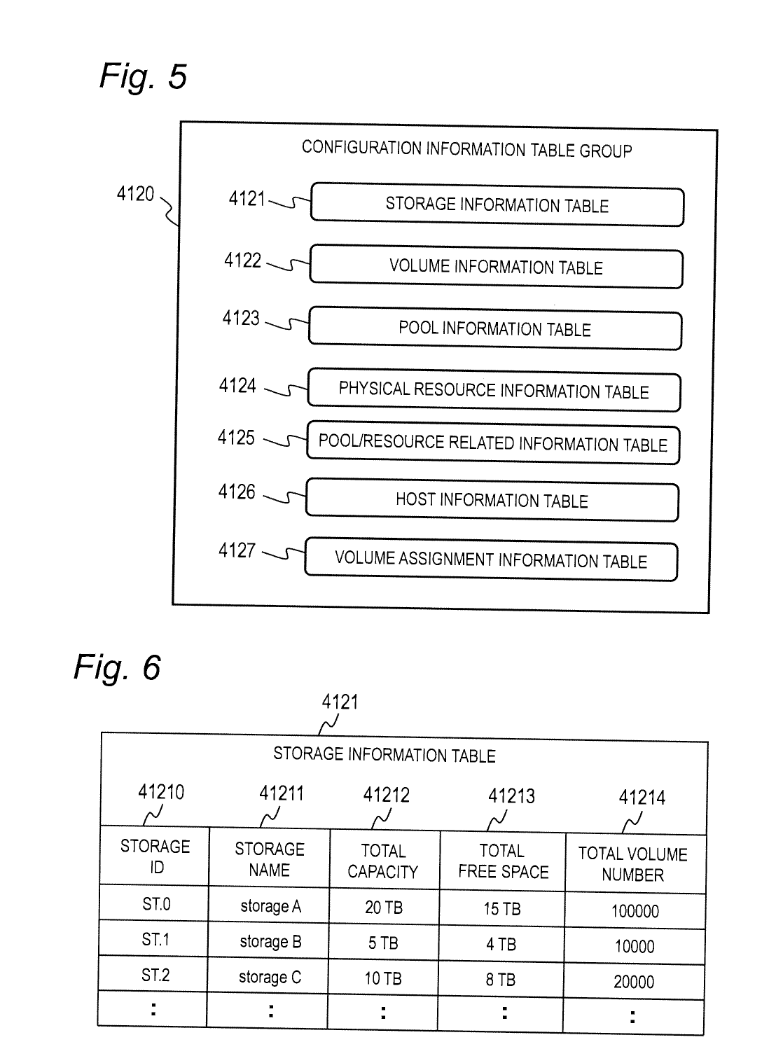

FIG. 5 is a diagram illustrating a configuration example of the configuration information table group 4120. In this embodiment, the configuration information table group 4120 includes a storage information table 4121, a volume information table 4122, a pool information table 4123, a physical resource information table 4124, a pool/resource related information table 4125, a host information table 4126, and a volume assignment information table 4127.

The storage information table 4121 is a table for storing information of the storage array 1000 and the second storage array 6000. The volume information table 4122 is a table for storing information of the logical volume 1110 of the storage array 1000 and the logical volume 6110 of the second storage array 6000.

The pool information table 4123 is a table for storing information of the pool 1120 of the storage array 1000 and the pool 6120 of the second storage array 6000. The physical resource information table 4124 is a table for storing information of the physical resource 1121 of the storage array 1000 and the physical resource 6121 of the second storage array 6000.

The pool/resource related information table 4125 is a table for storing information of relationship between the pool 1120 and the physical resource 1121 of the storage array 1000 and the relationship between the pool 6120 and the physical resource 6121 of the second storage array 6000.

The host information table 4126 is a table for storing information of the host computer 2000. The volume assignment information table 4127 is a table indicating a relationship between the host computer 2000 and the logical volume 1110 or the logical volume 6110 assigned to the host computer 2000.

<Configuration Example of Storage Information Table>

FIG. 6 is a diagram illustrating a specific configuration example of the storage information table 4121. The storage information table 4121 includes, as configuration items, a storage ID 41210 for identifying the storage array 1000 or the second storage array 6000, a storage name 41211 indicating a name of the storage array 1000 or the second storage array 6000, and a total capacity 41212 of the pool 1120 of the storage array 1000 or the pool 6120 of the second storage array 6000.

The storage information table 4121 further includes, as configuration items, a total free space 41213 of the pools 1120 of the storage array 1000 or the pools 6120 of the second storage array 6000, a total volume number 41214 which is a total number of the logical volumes 1110 of the storage array 1000 or a total number of the logical volumes 6110 of the second storage array 6000.

The storage information table 4121 may store not only the information illustrated in FIG. 6 but also other types of information of the storage array 1000 or the second storage array 6000.

<Configuration Example of Volume Information Table>

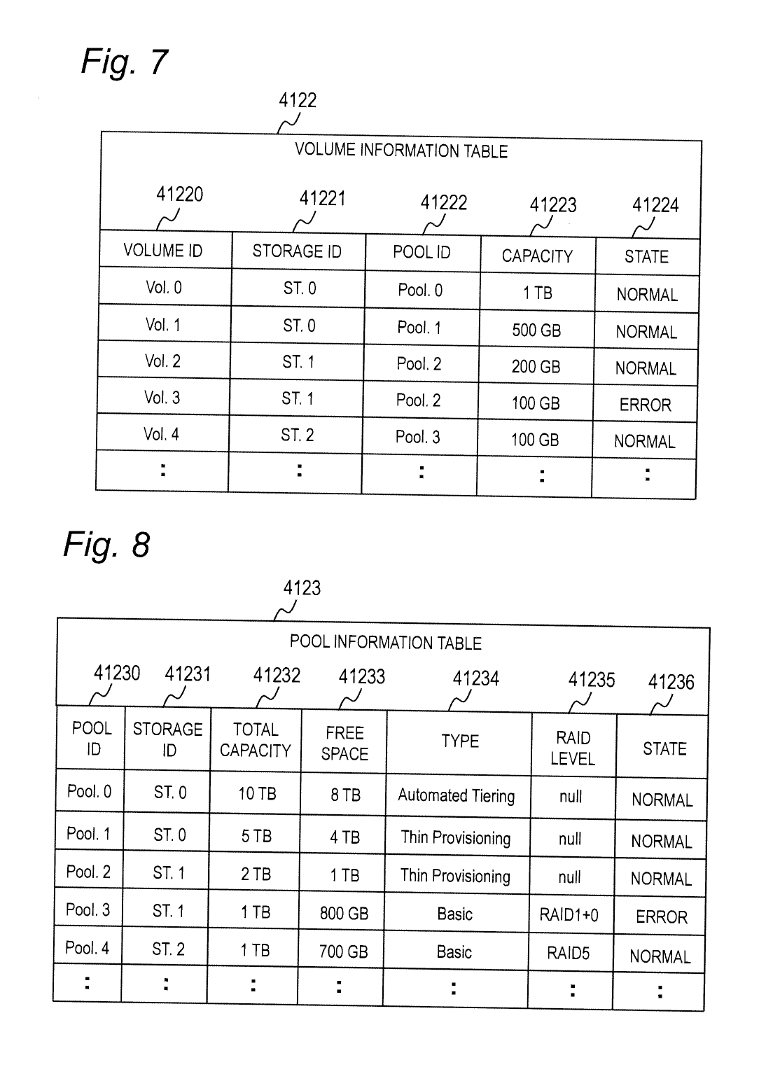

FIG. 7 is a diagram illustrating a specific configuration example of the volume information table 4122. The volume information table 4122 includes, as configuration items, a volume ID 41220 for identifying the logical volume 1110 or the logical volume 6110 and a storage ID 41221 for identifying the storage array 1000 or the second storage device 6000.

The volume information table 4122 further includes, as configuration items, a pool ID 41222 for identifying a pool 1120 of which the logical volume 1110 is cut out or the pool 6120 of which the logical volume 6110 is cut out, a capacity 41223 of the logical volume 1110 or the logical volume 6110, and a state 41224 indicating a working state of the logical volume 1110 or the logical volume 6110

In FIG. 7, either one of values “normal” and “error” is stored in the state 41224, but they are not limiting and may be any information indicating the working state of the logical volume 1110 or the logical volume 6110. Moreover, the volume information table 4122 may store not only the information illustrated in FIG. 7 but also other types of information of the logical volume 1110 or the logical volume 6110.

<Configuration Example of Pool Information Table>

FIG. 8 is a diagram illustrating a specific configuration example of the pool information table 4123. The pool information table 4123 includes, as configuration items, a pool ID 41230 for identifying the pool 1120 or the pool 6120 and a storage ID 41231 for identifying the storage array 1000 or the second storage array 6000.

The pool information table 4123 further includes, as configuration items, a total capacity 41232 of the pool 1120 or the pool 6120, a free space 41233 of the pool 1120 or the pool 6120, a type 41234 indicating a type of the pool 1120 or the pool 6120, an RAID level 41235 configured for the pool 1120 or the pool 6120, and a state 41236 indicating the working state of the pool 1120 or the pool 6120.

Here, the RAID level 41235 is information indicating the type of the RAID technology applied to the pool 1120 or the pool 6120, that is, information indicating the degree of redundancy of the pool 1120 or the pool 6120.

Moreover, when FIG. 7 is explained in relation with FIG. 8, since the logical volume is cut out of the pool, it is found that regarding the logical volume whose volume ID 41220 is “Vol. 0”, the capacity of 1 TB is cut out of the pool whose pool ID 41230 is Pool. 0 (the total capacity 41232 is 10 TB) and then, the logical volume is configured.

In FIG. 8, the type 41234 stores any one of values of “Basic”, “Thin Provisioning”, and “Automated Tiering”, but this is not limiting and it may be any as long as it is information indicating the type of the pool. In this embodiment, the pool 1120 having the type 41234 of “Basic” indicates a pool capable of assigning the capacity of one or more physical resources 1121 in advance to the logical volume 1110 (1).

Moreover, the pool 1120 having the type 41234 of “Thin Provisioning” indicates a pool capable of assigning the physical resource 1121 to the logical volume 1110 (2) in response to a writing request from the host computer 2000.

Furthermore, the pool 1120 having the type 41234 of “Automated Tiering” indicates the pool comprised of the physical resources provided by a plurality of types of the physical devices and capable of the following.

That is, the pool is capable of assigning the physical resource 1121 to the logical volume 1110 (2) in response to a writing request from the host computer 2000. It is possible to change the type of the physical resource 1121 to be assigned to the logical volume 1110 (2) in accordance with a frequency of an I/O access from the host computer 2000 to the logical volume 1110 (2). It is possible to migrate data having been written in the storage area of the already-assigned physical resource 1121 onto the storage area of another physical resource 1121.

In FIG. 8, either one of values of “normal” and “error” is stored in the state 41236, but this is not limiting and may be any information as long as it indicates the working state of the pool 1120. Moreover, the pool information table 4123 may store not only the information illustrated in FIG. 8 but also other types of information of the pool 1120 or the pool 6120.

<Physical Resource Information Table>

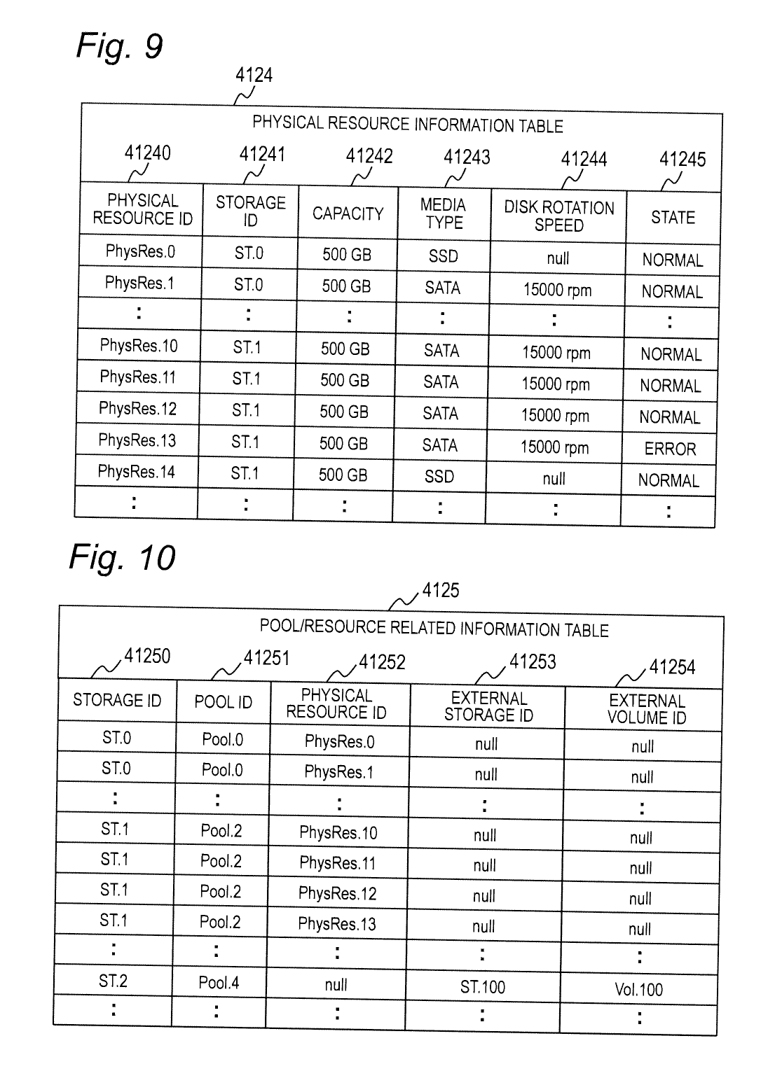

FIG. 9 is a diagram illustrating a specific configuration example of the physical resource information table 4124. The physical resource information table 4124 includes a physical resource ID 41240 for identifying the physical resource 1121 or the physical resource 6121, a storage ID 41241 for identifying the storage array 1000 or the storage array 6000, and the capacity 41242 of the physical resource 1121 or the physical resource 6121.

The physical resource information table 4124 further includes, as configuration items, a media type 41243 indicating a type of a providing source media (storage drive) of the storage area in the physical resource 1121 or the physical resource 6121, a disk rotation speed 41244 of the providing source media of the storage area in the physical resource 1121 or the physical resource 6121, and a state 41245 indicating the working state of the physical resource 1121 or the physical resource 6121.

In FIG. 9, either one of values “SATA” and “SSD” is stored in the media type 41243, but this is not limiting and may be any information as long as it indicates the type of the media.

In this embodiment, if the media type 41243 is “SSD”, the disk rotation speed 41244 stores “null”. This indicates that SSD has no disk and thus, disk rotation cannot occur. A method of indicating that there is no disk rotation is not limited to that but may be other methods of expression.

Moreover, in FIG. 9, the state 41245 stores either one of the values “normal” and “error”, but this is not limiting and may be any information as long as it indicates the working state of the physical resource 1121 or the physical resource 6121. Moreover, the physical resource information table 4134 may store not only the information illustrated in FIG. 9 but other types of information of the physical resource 1121 or the physical resource 6121.

<Configuration Example of Pool/Resource Related Information Table>

FIG. 10 is a diagram illustrating a specific configuration example of the pool/resource related information table 4125. The pool/resource related information table 4125 includes, as configuration items, a storage ID 41250 for identifying the storage array 1000, a pool ID 41251 for identifying the pool 1120, and a physical resource ID 41252 for identifying the physical resource 1121 which is a providing source of a storage area of the pool 1121.

If the providing source of the storage area of the pool 1120 is the logical volume 6110 of the second storage array 6000, the pool/resource related information table 4125 further includes, as configuration items, an external storage ID 41253 for identifying the second storage array 6000 and an external volume ID 41254 for identifying the logical volume 6110 of the second storage device 6000.

In FIG. 10, if the providing source of the storage area of the pool 1120 is the physical resource 1121 of the storage array 1000, the external storage ID 41253 and the external volume ID 41254 store “null”, while if the providing source of the storage area of the pool 1120 is the logical volume 6110 of the second storage array 6000, the physical resource ID 41252 stores “null”.

Moreover, the pool/resource related information table 4125 may store not only the information illustrated in FIG. 10 but other types of information indicating relation among the pool 1120, the physical resource 1121 or the logical volume 6110.

<Configuration Example of Host Information Table>

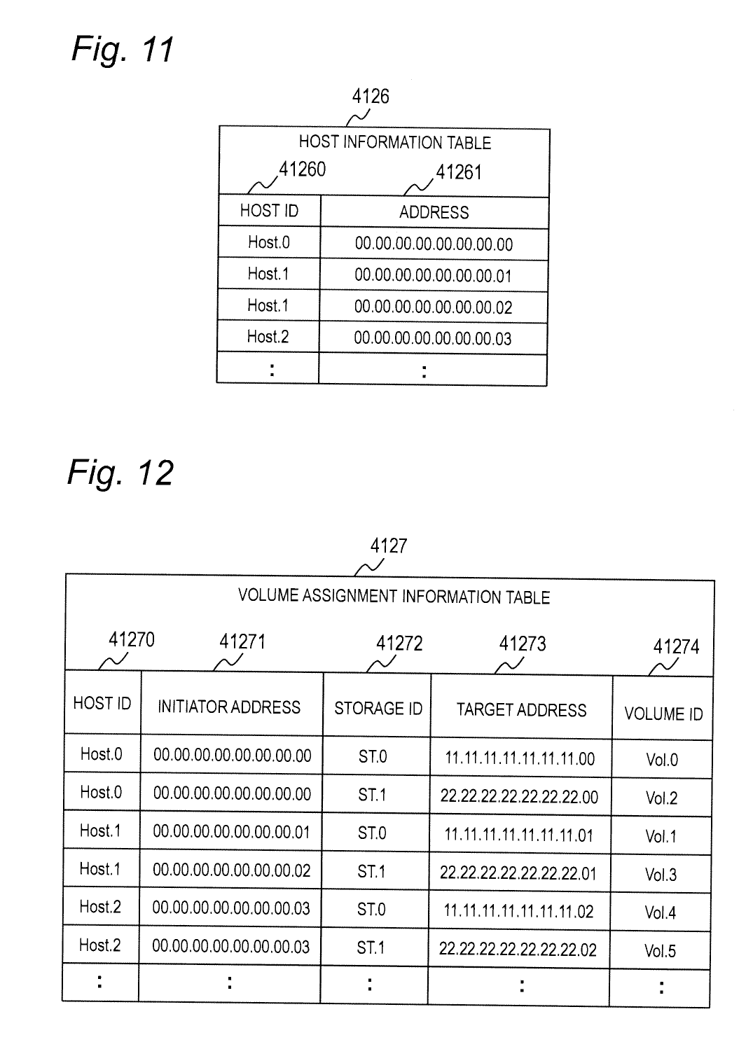

FIG. 11 is a diagram illustrating a specific configuration example of the host information table 4126. The host information table 4126 includes, as configuration items, a host ID 41260 for identifying the host computer 2000 and an address 41261 assigned to the I/F (A) 2300 of the host computer 2000.

In this example, WWN assigned to the I/F (A) 2300 of the host computer 2000 is stored in the address 41261, but this is not limiting, and it may be any information as long as it indicates a network address assigned to the I/F (A) 2300. Moreover, the host information table 4126 may store not only the information illustrated in FIG. 11 but other types of information of the host computer 2000.

<Configuration Example of Volume Assignment Information Table>

FIG. 12 is a diagram illustrating a specific configuration example of the volume assignment information table 4127. The volume assignment information table 4127 includes, as configuration items, a host ID 41270 for identifying the host computer 2000 and an initiator address 41271 indicating an address assigned to the I/F (A) 2300 of the host computer 2000.

The volume assignment information table 4127 further includes, as configuration items, a storage ID 41272 for identifying the storage array 1000 or the second storage array 6000, a target address 41273 indicating an address assigned to the I/F (A) 1230 of the storage array 1000 or the second storage array 6000, and a volume ID 41274 for identifying the logical volume 1110 or the logical volume 6110.

The volume assignment information table 4127 may store not only the information illustrated in FIG. 12 but other types of information relating to the relationship between the host computer 2000 and the logical volume 1110 or the logical volume 6110 assigned to the host computer 2000.

<Table Group for Unnecessary Resource Specification>

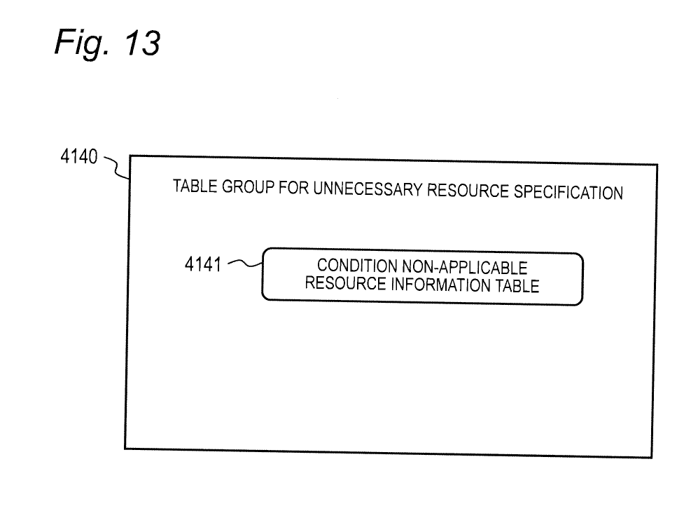

FIG. 13 is a diagram illustrating a specific example of the table group 4140 for unnecessary resource specification. In this embodiment, the table group 4140 for unnecessary resource specification includes a condition non-applicable resource information table 4141.

The condition non-applicable resource information table 4141 is a table which stores information indicating a degree of difficulty for the storage resource such as the logical volume, pool, physical resource and the like (hereinafter also collectively referred to simply as a resource or a storage resource) of the storage array 1000 or the second storage array 6000 in matching a condition requested by the administrator (hereinafter also referred to simply as a condition) and information indicating why the storage resource did not match the condition.

<Condition Non-Applicable Resource Information Table>

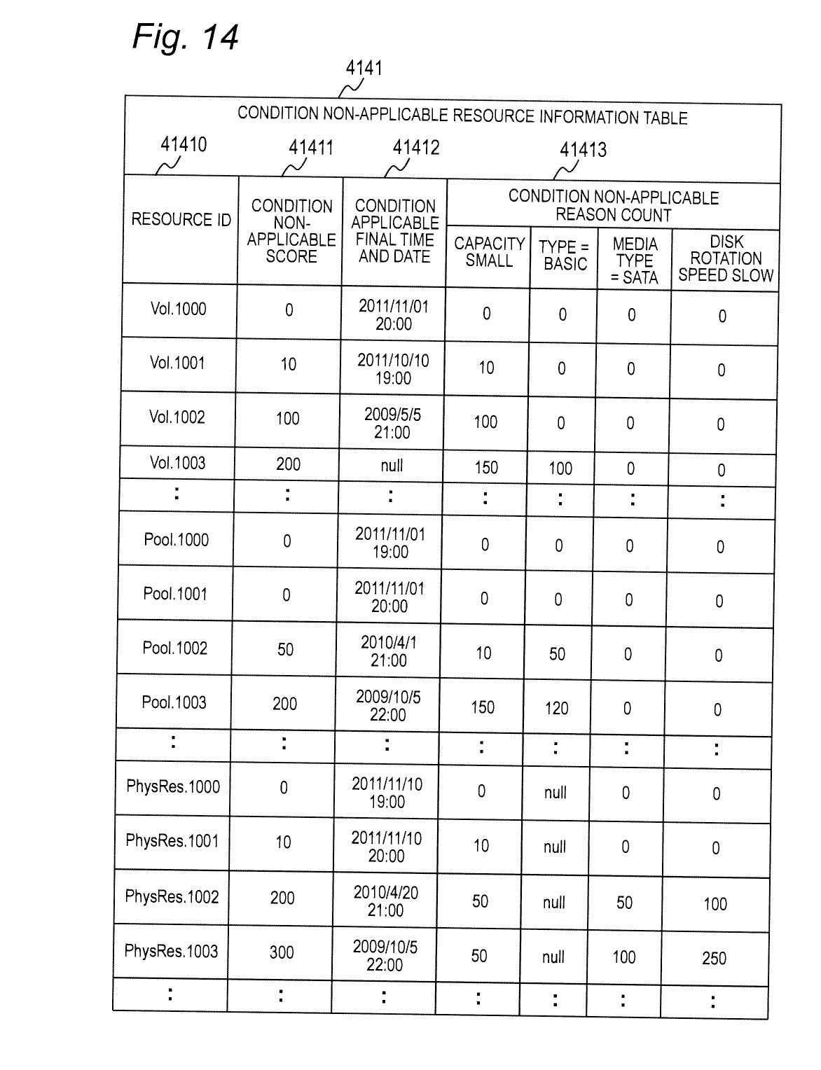

FIG. 14 is a diagram illustrating a specific configuration example of the condition non-applicable resource information table 4141. The condition non-applicable resource information table 4141 includes, as configuration items, a resource ID 41410 for identifying the resource, a condition non-applicable score 41411 indicating a degree of difficulty for the resource in matching the condition, condition applicable final time and date 41412 indicating the time and date when the resource at last matched the condition, and a condition non-applicable reason count 41413 indicating the reason why the resource did not match the condition.

In FIG. 14, the condition non-applicable reason count 41413 includes an item indicating that the reason why the resource did not match the condition is that the capacity is small, an item indicating the reason is that the type of the pool is “Basic”, an item indicating that the reason is that the type of the media is “SATA”, and an item indicating that the reason is that the disk rotation speed is slow, but they are not limiting, and other items indicating the reason why the condition is not matched can be included.

A specific calculation method of the information to be stored in the condition non-applicable score 41411 will be described later, but the condition non-applicable scorer 41411 stores the number of accumulated times of search in which the resource did not match the condition when the configuration management program 4110 searched the resource.

Moreover, a specific calculation method of the information to be stored in the condition non-applicable reason count 41413 will also be described later, but the condition non-applicable reason count 41413 stores the number of accumulated times when the condition was not matched for each reason corresponding to the unsatisfied condition if the resource did not match the condition.

Here, values to be stored in the condition non-applicable score 41411, the condition applicable final time and date 41412, and the condition non-applicable reason count 41413 will be described by using the logical volume A having a capacity of 1 TB and the logical volume B having a capacity of 500 GB as a specific example. Here, initial values of the condition non-applicable score 41411, the condition applicable final time and date 41412, and the condition non-applicable reason count 41413 are assumed to be “0”, “null” and “0”, respectively.

If a logical volume is searched with designating a condition that “the capacity is 700 GB or more”, for example, the logical volume A having the capacity of 1 TB matches the condition, but the logical volume B having the capacity of 500 GB does not match the condition. Here, the condition non-applicable score 41411 of the logical volume A remains “0”, while “1” is stored in the condition non-applicable score 41411 of the logical volume B.

Moreover, since the logical volume A matched the condition, the time and date when the search was executed (“2011/11/1 20:00”, for example) is stored in the condition applicable final time and date 41412. Since the logical volume B did not match the condition, the condition applicable final time and date 41412 of the logical volume B remains “null”. Furthermore, the items of the condition non-applicable reason count 41413 of the logical volume A all remain “0”, while “1” is stored in the item that “the capacity is small” of the condition non-applicable reason count 41413 of the logical volume B.

If a search is made with designating a condition other than the capacity or if a search is made with designating a plurality of conditions, the condition non-applicable score 41411, the condition applicable final time and date 41412, and the condition non-applicable reason count 41413 are also updated by the similar procedure.

<Management Registration Processing>

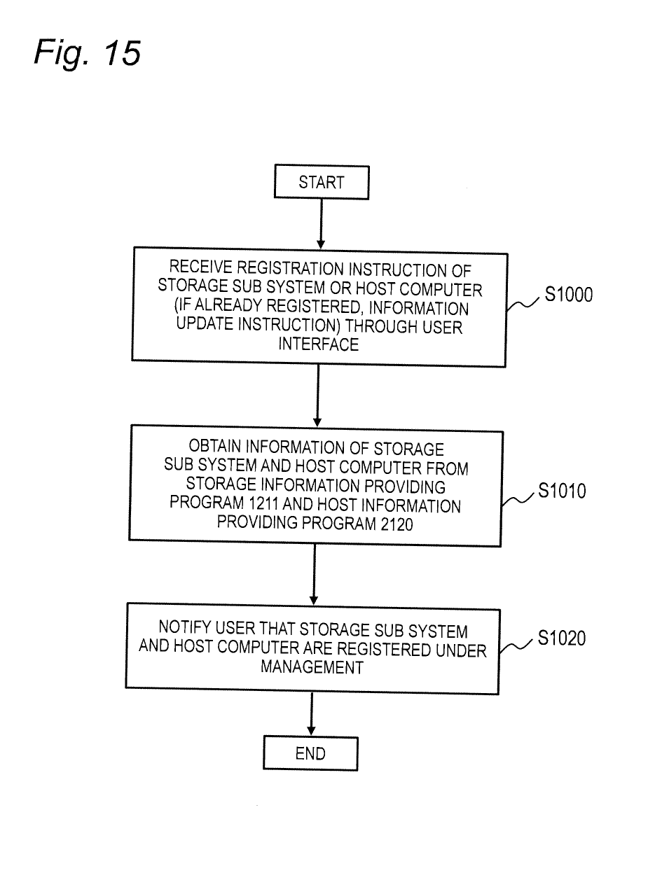

FIG. 15 is a flowchart for explaining processing when the configuration management program 4110 registers the storage array 1000, the second storage array 6000, and the host computer 2000 as management targets in this embodiment. Since the processing for the second storage array 6000 is the same as the processing for the storage array 1000, the explanation will be omitted.

First, at Step S1000, an administrator (user) instructs registration of the storage array 1000 and the host computer 2000 as management targets of the configuration management program 4110 through a user interface of the configuration management program 4110, and the configuration management program 4110 receives the instruction.

In this embodiment, if the administrator (user) designates the storage array 1000 or the host computer 2000 which has been already registered, it is assumed that the administrator instructs to re-obtain and update the configuration information of the storage array 1000 or the host computer 2000 stored in the configuration information table group 4120.

Subsequently, at Step S1010, the configuration management program 4110 conducts communication with the storage information providing program 1211 on the storage array 1000 or the host information providing program 2120 on the host computer 2000, obtains the configuration information of the storage array 1000 and the host computer 2000 and stores it in the configuration information table group 4120.

Finally, at Step S1020, the configuration management program 4110 notifies the administrator that the storage array 1000 and the host computer 2000 have been registered as the management targets. Notification methods include, but are not particularly limited to, a method of notification via a user interface such as GUI (Graphical User Interface) or CLI (Command Line Interface) and a method of outputting a message on a log.

Through the above-described processing, the processing of registering the storage array 1000 and the host computer 2000 as the management targets of the configuration management program 4110 is completed. This processing does not necessarily have to be executed with registration by the user of the storage array 1000 and the host computer 2000 as the management targets of the configuration management program 4110 as a trigger. That is, the configuration management program 4110 may detect presence of the storage array 1000 or the host computer 2000 connected via the switch device 5000 by using a technology such as SLP (Service Location Protocol), and, triggered by that, the registration processing may be executed.

<Search Processing of Free Resource 1>

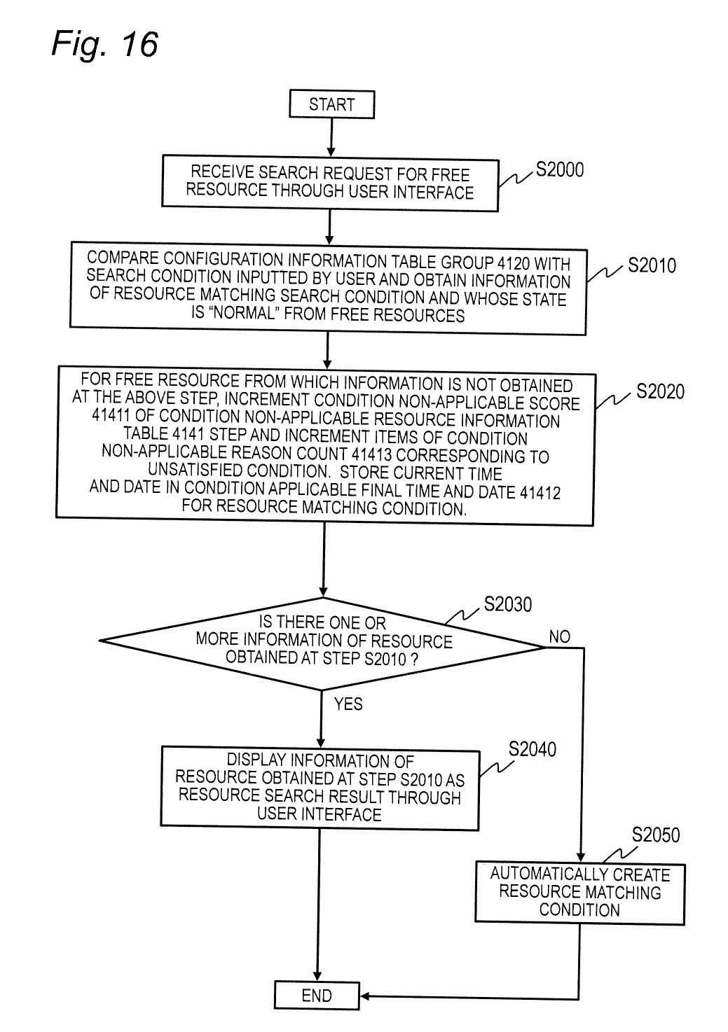

FIG. 16 is a flowchart for explaining processing when the configuration management program 4110 searches a specific free resource from the resources of the storage array 1000 and the second storage array 6000 in this embodiment. Since the processing for the second storage array 6000 is similar to the processing for the storage array 1000, the explanation will be omitted.

First, at Step S1000, the administrator (user) instructs execution of search with a condition (search condition) for searching a specific free resource via the user interface of the configuration management program 4110, and the configuration management program 4110 receives the instruction.

Subsequently, at Step S2010, the configuration management program 4110 compares the information stored in the configuration information table group 4120 with the condition (search condition) inputted by the user and obtains the information of the resource matching the search condition and whose state is “normal” from the free resources. An example of a method of determining whether or not the resource is free is as follows.

For example, if the resource to be searched is the logical volume 1110, the configuration management program 4110 determines that the resource is free if the logical volume is not assigned to the host computer. If the resource to be searched is the pool 1120, the configuration management program 4110 determines that the resource is free if a free space of the pool is 0 or more. If the resource to be searched is the physical resource 1121, the configuration management program 4110 determines that the resource is free if the physical resource does not configure a pool.

Moreover, methods for determining whether or not the search condition is matched include a method of determining that the search condition is matched if the value indicated in the search condition fully matches the value obtained from the configuration information table group 4120, and a method of determining that the search condition is matched if the value obtained from the configuration information table group 4120 is included in the value indicated in the search condition, for example.

The former is a method of determining that only the logical volume whose capacity is exactly 500 GB matches the search condition if the logical volume is searched on a search condition of “the capacity is 500 GB”, for example. On the other hand, the latter is a method of determining that the logical volume whose capacity is 500 GB or the logical volume whose capacity is 1 TB matches the condition if a logical volume is searched on a search condition that “the capacity is 500 GB or more”, for example.

Subsequently, at Step S2020, the configuration management program 4110 increments the condition non-applicable score 41411 of the condition non-applicable resource information table 4141 for the free resource for which the information was not obtained at Step S2010 (a free resource not applicable to the conditions at Step S2010, that is, a free resource not matching the search condition or a free resource whose state is not “normal”) and further increments the item of the condition non-applicable reason count 41413 corresponding to the condition not satisfied by the resource.

Moreover, regarding the resource matching the condition at Step S2010, that is, the free resource matching the search condition and also determined to be “normal”, the configuration management program 4110 stores the current time and date in the condition applicable final time and date 41412 of the condition non-applicable resource information table 4141.

Subsequently, at Step S2030, the configuration management program 4110 determines whether or not there is information of one or more resources obtained at Step S2010 (that is, whether or not there is one or more resources determined to match the condition at Step S2010).

If there is information of one or more applicable resources (YES at Step S2030), the configuration management program 4110 proceeds to Step S2040. If there is no information of the one or more applicable resources (NO at Step S2030), the configuration management program 4110 proceeds to Step S2050.

At Step S2040, the configuration management program 4110 displays the information of the resource obtained at Step S2010 as a search result of the resource via the user interface.

At Step S2050, the configuration management program 4110 automatically generates a resource matching the condition designated by the user. In accordance with a use case of the search function, the processing at Step S2050 is not necessarily executed. For example, if the search function is used in a series of processing configuring a management operation to assign the logical volume 1110 to the host computer 2000, when there is no logical volume matching the condition, the configuration management program 4110 may automatically generate a logical volume matching the condition by the processing at Step S2050.

On the other hand, if the user executes the management operation with selecting the resource obtained as the search result after the search function is executed, the configuration management program 4110 does not have to execute the processing at Step S2050. As described above, the configuration management program 4110 can determine whether or not the processing at Step S2050 is to be executed in accordance with which processing the processing in FIG. 16 starts at.

Through the above-described processing, the processing of searching a free resource from the resources of the storage array 1000 and the second storage array 6000 is completed.

<Search Processing of Free Resource 2>

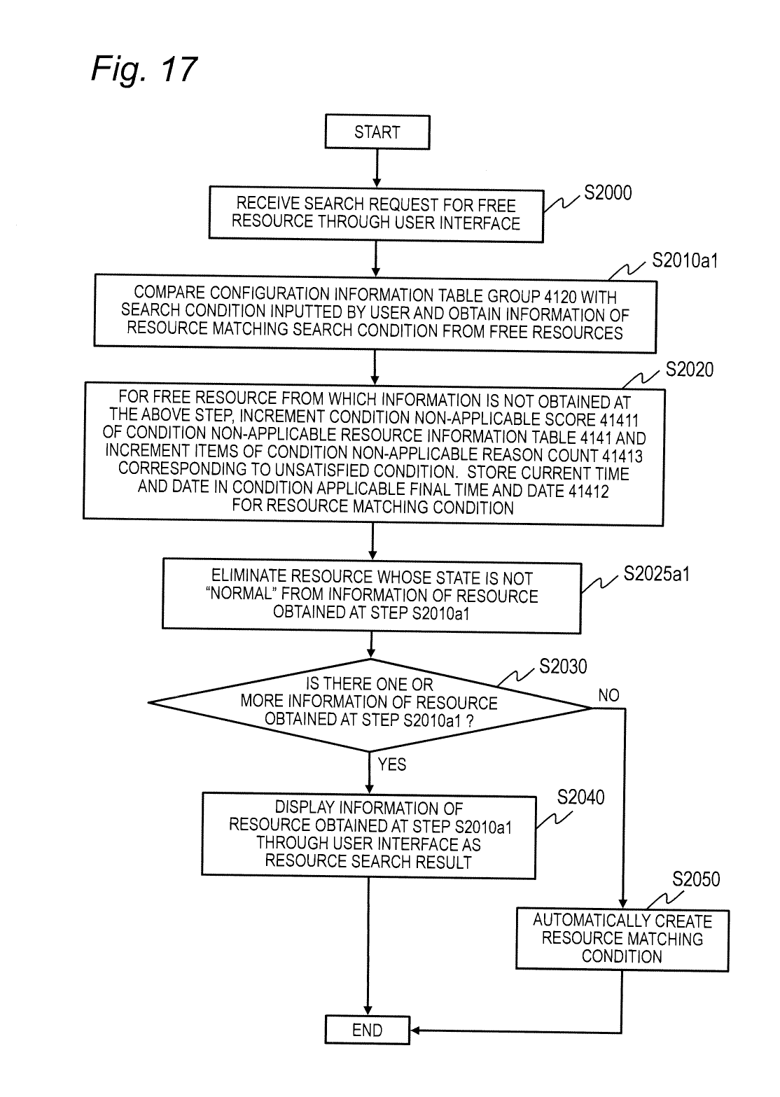

FIG. 17 is a flowchart for explaining another example of the processing when the configuration management program 4110 searches a free resource from the resources of the storage array 1000 and the second storage array 6000. Since most of the processing in FIG. 17 is similar to the processing in FIG. 16, a difference, from the processing in FIG. 16 will be described.

In FIG. 17, the configuration management program 4110 executes processing at Step S2010a1 after the processing at Step S2000 is completed. At Step S2010a1, the configuration management program 4110 compares information stored in the configuration information table group 4120 with the condition inputted by the user (search condition) and obtains the information of the resource matching the search condition from free resources.

Moreover, in FIG. 17, the configuration management program 4110 executes processing at Step S2025a1 after Step S2020 is completed. At Step S2025a1, the configuration management program 4110 excludes the information of the resource whose state is not “normal” from the information of the resource obtained at Step S2010 (that is, the resource matching the search condition).

Here, a difference in an aim between the processing in FIG. 16 and the processing in FIG. 17 will be described. Assume a resource matching the search condition inputted by the user but whose state is not “normal”. In the processing in FIG. 16, the resource is determined not to match the condition at Step S2010 and as a result, the condition non-applicable score 41411 of the condition non-applicable resource information table 4141 is incremented at Step S2020.

On the other hand, in the processing in FIG. 17, the applicable resource is determined to match the condition at Step S2010a1, and the condition non-applicable score 41411 is not incremented at Step S2020. This is based on the idea that the condition non-applicable score 41411 should not be incremented since the applicable resource cannot be used temporarily due to a factor such as a failure, but match the search condition inputted by user.

The condition non-applicable score 41411 is information indicating a degree of difficulty for the resource in matching the condition and its aim is to detect a resource, from the resources of the storage array 1000 or the second storage array 6000, which was considered to have a high usage at the time of generation but, during continuation of the operation of the system, gradually stops satisfying the requested requirement and is hardly used (the processing for that will be described later).

In the processing in FIG. 17, accuracy of the detection of a resource which is hardly used at present is improved by excluding a resource which matches the condition but cannot be used temporarily due to a reason such as a failure from the target used to increment the condition non-applicable score 41411. Since the resource whose state is not “normal” should not be shown in the search result as a free resource, this is excluded from the search result at Step S2025a1 in the processing in FIG. 17.

<Search Processing of Free Resource 3>

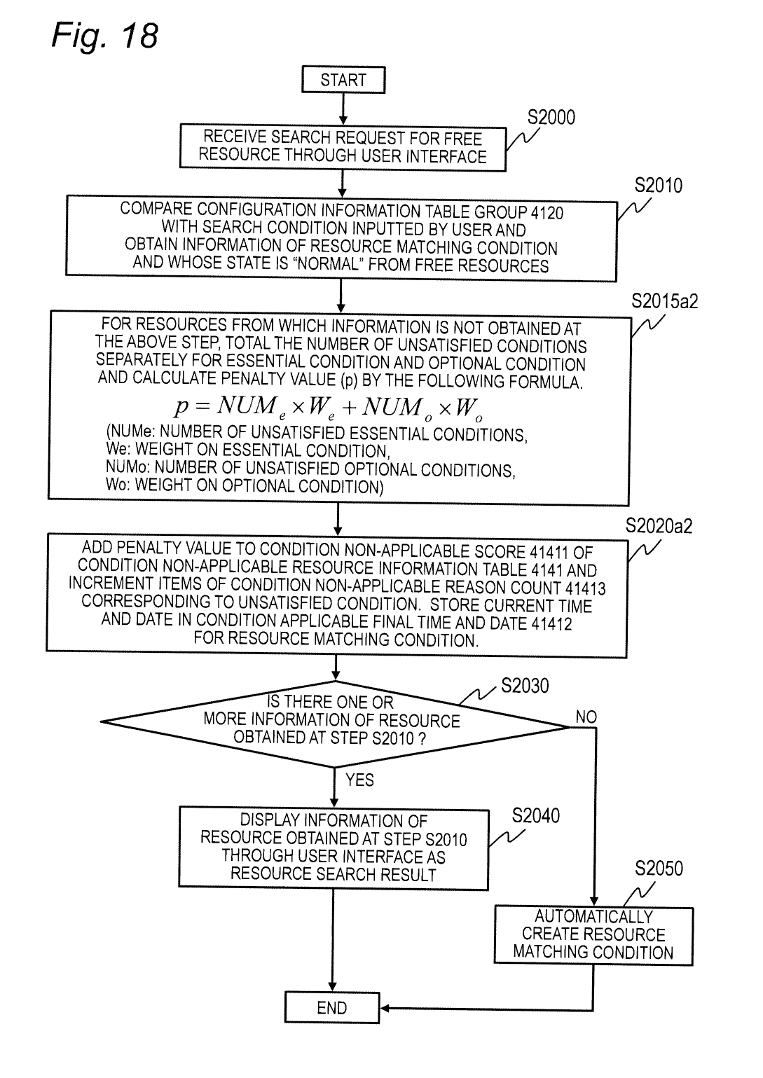

FIG. 18 is a flowchart for explaining another example of the processing when the configuration management program 4110 searches a free resource from the resources of the storage array 1000 and the second storage array 6000. Since most of the processing in FIG. 18 is similar to the processing in FIG. 16, a difference from the processing in FIG. 16 will be described.

In FIG. 18, the configuration management program 4110 executes processing at Step S2015a2 after the processing at Step S2010 is completed. At Step S2015a2, the configuration management program 4110 totals the number of unsatisfied conditions for the condition for which designation is indispensable and the condition for which designation is optional, respectively, for the resource determined not to match the condition at Step S2010 and calculates a penalty value (p) by using the following formula:

p=NUMₑ×Wₑ+NUMₒ×Wₒ [Formula 1]

Here, “NUMe” is the number of unsatisfied indispensable conditions, “We” is a weight determined in advance for the indispensable condition, “NUMo” is the number of the unsatisfied optional conditions, and “Wo” is a weight determined in advance for the optional condition.

When the processing at Step S2015a2 is completed, the configuration management program 4110 proceeds to Step S2020a2. At Step S2020a2, the configuration management program 4110 adds the penalty value (p) calculated at Step S2015a2 to the condition non-applicable score 41411 of the condition non-applicable resource information table 4141 and increments the condition non-applicable reason count 41413 corresponding to the unsatisfied condition. Moreover, the configuration management program 4110 stores the current time and date in the condition applicable final time and date 41412 for the resource matching the condition.

As described above, in the processing in FIG. 18, the method of increasing the value of the condition non-applicable score 41411 is different from the processing in FIG. 16. By executing the processing as in FIG. 18, the number of satisfied conditions can be reflected in the condition non-applicable score 41411, and a difference can be provided between the condition for which designation is indispensable and the condition for which designation is optional by a predetermined weight. The value of and the way to determine the weight is not particularly limited, but it may be so determined that the weight of condition for which designation is indispensable is 2 and that of the condition for which designation is optional is 1, for example.

Here, the difference in calculation of the condition non-applicable score 41411 between the processing in FIG. 16 and that in FIG. 18 will be described by using a specific example. Here, a search for a free logical volume is used as an example. For simplicity, it is assumed that only three search conditions, that is, “capacity”, “type”, and “RAID level” are used. Moreover, it is assumed that “capacity” is the condition for which designation is indispensable, while “type” and “RAID level” are conditions for which designation is optional. It is assumed that as the result of the logical volume search with designating these conditions, the logical volume A and the logical volume B do not match the condition.

In this case, with the method of processing in FIG. 16, the condition non-applicable score 41411 increases only by one for both the logical volumes. On the other hand, with the method of the processing in FIG. 18, if it is assumed that the logical volume A does not satisfy the condition of “type”, while the logical volume B satisfies none of the three conditions, for example, the penalty value (p) is 0×2+1×1=1 for the logical volume A. The penalty value (p) for the logical volume B is 1×2+2×1=4. As a result, the condition non-applicable score 41411 increases only by 1 for the logical volume A but increases by 4 for the logical volume B.

<Search Processing of Free Resource 4>

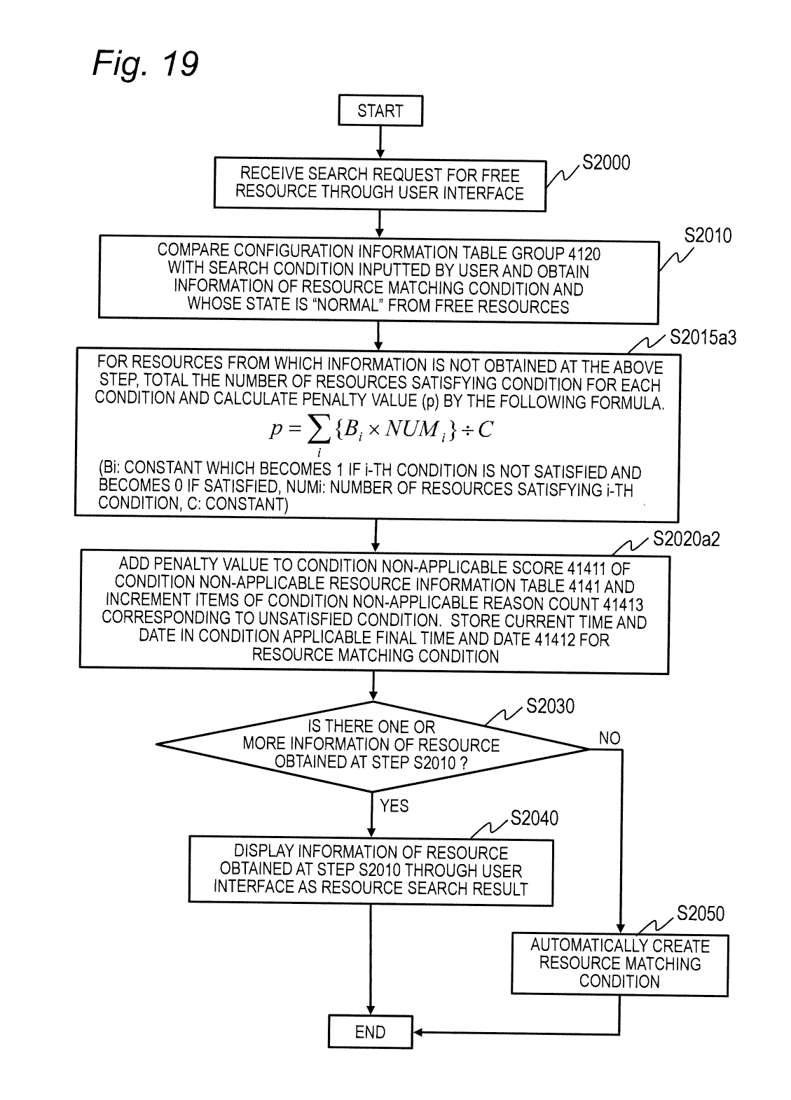

FIG. 19 is a flowchart for explaining another example of the processing when the configuration management program 4110 searches a free resource from the resources of the storage array 1000 and the second storage array 6000 in this embodiment. Since most of the processing in FIG. 19 is similar to the processing in FIG. 18, a difference from the processing in FIG. 18 will be described.

In FIG. 19, the configuration management program 4110 executes processing at Step S2015a3 after the processing at Step S2010 is completed. At Step S2015a3, the configuration management program 4110 totals the number of resources satisfying a condition for each of the conditions for the resources determined not to match the condition at Step S2010, and the penalty value (p) is calculated by using the following formula:

$$p = {\sum }_{i} \{ {B}_{i} \times {NUM}_{i} \} \div C \qquad [ Formula 2 ]$$

Here, Bi is a constant which is 1 if the i-th condition is not satisfied and is 0 when satisfied, NUMi is the number of resources satisfying the i-th condition, and C is a constant determined in advance (100, for example).

The processing in FIG. 18 and the processing in FIG. 19 are different from each other in the calculation method of the penalty value (p). By executing the processing as in FIG. 19, the ease to satisfy each condition (in this embodiment, the ease to satisfy each condition is expressed by using the number of resources satisfying it) can be reflected in the condition non-applicable score 41411.

Here, calculation of the condition non-applicable score 41411 by the processing in FIG. 19 will be described by using a specific example. Here, a search of a free logical volume is used as an example. For simplicity, it is assumed that only three search conditions, that is, “capacity”, “type”, and “RAID level” are used. It is assumed that as the result of the logical volume search by designating these conditions, the logical volume A and the logical volume B do not match the condition. Moreover, in this case, it is assumed that the number of resources satisfying the condition of “capacity” is 1000, the number of resources satisfying the condition of “type” is 500, and the number of resources satisfying the condition of “RAID level” is 300.

Here, if it is assumed, for example, that the logical volume A does not satisfy the condition of “type”, while the logical volume B satisfies none of the three conditions, with the method of processing in FIG. 19, the penalty value (p) is (0×1000+1×500+0×300)/100=5 for the logical volume A. The penalty value (p) for the logical volume B is (1×1000+1×500+1×300)/100=18. As a result, the condition non-applicable score 41411 increases by 5 for the logical volume A but increases by 18 for the logical volume B.

<Example of User Interface Relating to Search for Free Resource>

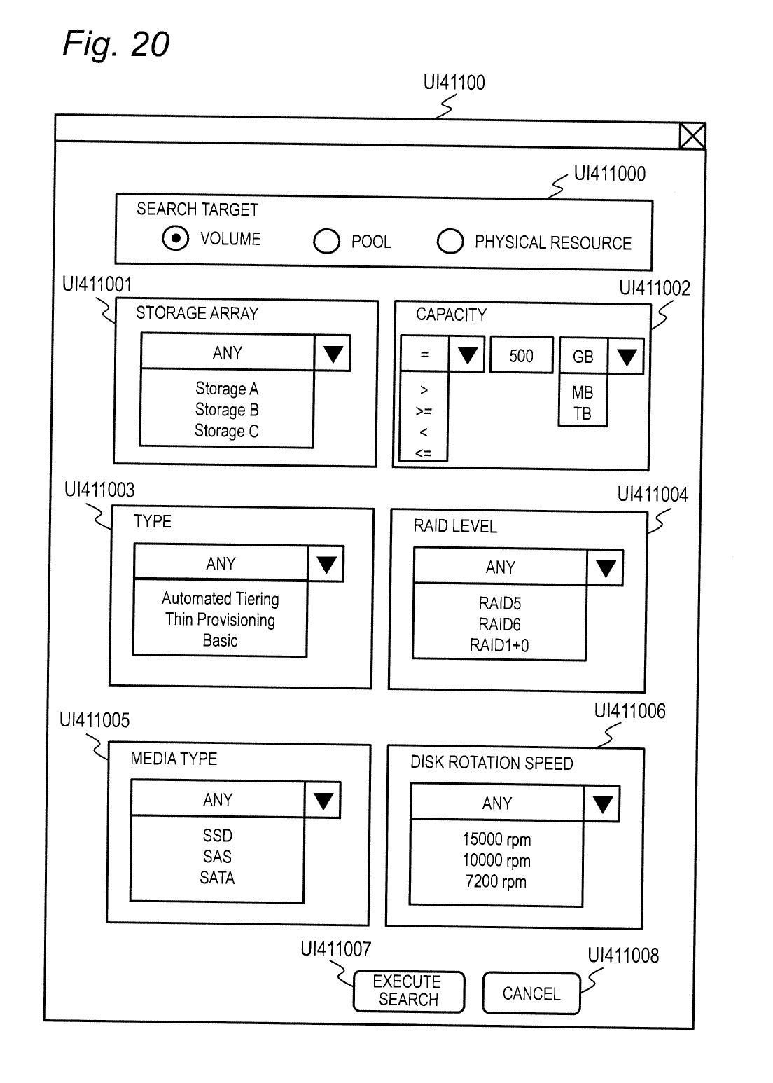

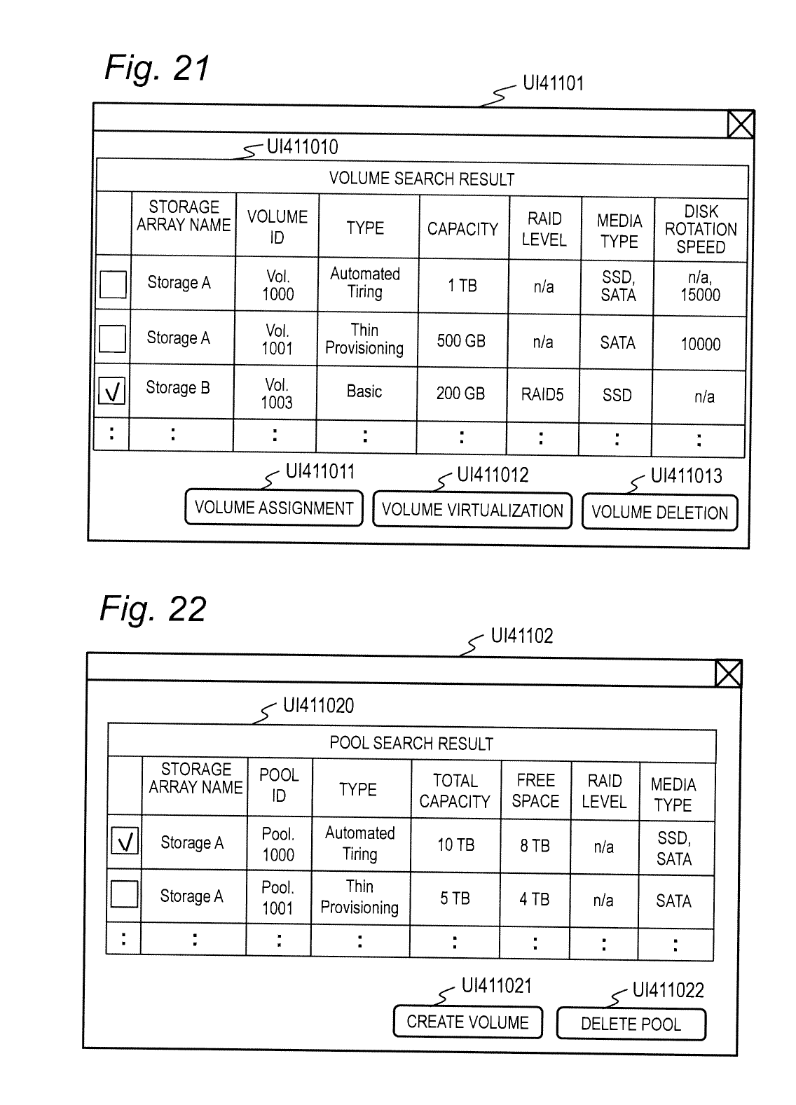

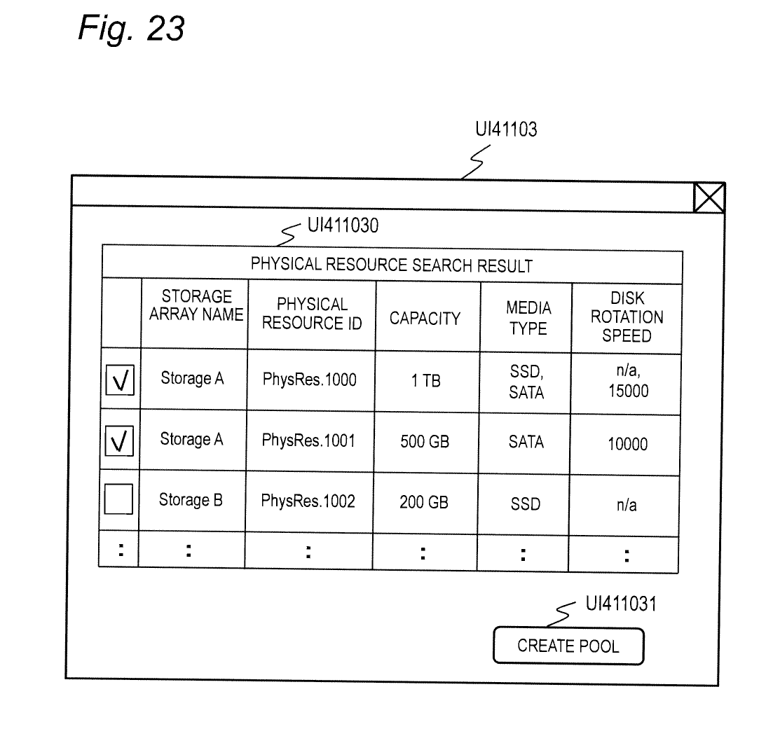

FIGS. 20 to 23 are diagrams illustrating a configuration example of the user interface of the configuration management program 4110 according to the embodiment of the present invention. FIG. 20 corresponds to the user interface for searching a free resource. FIG. 21 corresponds to the user interface indicating a result of a search made for the logical volume. FIG. 22 corresponds to the user interface indicating a result of a search made for the pool. FIG. 23 corresponds to the user interface indicating a result of a search made for the physical resource.

(i) In FIG. 20, the search user interface UI 41100 for a free resource includes, as constituent elements, a search target selection area UI411000, a condition input area UI411001 relating to a storage array, a condition input area UI411002 relating to a capacity, and a condition input area UI 411003 relating to a type.

The search user interface UI41100 for a free resource further includes, as constituent elements, a condition input area UI411004 relating to an RAID level, a condition input area UI411005 relating to a media type, a condition input area UI411006 relating to a disk rotation speed, a button UI411007 for instructing execution of a search, and a button UI411008 for instructing execution cancellation of a search.

The constituent elements of the search user interface UI41100 for a free resource are not limited to the expressions in FIG. 20 but may include other constituent elements. Particularly, a search condition input areas may include input areas for search conditions for other attributes characterizing the logical volume, the pool and the physical resource in addition to the elements illustrated in FIG. 20.

Such other attributes include a condition of whether or not data in the logical volume is to be encrypted, a condition of presence of a function to bring a working state of a physical media which is a providing source of a storage area of the logical volume into a power-saving state (or a stop state) if no access is made from the host computer to the logical volume for a certain period of time, and the like, for example. Moreover, the search condition may be provided separately for the logical volume, the pool and the physical resource in the search target selection area UI411000, for example, display of a condition input area of the user interface UI41100 may be dynamically switched when the search target is selected.

The search target selection area UI411000 is an area for selecting a type of the search target, and in FIG. 20, any one of “volume”, “pool”, and “physical resource” can be selected.

The storage array condition input area UI411001 is an area into which a condition for narrowing the storage array is to be inputted, and in FIG. 20, any one of “ANY”, “Storage A”, “Storage B”, and “Storage C” can be selected.

Here, “Storage A”, “Storage B”, and “Storage C” are all examples of the names of the storage arrays under the control of the configuration management program 4110. If “ANY” is designated, the resource of all the storage arrays under the control of the configuration management program 4110 becomes search targets.

The condition input area UI411002 relating to capacity in FIG. 20 includes an area for selecting a comparison condition (=, < and the like) of the capacity, an area for inputting a numeral value indicating a capacity, and an area for selecting a unit of the capacity. In FIG. 20, in the area for selecting the comparison condition of the capacity, any one of “=”, “>”, “>=”, “<”, and “<=” can be selected. In the area for inputting a numeral value indicating a capacity, an integer larger than 0 can be inputted, and in the area for selecting a unit of the capacity, any one of “MB”, “GB”, and “TB” can be selected.

In FIG. 20, in the condition input area UI411003 relating to a type, any one of “ANY”, “Automated Tiering”, “Thin Provisioning”, and “Basic” can be selected. If “ANY” is selected, the pools of all the types become the search targets.

In the condition input area UI411004 relating to an RAID level, any one of “ANY”, “RAID5”, “RAID6”, and “RAID1+0” can be selected in FIG. 20. If “ANY” is selected, the pools of all the RAID levels become the search targets.

In the condition input area UI41005 relating to a media type, any one of “ANY”, “SSD”, “SAS”, and “SATA” can be selected in FIG. 20. If “ANY” is selected, the pools of all the media types become the search targets.

In the condition input area UI411006 relating to a disk rotation speed, any one of “ANY”, “15000 rpm”, “10000 rpm”, and “7200 rpm” can be selected in FIG. 20. If “ANY” is selected, the pools of all the disk rotation speeds become the search targets.

In this embodiment, the condition input area from which “ANY” can be selected indicates that designation of the condition is optional. That is, in FIG. 20, only the “capacity” is a condition for which designation is indispensable, while designation is optional for the other conditions.

If the button UI411007 instructing execution of a search is pressed after the condition is selected or inputted, any one of the search processing for a free resource illustrated in FIGS. 16, 17, 18, and 19 is executed.

(ii) In FIG. 21, a user interface UI41101 indicating a result of a search made for the logical volume includes a logical volume search result UI411010, a button UI411011 for instructing assignment of a logical volume to the host computer, a button UI1411012 for instructing virtualization of the logical volume, and a button UI411013 for instructing deletion of a logical volume as constituent elements.

The logical volume search result UI411010 in FIG. 21 is comprised of an area for selecting one or more logical volumes and an area for indicating attributes of the logical volume (storage array name, volume ID, type and the like). The attributes of a logical volume are not limited to the expressions in FIG. 21 but other attributes may be displayed.

Moreover, the user interface UI41101 indicating a result of a search for the logical volume may include buttons for instructing execution of other configuring operations to the logical volume, not limited to the button UI411011 for instructing assignment of the logical volume to the host computer, the button UI1411012 for instructing virtualization of the logical volume, and the button UI411013 for instructing deletion of a logical volume.

FIG. 21 is displayed by the processing at Step S2040 as the result of execution of any one of the processing for a logical volume in FIGS. 16, 17, 18, and 19.

(iii) In FIG. 22, the user interface UI 41102 indicating a result of a search for the pool includes, as constituent elements, a pool search result UI411020, a button UI411021 for instructing generation of a logical volume from the pool, and a button UI411022 for instructing deletion of the pool.

The pool search result UI411020 in FIG. 22 is comprised of an area for selecting one or more pools and an area for indicating attributes of the pool (storage array name, ID, type and the like). The attributes of the pool are not limited to the expressions in FIG. 22 but other attributes may be displayed.

Moreover, the user interface UI41102 indicating a result of a search for the pool may include buttons for instructing execution of other configuring operations to the pool, not limited to the button UI411021 for instructing generation of the logical volume from the pool and the button UI411022 for instructing deletion of the pool.

FIG. 22 is displayed by the processing at Step S2040 as the result of execution of any one of the processing for a pool in FIGS. 16, 17, 18, and 19.

(iv) In FIG. 23, the user interface UI41103 indicating a result of a search for the physical resource includes, as constituent elements, a physical resource search result UI411030 and a button UI411031 for instructing generation of a pool from the physical resource.

The physical resource search result UI411030 in FIG. 23 is comprised of an area for selecting one or more physical resources and an area for indicating attributes of the physical resource (storage array name, physical resource ID and the like). The attributes of the physical resource are not limited to the expressions in FIG. 23 but other attributes may be displayed.

Moreover, the user interface UI41103 indicating a result of a search for physical resource may include buttons for instructing execution of other configuring operations to the physical resource, not limited to the button UI411031 for instructing generation of the pool from the physical resource.

FIG. 23 is displayed by the processing at Step S2040 as the result of execution of any one of the processing for a logical volume in FIGS. 16, 17, 18, and 19.

<Identification Processing 1 of Unnecessary Resource>

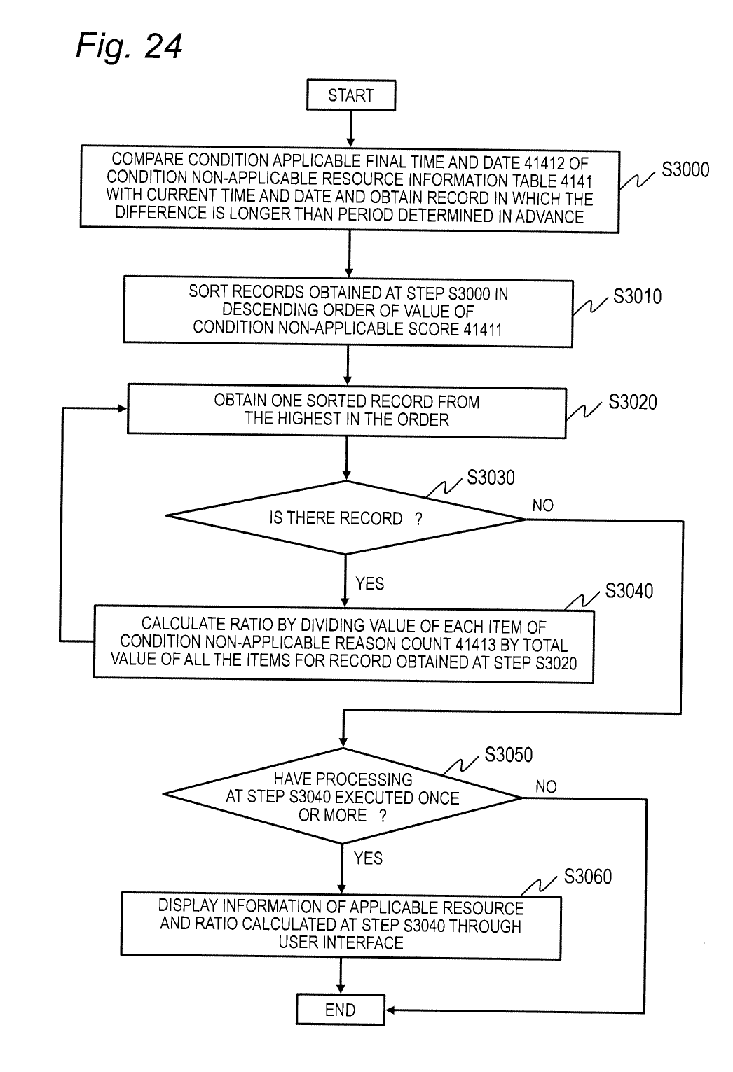

FIG. 24 is a flowchart for explaining an example of processing when the unnecessary resource specification program 4130 specifies a resource hardly matching the condition designated by the user any longer from the resources of the storage array 1000 or the second storage array 6000. The processing in FIG. 24 can be executed at certain intervals by a scheduler function of the configuration management program 4110, for example, but it may be executed at another trigger.

First, at Step S3000, the unnecessary resource specification program 4130 compares the condition applicable final time and date 41412 of the condition non-applicable resource information table 4141 with the current time and date and obtains a record in which the difference is longer than a period determined in advance (6 months, for example).

Subsequently, at Step S3010, the unnecessary resource specification program 4130 sorts the information obtained at Step S3000 in the order from the larger value of the condition non-applicable score 41411. At Step S3020, the unnecessary resource specification program 4130 obtains one of sorted records from the highest order.

At Step S3030, the unnecessary resource specification program 4130 determines whether or not there is the record. If there is the record (YES at Step S3030), the unnecessary resource specification program 4130 proceeds to Step S3040. If there is no record (NO at Step S3030), the unnecessary resource specification program 4130 proceeds to Step S3050.

If it is determined at Step S3030 that there is the record (YES at Step S3030), at Step S3040, the unnecessary resource specification program 4130 calculates a ratio by dividing the values of each item in the condition non-applicable reason count 41413 by a total value of all the items of the condition non-applicable reason count 41413 for the record obtained at Step S3020. When the processing at Step S3040 is completed, the unnecessary resource specification program 4130 returns to Step S3020.

If it is determined at Step S3030 that there is no record (NO at Step S3030), at Step S3050, it is determined whether or not the unnecessary resource specification program 4130 has executed the processing at Step S3040 has executed once or more. If the processing at Step S3040 has been executed once or more (YES at Step S3050), the unnecessary resource specification program 4130 proceeds to Step S3060. If the processing at Step S3040 is not executed (NO at Step S3050), this flow is finished.

At Step S3060, the unnecessary resource specification program 4130 displays the resource information and the ratio calculated at Step S3040 via the user interface.

<Example of User Interface Relating to Display of Unnecessary Resource Candidate>

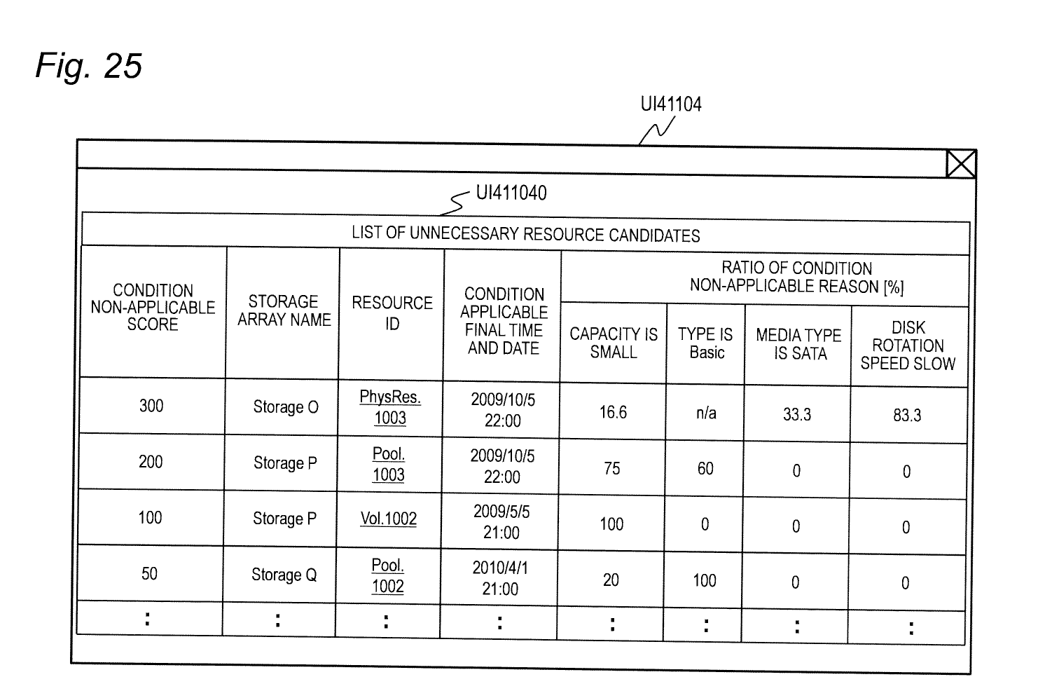

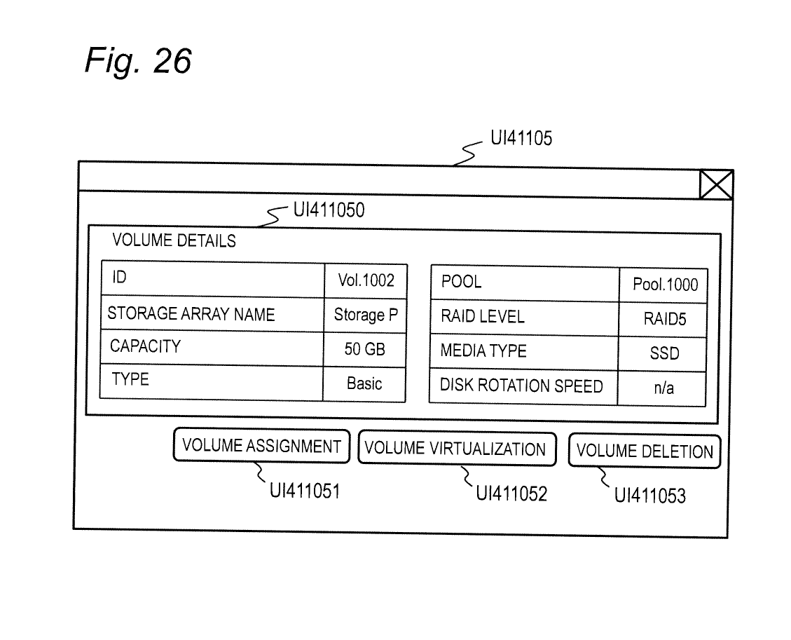

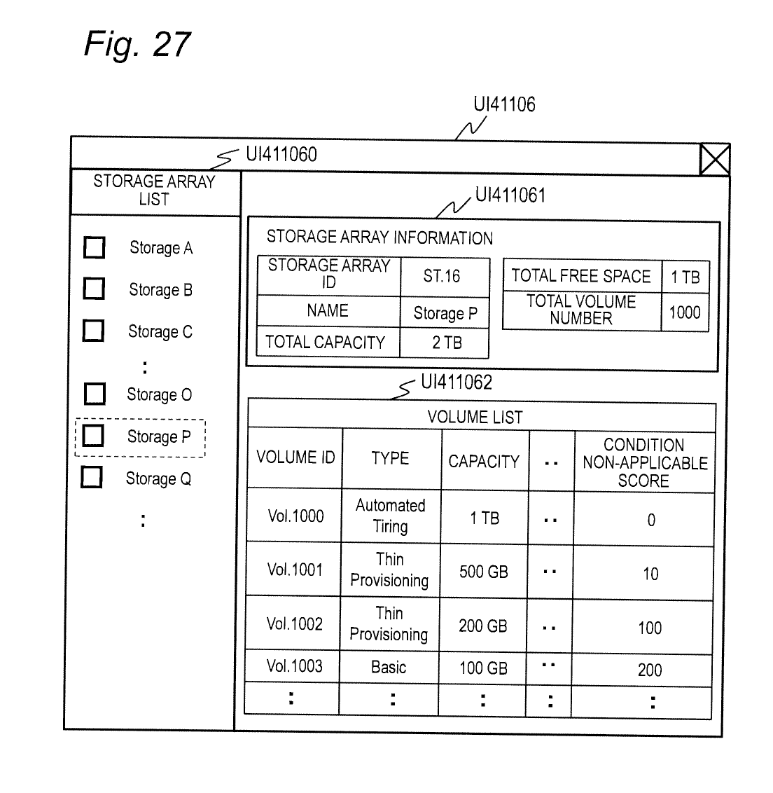

FIGS. 25, 26, and 27 are diagrams illustrating a configuration example of the user interface of the unnecessary resource specification program 4130 in the embodiment of the present invention. FIG. 25 corresponds to a user interface for indicating a list of unnecessary resource candidates. FIG. 26 corresponds to a user interface for indicating detailed information of the unnecessary resource candidates. FIG. 27 corresponds to a user interface for indicating information of the unnecessary resource in the list display of the resources.

(i) In FIG. 25, a user interface UI41104 indicating a list of unnecessary resource candidates includes a list UI411040 of the unnecessary resource candidates as constituent elements. In FIG. 25, the list UI411040 of the unnecessary resource candidates includes a condition non-applicable score, a storage array name, a resource ID, condition applicable final time and date, and a ratio of condition non-applicable reason. The user interface UI41104 indicating a list of unnecessary resource candidates may display other types of information indicating a degree at which the resource is not used and the reason thereof and other types of information indicating the attribute of the resource, not limited to the expressions in FIG. 25.

The user interface in FIG. 25 is displayed by the processing at Step S3060 in FIG. 24. In FIG. 25, the IDs of the resources displayed on the list UI411040 of the unnecessary resource candidates are links for indicating detailed information of the resources, and if the link is pressed, the user interface in FIG. 26 is displayed.

i) FIG. 26 illustrates a user interface indicating detailed information of the logical volume displayed when the link configured for the resource ID of the resource whose resource ID is indicated as “Vol. 1002” (that is, a logical volume) is pressed in the list UI411040 of the unnecessary resource candidates in FIG. 25.

In FIG. 26, a user interface UI41105 indicating detailed information of the unnecessary resource candidates includes, as constituent elements, an area UI411050 for indicating detailed information of a volume, a button UI411051 for instructing assignment of the logical volume to the host computer, a button UI411052 for instructing virtualization of the logical volume and a button UI411053 for instructing deletion of the logical volume.

The user interface UI41105 indicating the detailed information of the unnecessary resource candidates may display other types of detailed information relating to the unnecessary resource candidates, not limited to the expressions in FIG. 26. Moreover, the user interface UI41105 indicating the detailed information of the unnecessary resource candidates may include a button for instructing execution of other configuration operations to the unnecessary resource candidates.

(iii) FIG. 27 illustrates an example of list display of a logical volume as an example of a user interface for indicating information of an unnecessary resource in the list display of the resources. In FIG. 27, the user interface UI41106 indicating the information of the unnecessary resources in the list display of the resources includes an area UI411060 for indicating a list of storage arrays, an area UI411061 for indicating information of the storage arrays, and an area UI411062 for indicating a list of logical volumes.

The area UI411060 for indicating the list of the storage arrays is an area for indicating a list of all the storage arrays under the control of the configuration management program 4110 and one of the storage arrays can be selected. FIG. 27 illustrates a state where “Storage P” is selected.

The area UI411061 indicating information of the storage array is an area for indicating the information of the storage array selected at the area UI411060 indicating a list of the storage arrays. The information to be displayed is not limited to the expressions in FIG. 27, but other types of information relating to the storage arrays may be displayed.

The area UI411062 indicating a list of logical volumes is an area for indicating the list of the logical volumes of the storage array selected in the area UI411060 indicating the list of the storage arrays. In FIG. 27, the area UI411062 indicating the list of logical volumes includes attributes of the logical volume (ID, type, capacity), but not limited to that, it may include other attributes of the logical volume. Moreover, in FIG. 27, the area UI411062 indicating the list of the logical volumes includes a condition non-applicable score, but not limited to that, other types of information relating to a degree at which the resource is not used such as a ratio of the condition non-applicable reason may be included.

<Conclusion>

In the first embodiment, when the management computer (management software) searches a usable resource matching a condition designated by a user (administrator) from the resources of the storage arrays, the management computer records the time and date for the resources matching the condition and the number of accumulated times and the condition not satisfied by the resource for the resource not matching the condition. Moreover, the administrator calculates a score indicating a degree of difficulty for each resource in matching the condition designated by the user on the basis of the information.

The score may be based on the number of accumulated times of the resource not matching the condition or the number of conditions not satisfied by the resource. For the resource which matches the condition but is determined to be not usable due to a temporary factor such as a failure in a storage, the score may be adjusted so that it is not determined to be difficult for the resource to match the condition designated by the user. Furthermore, if the score is calculated on the basis of the number of conditions not satisfied by the resource, weights which are different between the conditions for which designation is indispensable and optional may be used, or the calculation may be made in accordance with the ease of satisfying each condition (the number of resources satisfying each condition).

On the basis of the information, the management computer determines a resource not matching the condition within a period determined in advance prior to the current time and date and presents a score indicating a degree of difficulty for the resource in matching the condition and the condition not satisfied by the resource to the user. By performing as above, the resource with difficulty in matching the condition designated by the user can be identified, and moreover, the condition for which it is difficult for the resource to match can be identified.

Therefore, even in a large-scale storage system, an unnecessary resource can be efficiently discovered from the resources of the storage array. The targets managed by the management software are not limited to the storage arrays but may include a host computer, a switch, a hub, an application program running on the host computer and the like.

The management computer presents a score indicating a degree of difficulty for the resource in matching the condition and the condition not satisfied by the resource to the user via the user interface relating to the list display of the resources having difficulty in matching the condition designated by the user. Then, if a target whose detailed information of the resource is to be displayed (a logical volume, for example) is selected from the user interface of the list display, in response to the selection operation, the management computer displays the detailed configuration information of the resource on the display screen via the user interface of the detailed display.

Moreover, when the list of resources is displayed on the display screen via the user interface relating to the list display of the resources, the management computer presents a score indicating a degree of difficulty for the resource in matching the condition and the condition not satisfied by the resource to the user. By performing as above, the resource which hardly matches the condition designated by the user can be provided to the administrator easily to be seen.

The management computer may determine the unnecessary resource candidate on a condition different from the condition of the above-described condition non-applicable period. For example, the management computer may determine the unnecessary resource candidate on the basis of the number of times of condition non-applicability. The unnecessary resource candidate may be determined on a condition that the number of times of continuation of the condition non-applicability reaches a threshold value or that the number of times of condition non-applicability reaches a threshold value in a predetermined number of times of making determination.

The management computer may compare the above-described score with the threshold value and determine the unnecessary resource candidate based on the comparison result. A threshold value used in the determination of the unnecessary resource candidate is a fixed value or a variable value. The management computer may execute a flow in FIG. 16 and after in response to an event different from the search for a free resource applicable to a search condition such as predetermined time, for example, as described above. The management computer does not have to calculate a penalty value if it is not necessary.

### B. Second embodiment

### Configuration of Computer System

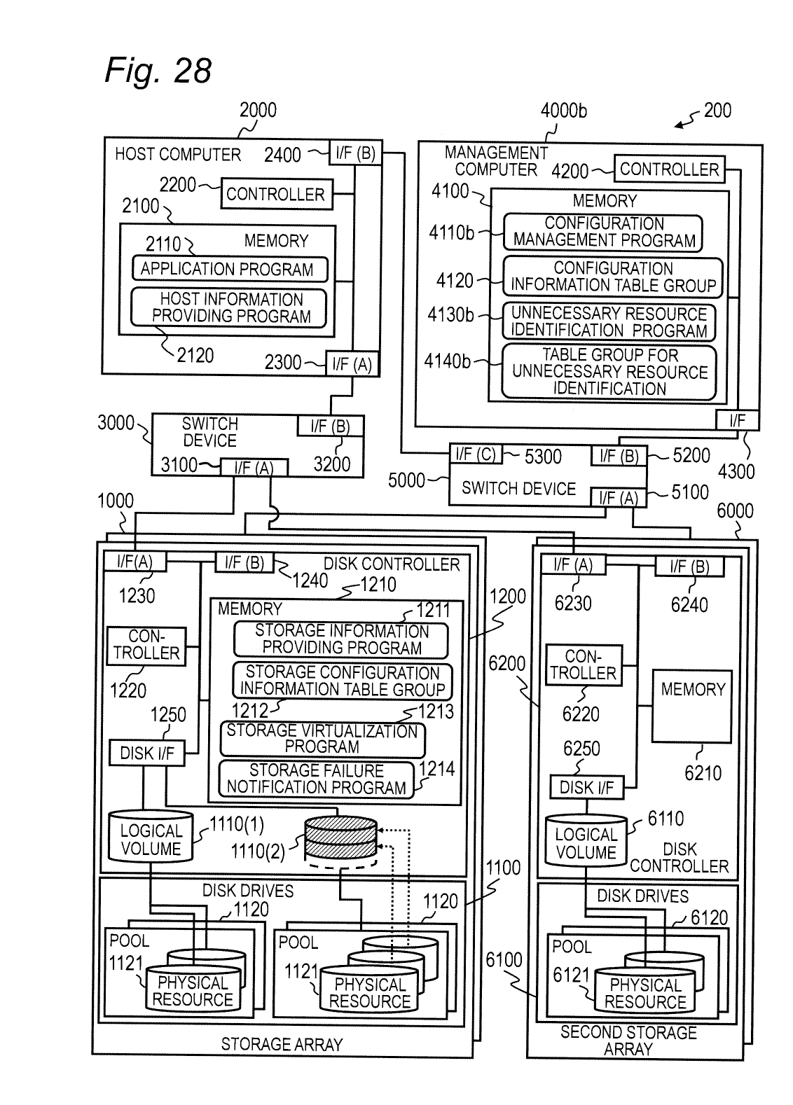

FIG. 28 is a diagram illustrating a schematic configuration of a computer system 200 according to a second embodiment of the present invention. The computer system 200 includes the storage array 1000, the host computer 2000, the switch device 3000, a management computer 4000b, the switch device 5000, and the second storage array 6000.

In the figure, there are two storage arrays 1000 and one host computer 2000, one switch device 3000, one management computer 4000b, and one switch device 5000, but the number of the devices is not limited as above and may be any as long as there is one or more each. Moreover, in the figure, there are two storage arrays 6000, but the number of the devices is not limited as above and may be three or more. Since most of this configuration is equal to the configuration of the first embodiment, a difference will be described below.

A difference from the computer system 100 illustrated in FIG. 1 is a processing sequence when a configuration management program 4110b of the management computer 4000b makes a search for a free resource, a processing sequence when an unnecessary resource specification program 4130b of the management computer 4000b identifies an unnecessary resource and the configuration of a table group 4140b for unnecessary resource specification of the management computer 4000b.

<Table Group for Unnecessary Resource Specification>

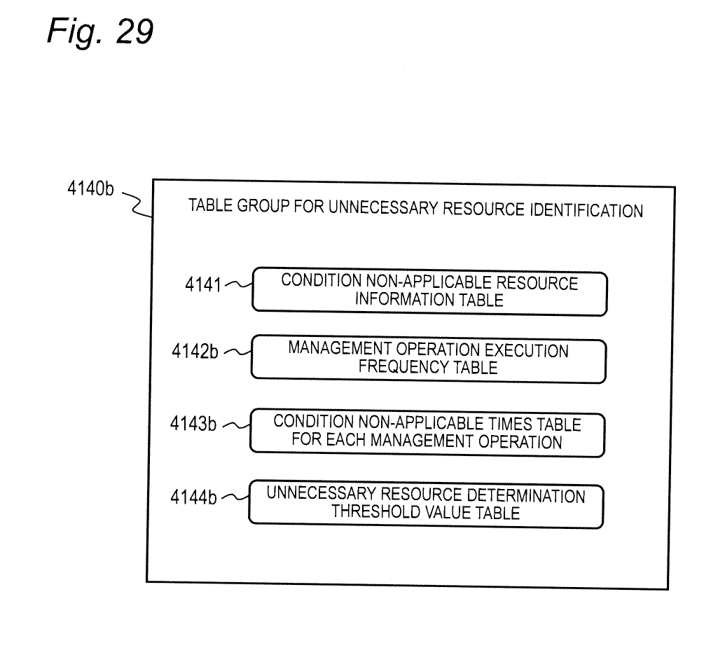

FIG. 29 is a diagram illustrating a configuration example of the table group 4140b for unnecessary resource specification according to the second embodiment. A difference between the table group 4140 for unnecessary resource specification illustrated in FIG. 13 and the table group 4140b for unnecessary resource specification illustrated in FIG. 29 is that the table group 4140b for unnecessary resource specification includes a management operation execution frequency table 4142b, a condition non-applicable times table 4143b for each management operation, and an unnecessary resource determination threshold value table 4144b.

<Configuration Example of Management Operation Execution Frequency Table>

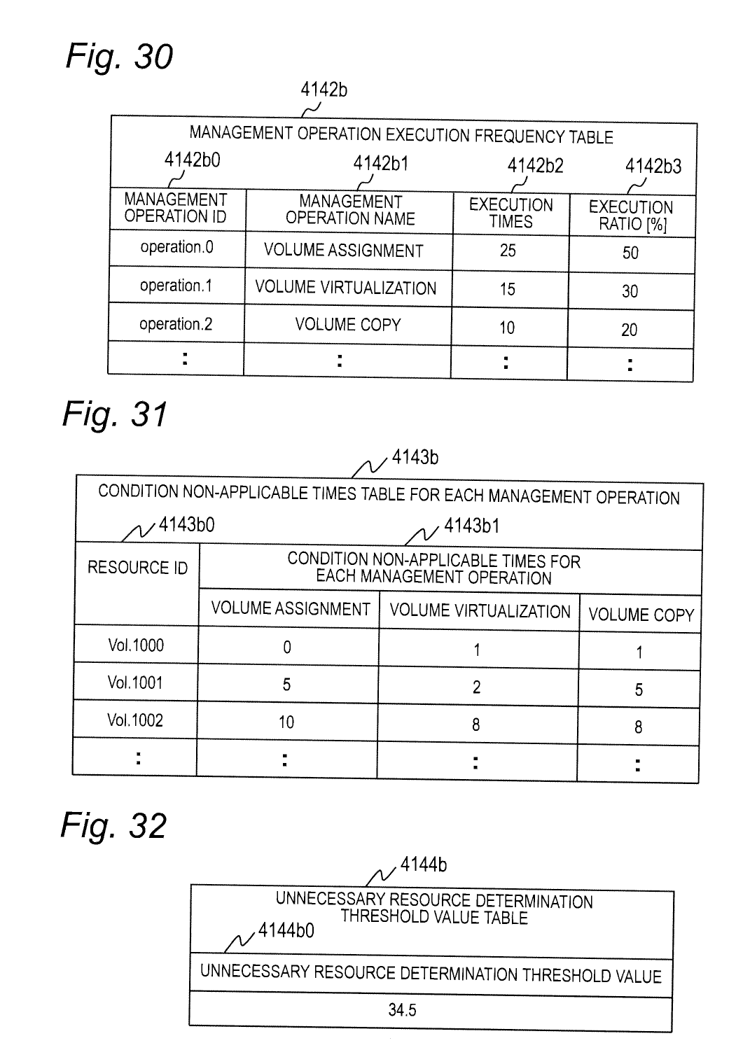

FIG. 30 is a diagram illustrating a configuration example of the management operation execution frequency table 4142b according to the second embodiment. The management operation execution frequency table 4142b includes, as configuration items, a management operation ID 4142b0 for identifying a management operation executed by the user through a configuration management program 4110, a management operation name 4142b1, a management operation execution number of times 4142b2, and a management operation execution ratio 4142b3.

In FIG. 30, the management operation execution ratio 4142b3 is a value indicating a ratio of the execution times 4142b2 of each management operation to the total of the execution number of times 4142b2 of all the management operations stored in the management operation execution frequency table 4142b.

<Configuration Example of Condition Non-Applicable Times Table for Each Management Operation>

FIG. 31 is a diagram illustrating a configuration example of the condition non-applicable times table 4143b for each management operation according to the second embodiment. The condition non-applicable times table 4143b for each management operation includes, as configuration items, a resource ID 4143b0 for identifying a resource of the storage array 1000 and the second storage array 6000 and a condition non-applicable times 4143b1 for each management operation indicating the number of times that each resource does not match the condition when a search for a free resource is made with execution of the management operation as configuration items.

For example, an example of a search for a free logical volume when a user executes a management operation of assigning a logical volume to the host computer through the configuration management program 4110 is assumed. Here, for the resource not matching the condition inputted by the user, a value in the column of “volume assignment” of the condition non-applicable times 4143b1 for each management operation is incremented. Specific processing at this time will be described later.

<Configuration Example of Unnecessary Resource Determination Threshold Value Table>

FIG. 32 is a diagram illustrating a configuration example of the unnecessary resource determination threshold value table 4144b according to the second embodiment. The unnecessary resource determination threshold value table 4144b includes an unnecessary resource determination threshold value 4144b0 which is a threshold value for determining a resource hardly matching the condition designated by the user.

<Contents of Data Processing>

Since most of the processing in this embodiment is the same as the processing contents of the first embodiment, a difference will be described below. Differences between the data processing in the first embodiment and the data processing in this embodiment are a processing sequence when a configuration management program 4110b makes a search for a free resource in the resources of the storage array 1000 and the second storage array 6000 and processing in which the unnecessary resource specification program 4130b identifies a resource hardly matching the condition designated by the user from the resources of the storage array 1000 and the second storage array 6000. These differences will be described below.

<Search Processing of Free Resource 5>

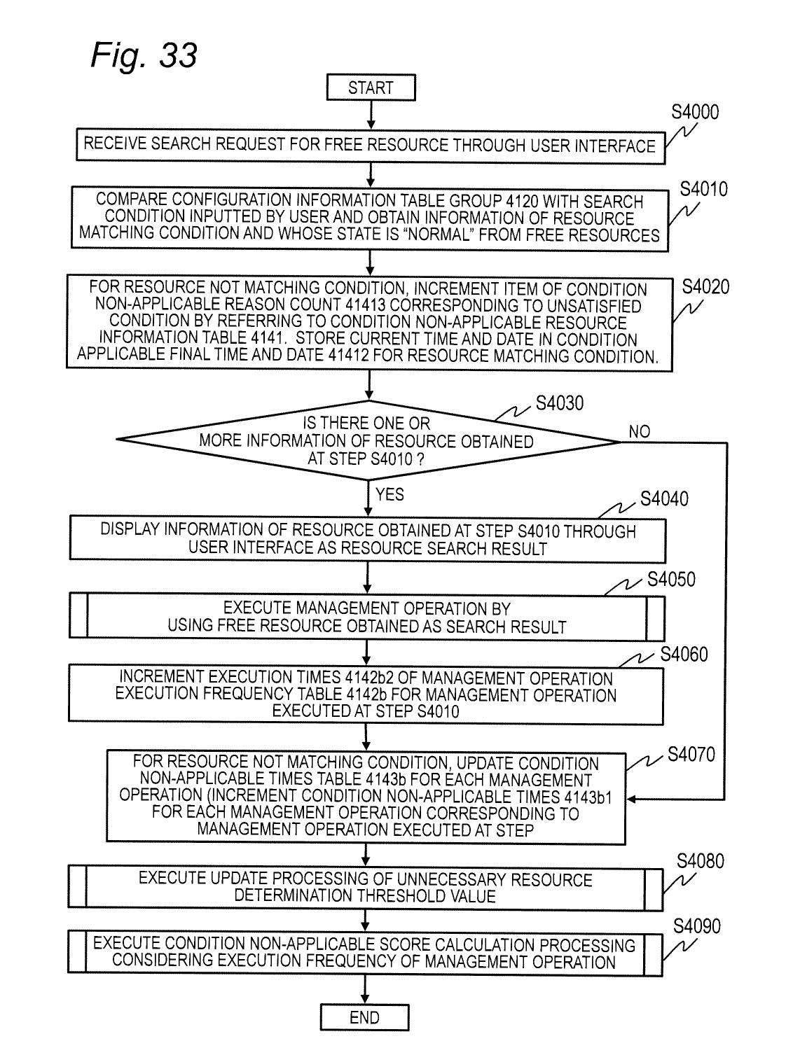

FIG. 33 is a flowchart for explaining processing when the configuration management program 4110b searches a free resource from the resources of the storage array 1000 and the second storage array 6000 in the second embodiment.

First, at Step S4000, the configuration management program 4110b receives a search request of a free resource from a user via the user interface. Subsequently, at Step S4010, the configuration management program 4110b compares the configuration information table group 4120 with a search condition inputted by the user and obtains information of a resource matching the condition and whose state is “normal” from the free resources.

Subsequently, at Step S4020, the configuration management program 4110b refers to the condition non-applicable resource information table 4141 for the resource not matching the condition at Step S4010 and increments the item of the condition non-applicable reason count 41413 corresponding to the unsatisfied condition. Moreover, the configuration management program 4110b stores the current time and date in the condition applicable final time and date 41412 for the resource matching the condition at Step S4010.

Subsequently, at Step S4030, the configuration management program 4110b determines whether or not there is information of one or more resources obtained at Step S4010. If there is information of one or more resources (YES at Step S4030), the configuration management program 4110b proceeds to Step S4040. If there is no information of one or more resources (NO at Step S4030), the configuration management program 4110b proceeds to Step S4070.

At Step S4030, if it is determined that there is information of one or more resources (YES at Step S4030), the configuration management program 4110b displays the information of the resource obtained at Step S4010 as a search result of the resource via the user interface at Step S4040.

Subsequently, at Step S4050, the configuration management program 4110b executes a management operation by using the free resource obtained as the search result. Examples of the management operation include, but are not particularly limited to, processing of assigning a logical volume to the host computer. Moreover, since this processing is executed by using a general storage management function of the configuration management program 4110b, the explanation will be omitted.

Subsequently, at Step S4060, the configuration management program 4110b increments a corresponding value of the execution times 4142b2 of the management operation execution frequency table 4142b for the management operation executed at Step S4010.

Subsequently, at Step S4070, the configuration management program 4110b updates the condition non-applicable times table 4143b for each management operation for the resource not matching the condition at Step 4010. That is, the configuration management program 4110b increments the item of the condition non-applicable times 4143b1 for each management operation corresponding to the management operation executed at Step S4010.

Subsequently, at Step S4080, the configuration management program 4110b executes update processing of the unnecessary resource determination threshold value. Details of this processing will be described later. Finally, at Step S4090, the configuration management program 4110b executes condition non-applicable score calculation processing in the light of an execution frequency of the management operation. This processing will be described later, too.

As described above, in the second embodiment, the processing in which the configuration management program 4110b searches a free resource from the resources of the storage array 1000 and the second storage array 6000 is completed.

<Update Processing of Unnecessary Resource Determination Threshold Value>

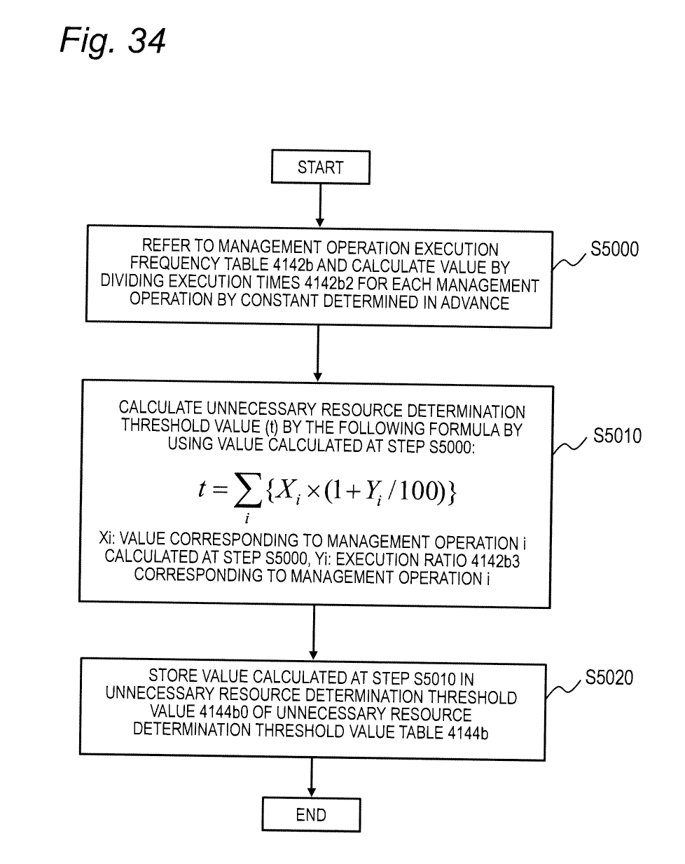

FIG. 34 is a flowchart for explaining processing in which the configuration management program 4110b updates the unnecessary resource determination threshold value in the second embodiment. First at Step S5000, the configuration management program 4110b refers to the management operation execution frequency table 4142b and calculates a value obtained by dividing the execution times 4142b2 for each management operation by a constant determined in advance (2, for example) for all the management operations.

Subsequently, at Step S5010, the configuration management program 4110b calculates an unnecessary resource determination threshold value (t) by using a value calculated at Step S5000 and the following formula:

$$t = {\sum }_{i} \{ {X}_{i} \times ( 1 - {Y}_{i} \text{/} 100 ) \} \qquad [ Formula 3 ]$$

Xi is a value calculated at Step S5000 for a management operation and Yi is a value of an execution ratio 4142b3 corresponding to a management operation i.

Here, calculation of the unnecessary resource determination threshold value (t) will be described by using a specific example. For example, information of the management operation execution frequency table 4142b illustrated in FIG. 30 is used as an example. Here, a value calculated at Step S5000 (that is, the value of Xi) is, assuming the constant determined in advance is 2, “volume assignment” is 25/2=12.5, “volume virtualization” is 15/2=7.5, and “volume copy” is 10/2=5. The value of the unnecessary resource determination threshold value (t) is 12.5×(1+50/100)+7.5×(1+30/100)+5(1+20/100)=34.5.

Finally, at Step S5020, the configuration management program 4110b stores a value calculated at Step S5010 in the unnecessary resource determination threshold value 4144b0 of the unnecessary resource determination threshold value table 4144b.

Through the above-described processing, the processing of updating the unnecessary resource determination threshold value by the configuration management program 4110b is completed.

<Condition Non-Applicable Score Calculation Processing in the Light of Execution Frequency of Management Operation>

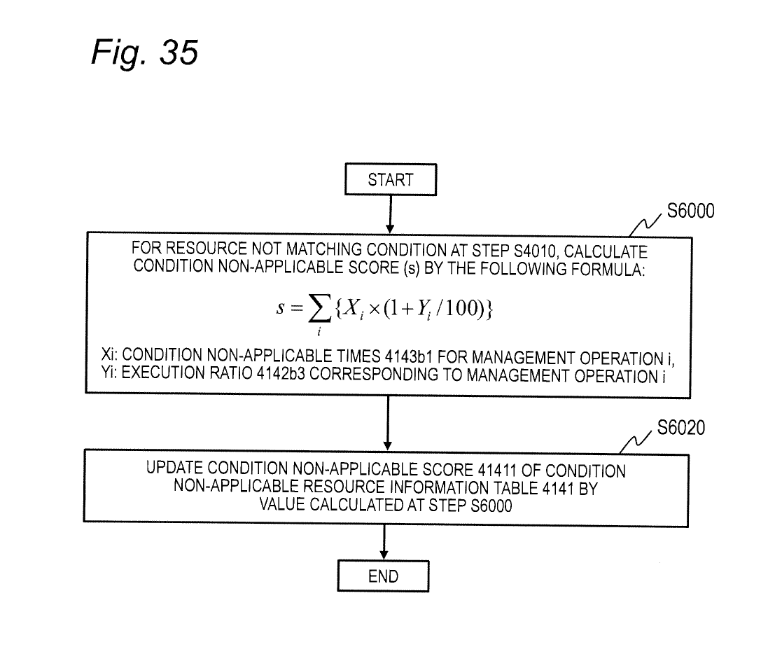

FIG. 35 is a flowchart for explaining processing when the configuration management program 4110b calculates the condition non-applicable score 41411 in the light of the execution frequency of the management operation in the second embodiment.

First, at Step S6000, the configuration management program 4110b calculates the condition non-applicable score (s) by using the following formula for the resource determined not to match the condition at Step S4010.

$$s = {\sum }_{i} \{ {X}_{i} \times ( 1 + {Y}_{i} \text{/} 100 ) \} \qquad [ Formula 4 ]$$

Here, Xi is the condition non-applicable times 4143b1 for the management operation i and Yi is the execution ratio 4142b3 corresponding to the management operation i.

In the above-described processing of calculating the unnecessary resource determination threshold value (t), assuming that the constant determined in advance is set to 2, a condition non-applicable score (s) if the condition non-applicable times for each management operation is exactly a half of the search execution times is considered as the unnecessary resource determination threshold value (t).

Finally, at Step S6020, the configuration management program 4110b updates the condition non-applicable score 41411 of the condition non-applicable resource information table 4141 by a value calculated at Step S6000.

Through the above-described processing, the processing in which the configuration management program 4100b calculates the condition non-applicable score 41411 in the light of the execution frequency of the management operation is completed in the second embodiment. As described above, in the processing in FIG. 35, when the condition non-applicable score 41411 is to be calculated, the resource not matching the condition in the free resource search executed with the management operation with a higher execution frequency can have a higher condition non-applicable score 41411 than the resource not matching the condition in the free resource search executed with the management operation with a lower execution frequency.

<Identification Processing of Unnecessary Resource 2>

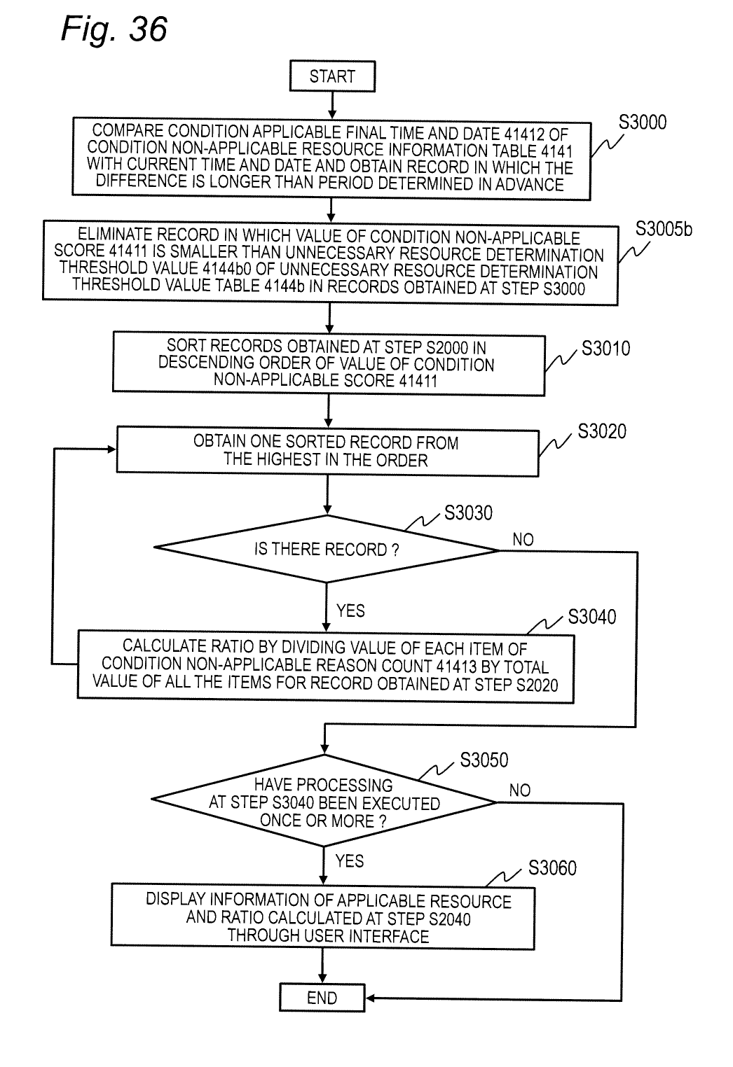

FIG. 36 is a flowchart for explaining an example of processing in which the unnecessary resource specification program 4130b specifies a resource hardly matching the condition designated by the user any longer from the resources of the storage array 1000 and the second storage array 6000 in the second embodiment. Since most of the processing in FIG. 36 is similar to the processing in FIG. 24, a difference from the processing in FIG. 16 will be explained.

In FIG. 36, the unnecessary resource specification program 4130b proceeds to Step S3005b after the processing at Step S3000 is completed. At Step S3005b, the unnecessary resource specification program 4130b excludes a record in which the value of the condition non-applicable score 41411 is smaller than the unnecessary resource determination threshold value 4144b0 of the unnecessary resource determination threshold value table 4144b in the records obtained at Step S3000.

As described above, the difference from the processing in FIG. 24 is that the unnecessary resource determination threshold value 4144b0 is used in the processing in FIG. 36, when the unnecessary resource specification program 4130b specifies the resource hardly matching the condition specified by the user any longer in the resources of the storage array 1000 and the second storage array 6000.

<Conclusion>

In the embodiments in the second embodiment, the management computer records the execution frequency of the management operation when the management computer executes the management operation by using an available resource matching the condition designated by the user (an operation of assigning a logical volume to the host computer, for example). Moreover, the management computer records the number of times for each type of the management operation for the resources not matching the condition.

The management computer calculates a score indicating a degree of difficulty for the resource in matching the condition by using the number of times of the resource not matching the condition and the execution frequency of the management operation for each type of the management operation. By performing as above, in the resource search executed with the management operation with a high execution frequency, the less the resource matches the condition, the higher the possibility to be an unnecessary resource can be determined to be.

### C. Third Embodiment

### Configuration of Computer System

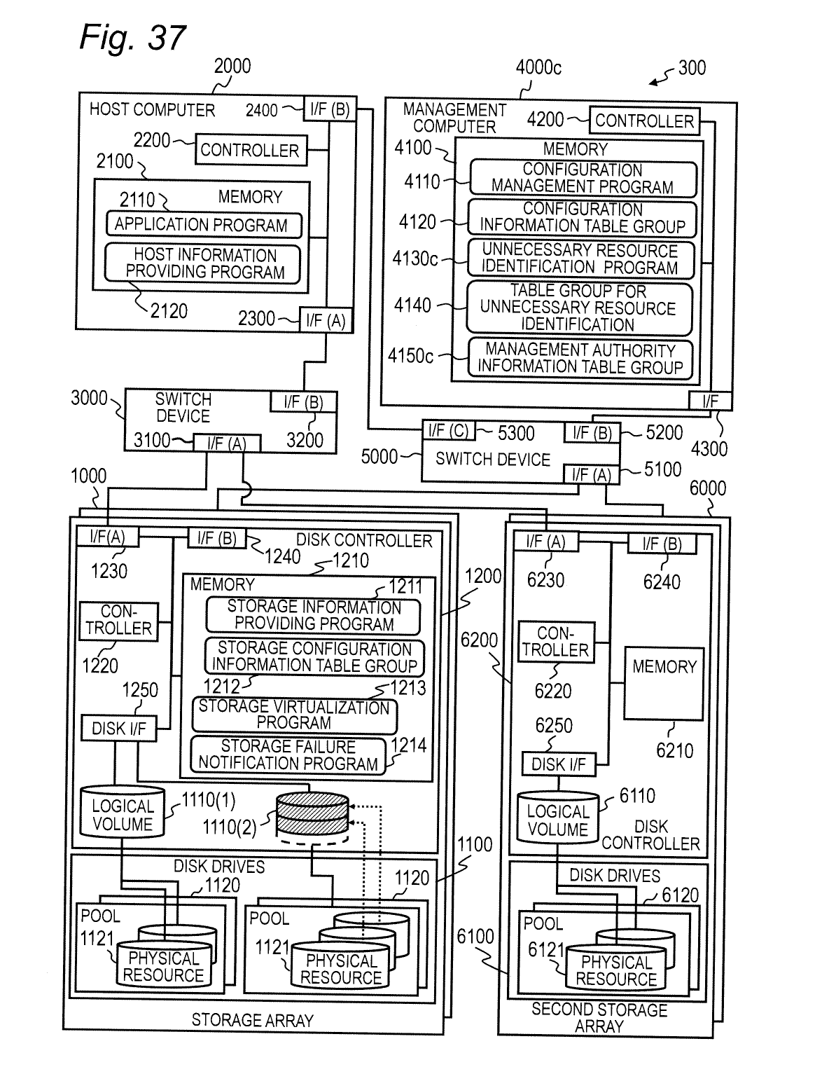

FIG. 37 is a diagram illustrating a schematic configuration of a computer system 300 according to a third embodiment of the present invention. The computer system 300 includes the storage array 1000, the host computer 2000, the switch device 3000, a management computer 4000c, the switch device 5000, and the second storage array 6000.

In the figure, there are two storage arrays 1000 and one host computer 2000, one switch device 3000, one management computer 4000c, and one switch device 5000, but the number of the devices is not limited as above and may be any as long as there is one or more each. Moreover, in the figure, there are two storage arrays 6000, but the number of the devices is not limited as above and may be three or more. Since most of this configuration is equal to the configuration of the first embodiment, a difference will be described below.

A difference from the computer system 100 illustrated in FIG. 1 is a processing sequence of an unnecessary resource specification program 4130c of the management computer 4000c and that the management computer 4000c includes a management authority information table group 4150c.

<Resource Group Information Table Group>

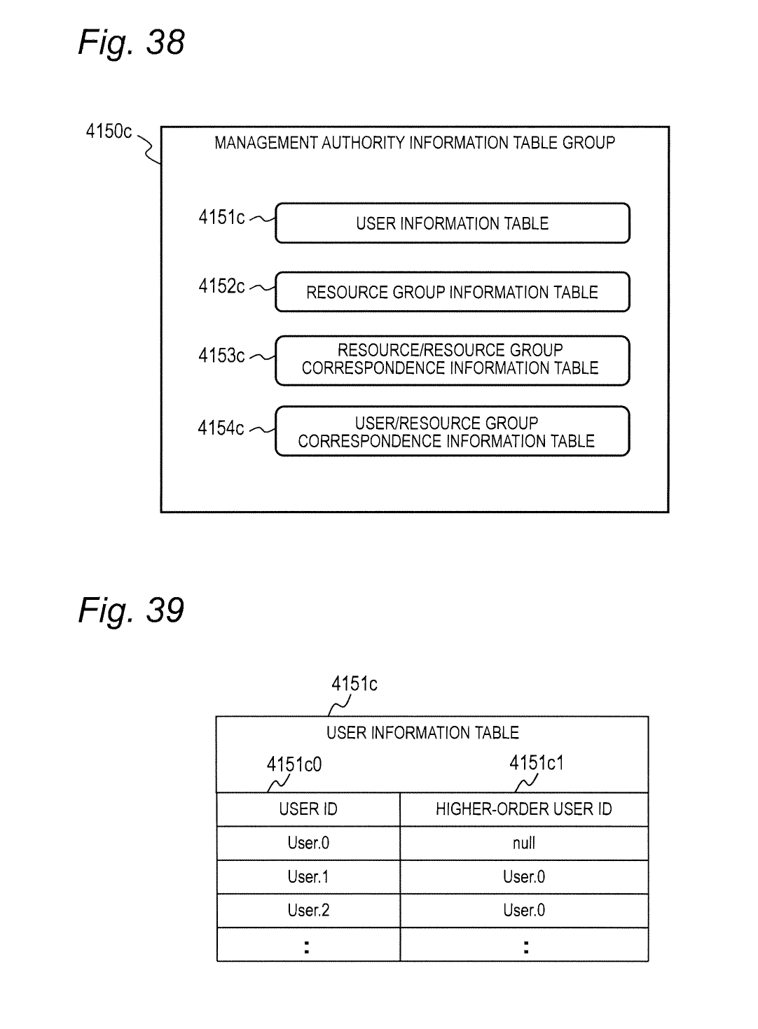

FIG. 38 is a diagram illustrating a configuration example of the management authority information table group 4150c in the third embodiment. The management authority information table group 4150c includes a user information table 4151c, a resource group information table 4152c, a resource/resource group correspondence information table 4153c, and a user/resource group correspondence information table 4154c.

The user information table 4151c is a table for storing information of a user (administrator). The resource group information table 4152c is a table for storing information of a group of the resources of the storage array 1000 and the second storage array 6000. The resource/resource group correspondence information table 4153c is a table for storing information relating to a correspondence relationship between the resource of the storage array 1000 or the second storage array 6000 and the resource group. The user/resource group correspondence information table 4154c is a table for storing information relating to a correspondence relationship between the user (administrator) and the resource group.

<Configuration Example of User Information Table>

FIG. 39 is a diagram illustrating a configuration example of the user information table 4151c in the third embodiment. The user information table 4151c includes, as configuration items, a user ID 4151c0 for identifying a user and a higher-order user ID 4151c1 for identifying a higher-order user assigned to a user.

Here, the higher-order user is a user having a higher-order management authority than a management authority of the other users. For example, an operation to classify the resources of the storage array 1000 and the second storage array 6000 into several resource groups is performed by the higher-order user, and a user is assigned to each of the resource groups for managing each of them.

In FIG. 39, a user with “null” stored in the higher-order ID 4151c1 indicates that the user is the highest-order user. The user information table 4151c may hold other types of information relating to the user (administrator), not limited to the expressions in FIG. 39.

<Configuration Example of Resource Group Information Table>

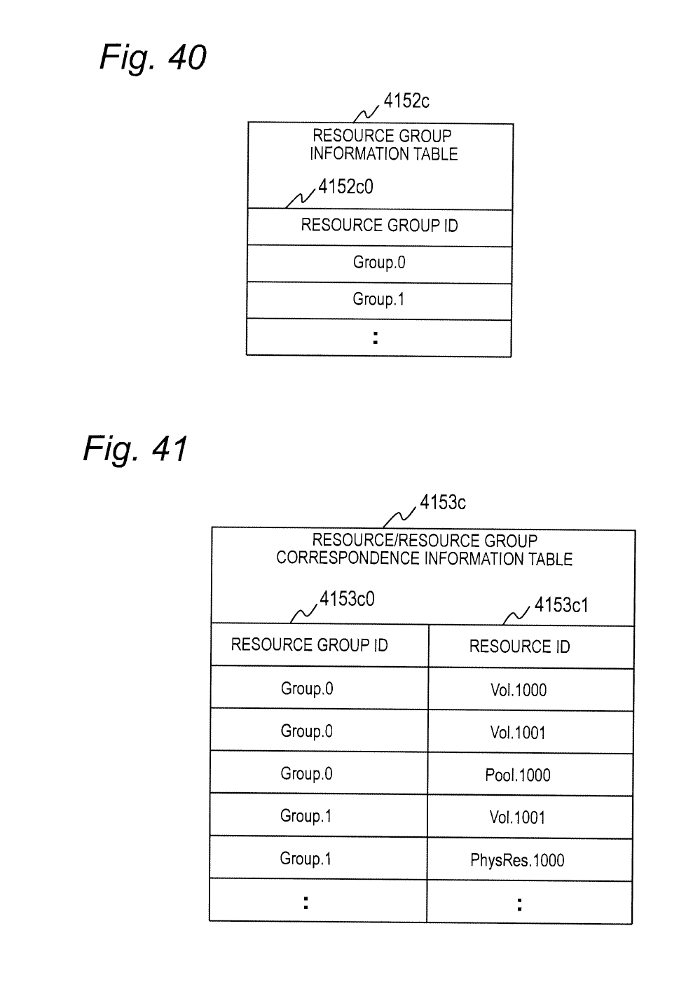

FIG. 40 is a diagram illustrating a configuration example of the resource group information table 4152c according to the third embodiment. The resource group information table 4152c includes a resource group ID 4152c0 for specifying a resource group as a configuration item. The resource group information table 4152c may hold other types of information relating to the resource group, not limited to the expressions in FIG. 40.

<Configuration Example of Resource/Resource Group Correspondence Information Table>

FIG. 41 is a diagram illustrating a configuration example of the resource/resource group correspondence information table 4153c according to the third embodiment. The resource/resource group correspondence, as configuration items, information table 4153c includes a resource group ID 4153c0 for identifying a resource group and a resource ID 4153c1 for identifying a resource. The resource/resource group correspondence information table 4153c may hold other types of information relating to the correspondence relationship between the resource and the resource group, not limited to the expressions in FIG. 41.

<Configuration Example of User/Resource Group Correspondence Information Table>

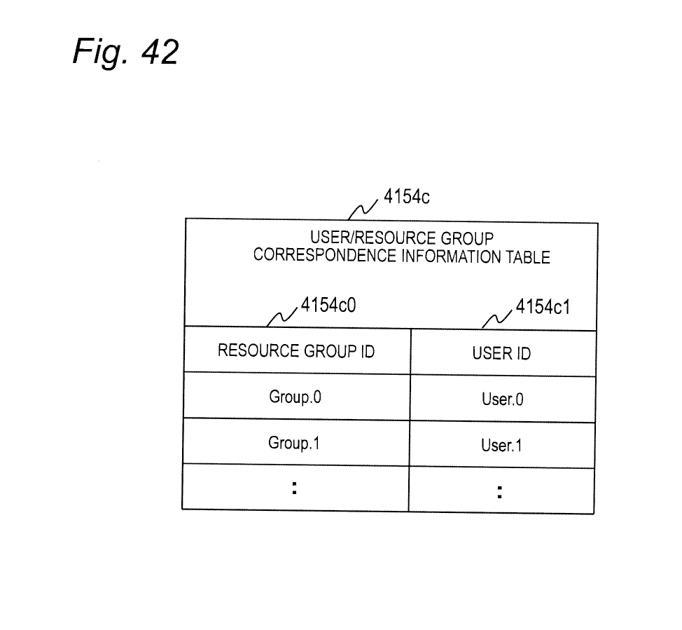

FIG. 42 is a diagram illustrating a configuration example of the user/resource group correspondence information table 4154c according to the third embodiment. The user/resource group correspondence information table 4154c includes, as configuration items, a resource group ID 4154c0 for identifying a resource group and a user ID 4154c1 for identifying a user. The user/resource group correspondence information table 4154c may hold other types of information relating to the correspondence relationship between the resource group and the user, not limited to the expressions in FIG. 42.

<Contents of Data Processing>

Since most of the processing in this embodiment is the same as the processing contents of the first embodiment, a difference will be described below. A difference between the data processing in the first embodiment and the data processing in this embodiment is processing in which the unnecessary resource specification program 4130c specifies a resource hardly matching the condition designated by a user from the resources of the storage array 1000 and the second storage array 6000 and the processing in which the unnecessary resource specification program 4130c presents the applicable information of the resource to a user.

<Identification Processing 3 of Unnecessary Resource>

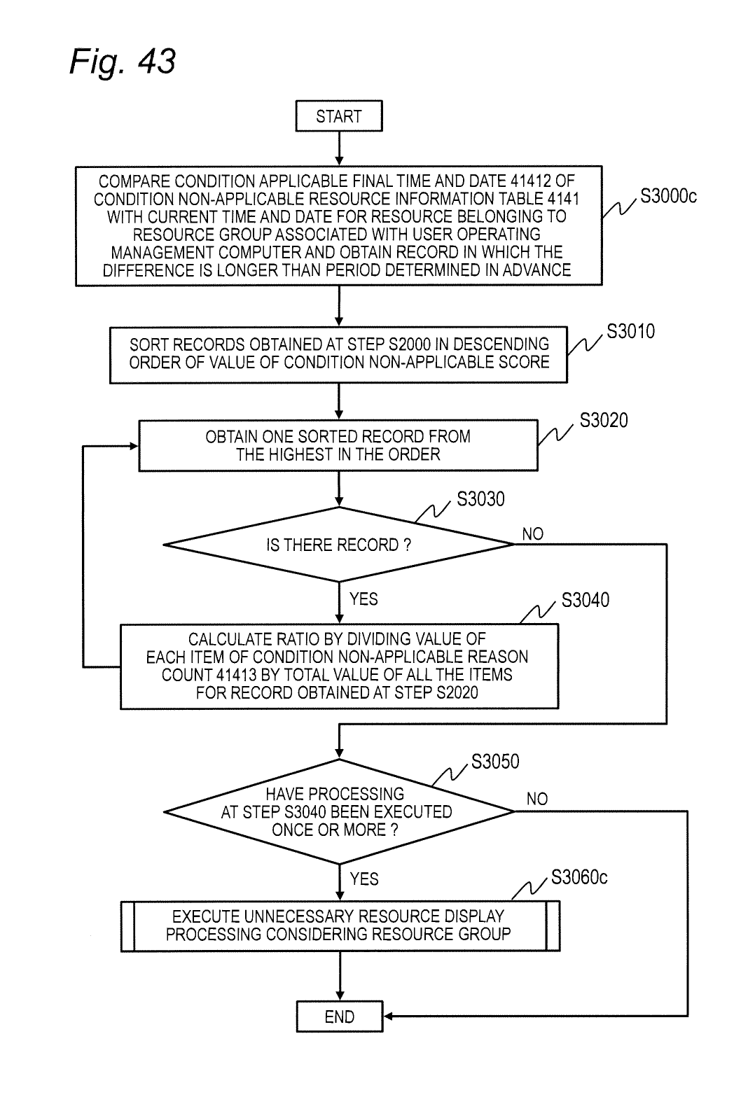

FIG. 43 is a flowchart for explaining processing when the unnecessary resource specification program 4130c specifies a resource hardly matching the condition designated by a user from the resources of the storage array 1000 and the second storage array 6000 according to the third embodiment. Since most of the processing in FIG. 43 is similar to the processing in FIG. 24, a difference from the processing in FIG. 24 will be described.

In FIG. 43, first, at Step S3000c, the unnecessary resource specification program 4130c compares the condition applicable final time and date 41412 of the condition non-applicable resource information table 4141 with the current time and date only for the resources belonging to a resource group associated with a user operating the management computer as targets and obtains a record with a difference longer than a period determined in advance.

Moreover, in FIG. 43, if it is determined at Step S3050 that the processing at Step S3040 was executed once or more (“YES” at Step S3050), the unnecessary resource specification program 4130c proceeds to Step S3060c. At Step S3060c, the unnecessary resource specification program 4130c executes unnecessary resource display processing, considering a resource group. This processing will be described later.

<Unnecessary Resource Display Processing with Considering Resource Group>

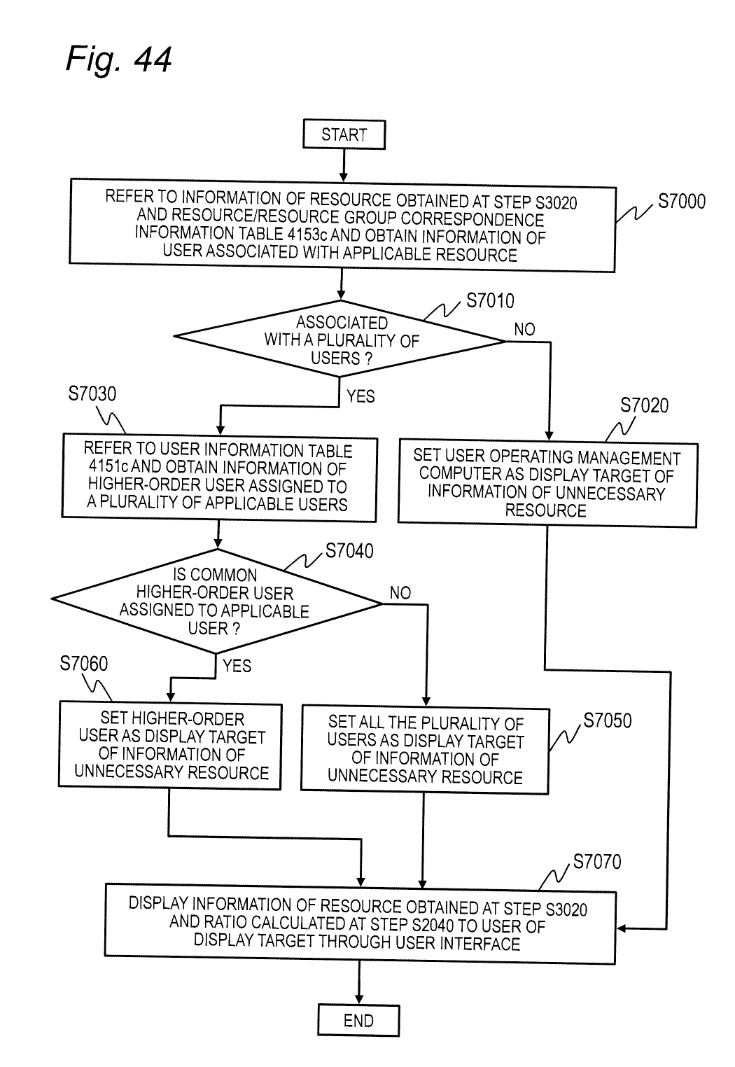

FIG. 44 is a flowchart for explaining processing (Step S3060c) when the unnecessary resource specification program 4130c displays a resource hardly matching the condition designated by a user from the resources of the storage array 1000 and the second storage array 6000 in the third embodiment.

First, at Step S7000, the unnecessary resource specification program 4130c refers to information of a resource obtained at Step S3020 and the resource/resource group correspondence information table 4153c, and obtains information of a user associated with the applicable resource.

Subsequently, at Step S7010, the unnecessary resource specification program 4130c determines whether or not the applicable resource is associated with a plurality of different users. If a plurality of different users are associated (Step S7010: YES), the program proceeds to Step S7030. If the resource is not associated with a plurality of different users (Step S7010: NO), the program proceeds to Step S7020.

At Step S7020, the unnecessary resource specification program 4130c sets a user operating the management computer 4000c as a display target of the information of the unnecessary resource. At Step S7030, the unnecessary resource specification program 4130c refers to the user information table 4151c and obtains information of a higher-order user assigned to the applicable plurality of users.

Subsequently, at Step S7040, the unnecessary resource specification program 4130c determines whether or not a common higher-order user is assigned to the applicable user. If the common higher-order user is assigned (Step S7040; YES), the program proceeds to Step S7060. If the common higher-order user is not assigned (Step S7040: NO), the program proceeds to Step S7050.

At Step S7050, the unnecessary resource specification program 4130c sets all the plurality of users obtained at Step S7000 as display targets of the information of the unnecessary resources. At Step S7060, the unnecessary resource specification program 4130c sets the common higher-order user obtained at Step S7030 as display targets of the information of the unnecessary resources.

Finally, at Step S7070, the unnecessary resource specification program 4130c displays the information of the resource obtained at Step S3020 and the ratio calculated at Step S2040 to the user of a display target via the user interface.

As described above, in the third embodiment, the unnecessary resource specification program 4130c can indicate to the user the information of the resource hardly matching the condition designated by the user from the resources of the storage array 1000 and the second storage array 6000 in the light of the resource group.

<Conclusion>

In the third embodiment, the management computer includes the information of the user using the management computer, the information of the higher-order user having a higher-order management authority to the user, and the information of the resource for which the user has the management authority. On the basis of the information, the management computer determines a user as a target to whom the information of the resource with difficulty in matching the condition designated by the user is to be presented.

Methods for realizing this include, for example, a method in which, if a single user has a management authority to a resource with difficulty in matching the condition, the user is set as a user as a presentation target of the information, while if a plurality of users have management authority to the resource with difficulty in matching the condition, the higher-order user of the user is specified, and if there is a higher-order user, the higher-order user is set as a presentation target user of the information, while if there is no higher-order user, the plurality of users are set as presentation target users of the information. By configuring as above, the information of the resource with difficulty in matching the condition designated by the user can be presented to an appropriate user.

### D. Fourth Embodiment

### Configuration of Computer System

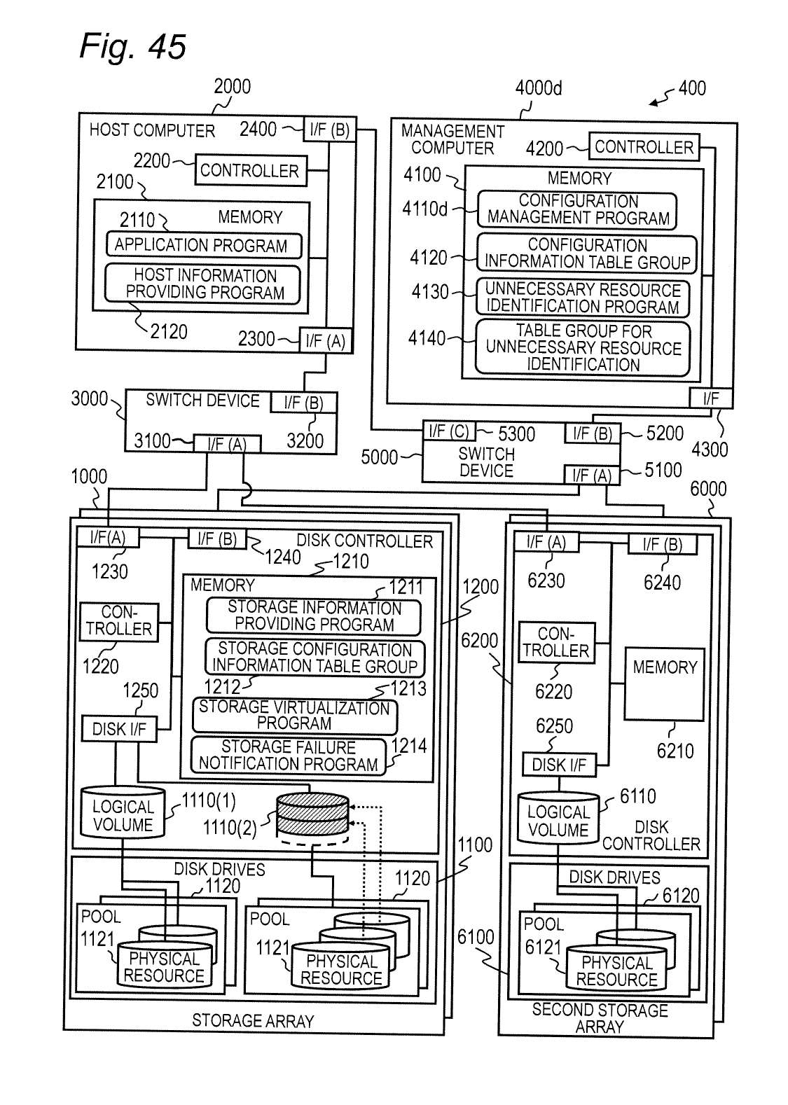

FIG. 45 is a diagram illustrating a schematic configuration of a computer system 400 according to a fourth embodiment of the present invention. The computer system 400 includes the storage arrays 1000, the host computer 2000, the switch device 3000, a management computer 4000d, the switch device 5000, and the second storage arrays 6000.

In the figure, there are two storage arrays 1000 and one host computer 2000, one switch device 3000, one management computer 4000d, and one switch device 5000, but the number of the devices is not limited as above and may be any as long as there is one or more each. Moreover, in the figure, there are two second storage arrays 6000, the number of the devices is not limited as above and may be three or more.

Since most of this configuration is equal to the configuration of the first embodiment, a difference will be described below. A difference from the computer system 100 illustrated in FIG. 1 is a processing sequence of the configuration management program 4110d of the management computer 4000d.

<Contents of Data Processing>

Since most of the processing in this embodiment is equal to the processing contents of the first embodiment, only a difference will be described below. A difference between the data processing in the first embodiment and the data processing in this embodiment is a processing sequence in which the configuration management program 4110d searches a free resource from the resources of the storage array 1000 and the second storage array 6000. This difference will be described below.

<Search Processing of Free Resource 6>

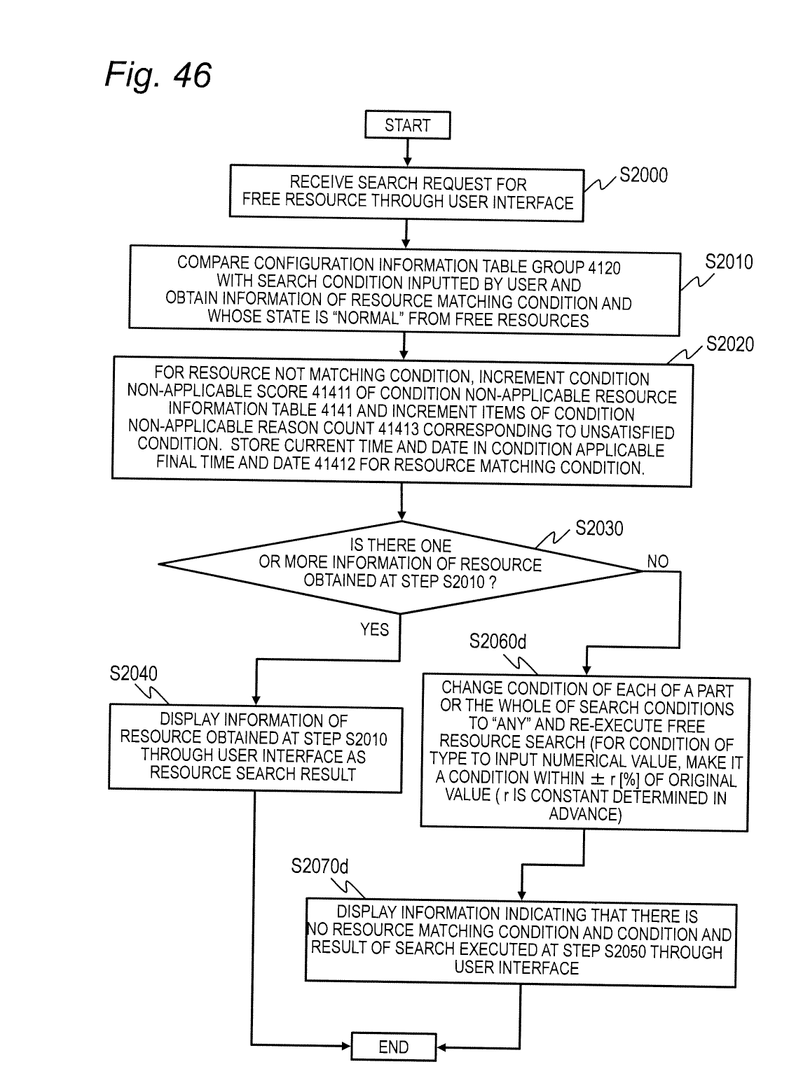

FIG. 46 is a flowchart for explaining an example of processing when the configuration management program 4110d searches a free resource from the resources of the storage array 1000 and the second storage array 6000 in this embodiment. Since most of the processing in FIG. 46 is similar to the processing in FIG. 16, only a difference from the processing in FIG. 16 will be described.

In FIG. 46, at Step S2030, if it is determined that there is no information of the one or more resources obtained at Step S2010, the configuration management program 4110d proceeds to Step S2060d.

At Step S2060d, the configuration management program 4110d re-executes a free resource search by changing the conditions of a part of or the whole of the search conditions to “ANY”. However, for the condition of the type in which a numeral value is inputted, a search is re-executed on condition within ±r[%] (r is a constant determined in advance) of the original value.

Subsequently, at Step S2070d, the configuration management program 4110d displays the information indicating that there is no resource matching the condition inputted at Step S2000 and the search condition and the result of the search executed at Step S2050 via the user interface.

<Example of User Interface Relating to Search for Free Resource>

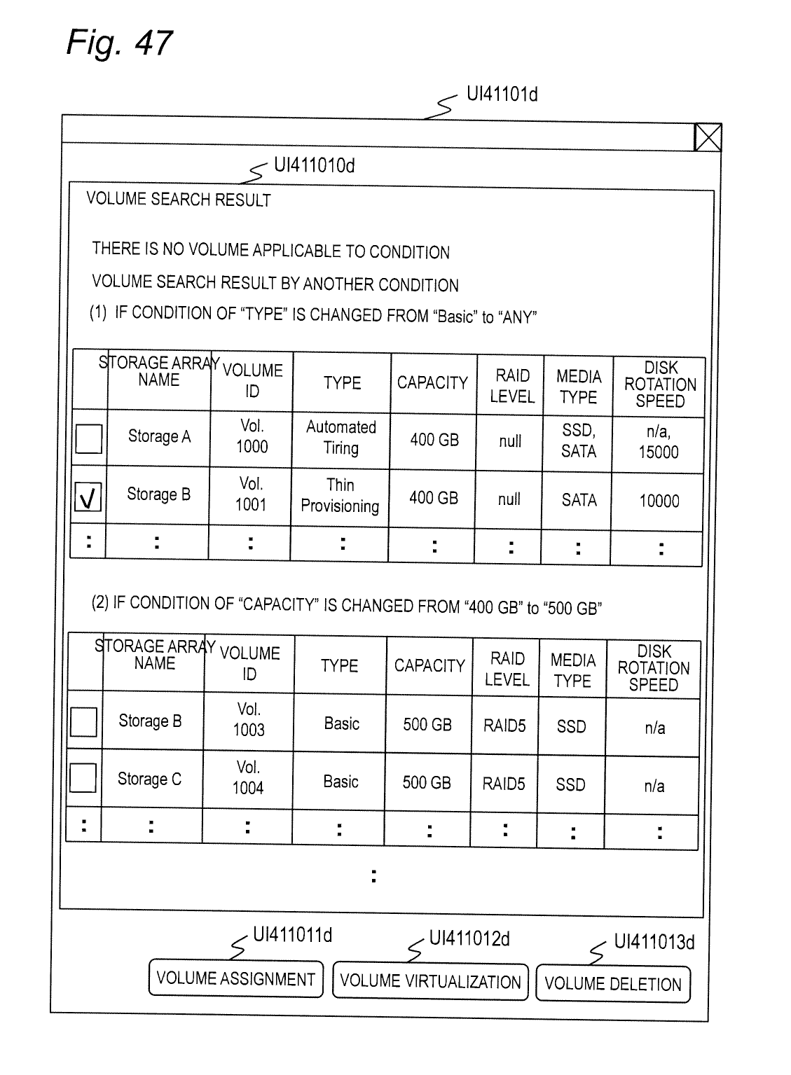

FIG. 47 is a diagram illustrating a configuration example of the user interface of the configuration management program 4110d in the fourth embodiment. FIG. 47 corresponds to a user interface indicating a result of a search for the logical volume.

In FIG. 47, a user interface UI41101d indicating a search result of the logical volume includes, as constituent elements, an area UI411010d for indicating a search result of the logical volume, a button UI411011d for instructing assignment of the logical volume to the host computer, a button UI411012d for instructing virtualization of the logical volume, and a button UI411013d for instructing deletion of the logical volume.

In FIG. 47, the area UI411010d for indicating the search result of the logical volume has an area indicating a message indicating that there is no resource matching the condition inputted by the user and a result obtained by re-execution of the free-resource search by changing a part of or the whole of the search conditions.

The area UI411010d indicating a search result of a logical volume is not limited to the expressions in FIG. 47 but may display information indicating that there is no resource matching the condition inputted by the user and other types of information indicating a result of the free-resource search re-executed with changing apart of or the whole of the search conditions. Moreover, the area UI411010d illustrating a search result of the logical volume may include a button for instructing execution of other configuration operation to the logical volume.

<Conclusion>

In the embodiments of the fourth embodiment, when the management computer searches an available resource matching the condition designated by a user (administrator) from the resources of the storage arrays, if there is no resource matching the condition, the management computer executes a search for a resource again by using a search condition of the case where the conditions are not designated or a search condition of the case where a value to be designated to each condition is changed within a range determined in advance (hereinafter noted as a neighborhood condition) for a part of or the whole of one or more designated conditions.

Moreover, the management computer displays on a screen a neighborhood condition and a result of a resource search by the neighborhood condition together with information indicating that there is no available resource matching the condition designated by the user via the user interface relating to the display of a search result. By performing as above, the user can easily find an available alternative resource and thus, utilization efficiency of the resource of the storage array can be improved.

### D. Fifth Embodiment

### Configuration of Computer System

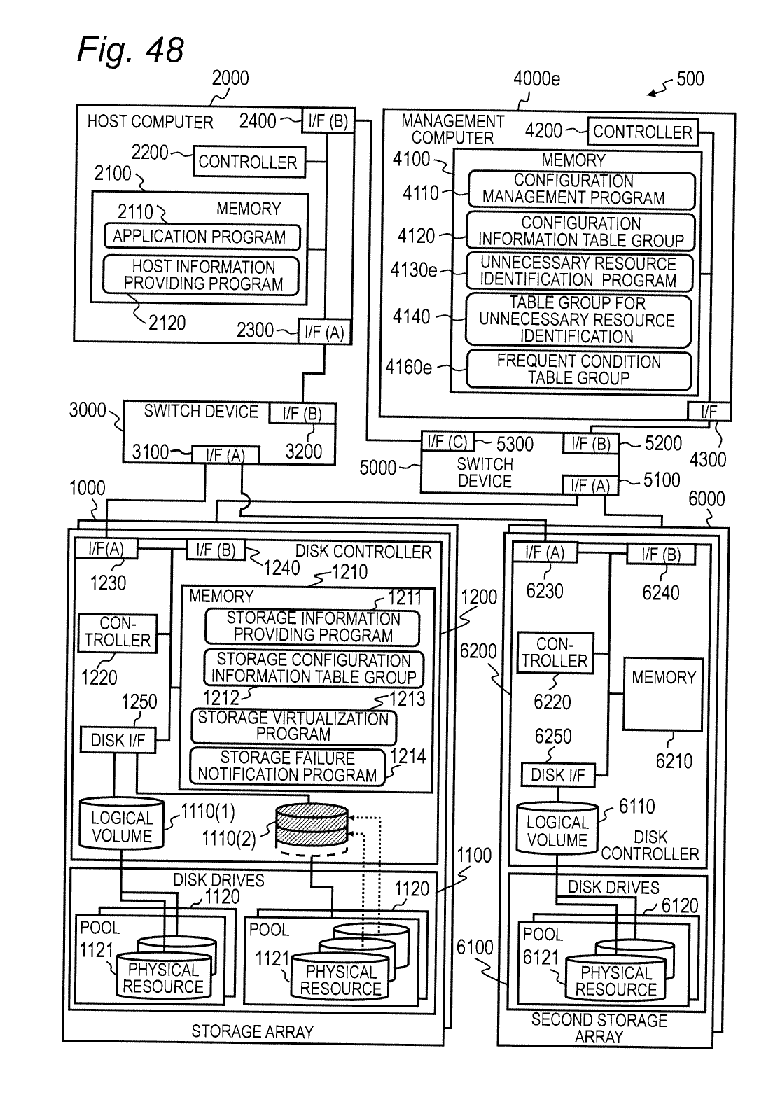

FIG. 48 is a diagram illustrating a schematic configuration of a computer system 500 according to a fifth embodiment of the present invention. The computer system 500 includes the storage array 1000, the host computer 2000, the switch device 3000, a management computer 4000e, the switch device 5000, and the second storage array 6000.

In the figure, there are two storage arrays 1000 and one host computer 2000, one switch device 3000, one management computer 4000e, and one switch device 5000, but the number of the devices is not limited as above and may be any as long as there is one or more each. Moreover, in the figure, there are two second storage arrays 6000, but the number of the devices is not limited as above and may be three or more. Since most of this configuration is equal to the configuration of the first embodiment, a difference will be described below.

Difference from the computer system 100 illustrated in FIG. 1 are a processing sequence of an unnecessary resource specification program 4130e of the management computer 4000e and that the management computer 4000e includes a frequent appearance condition table group 4160e.

<Frequent Appearance Condition Table Group>

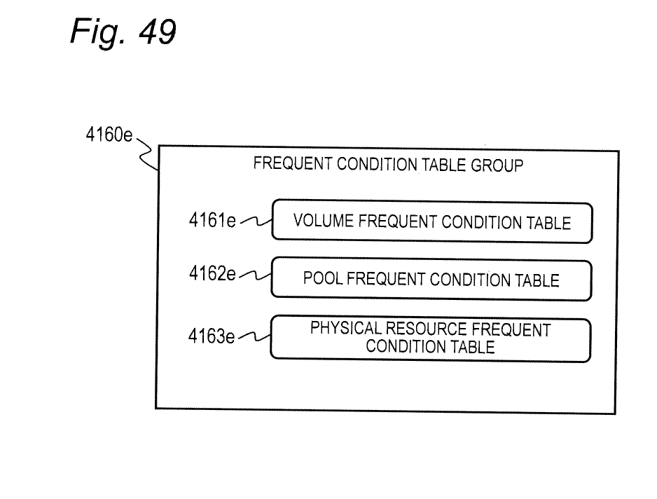

FIG. 49 is a diagram illustrating a configuration example of the frequent appearance condition table group 4160e in the fifth embodiment. In this embodiment, the frequent appearance condition table group 4160e includes a volume frequent appearance condition table 4161e, a pool frequent appearance condition table 4162e, and a physical resource frequent appearance condition table 4163e.

The volume frequent appearance condition table 4161e is a table for storing a condition which has ever been designated in a free resource search relating to the logical volume. The pool frequent appearance condition table 4162e is a table for storing a condition which has ever been designated in a free resource search relating to a pool. The physical resource frequent appearance condition table 4163e is a table for storing a condition which has ever been designated in a free resource search relating to a physical resource.

<Configuration Example of Volume Frequent Appearance Condition Table>

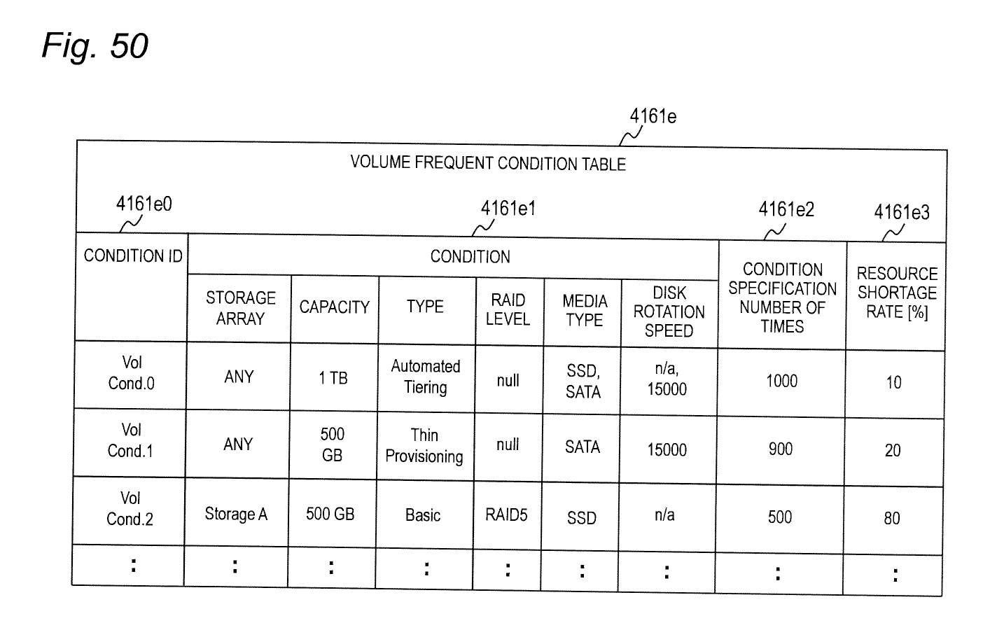

FIG. 50 is a diagram illustrating a configuration example of the volume frequent appearance condition table 4161e in the fifth embodiment. The volume frequent appearance condition table 4161e includes, as configuration items, a condition ID 4161e0 for identifying a condition, a condition 4161e1, a condition designation number of times 4161e2 indicating the number of times of designation of the condition, and a resource shortage rate 4161e3 indicating a ratio of not finding a resource matching the condition when a search is executed by designating a condition. The condition 4161e1 is not limited to the expressions in FIG. 50 but may be any condition as long as it is for search for a logical volume.

<Configuration Example of Pool Frequent Appearance Condition Table>

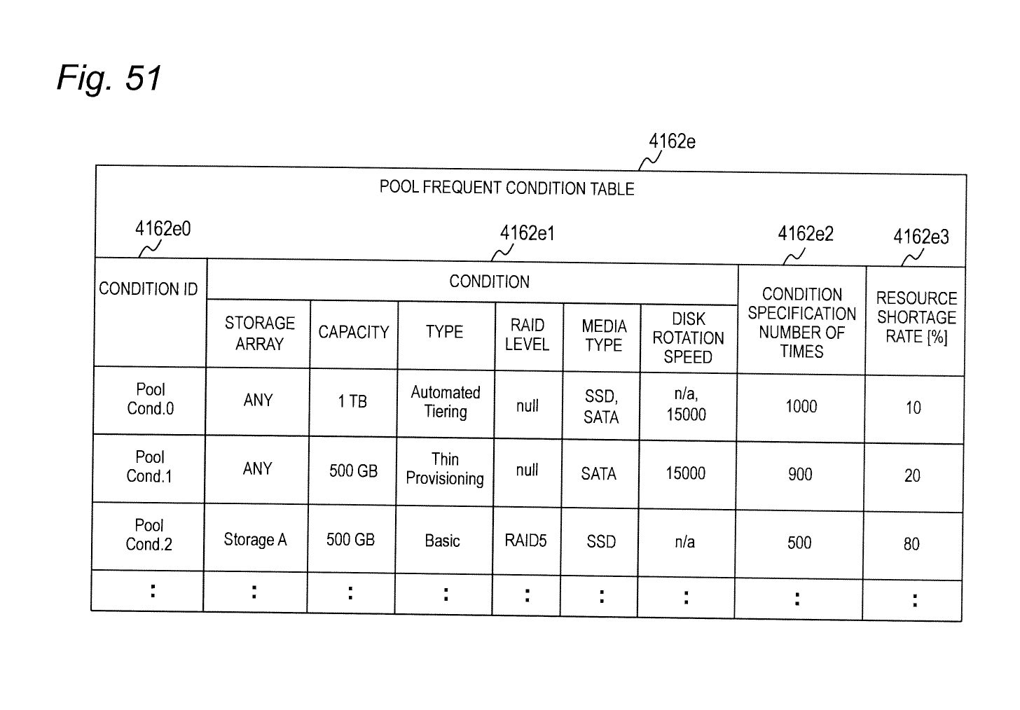

FIG. 51 is a diagram illustrating a configuration example of the pool frequent appearance condition table 4162e in the fifth embodiment. Since the configuration of the pool frequent appearance condition table 4162e is similar to the configuration of the volume frequent appearance condition table 4161e, the explanation will be omitted.

<Configuration Example of Physical Resource Frequent Appearance Condition Table>

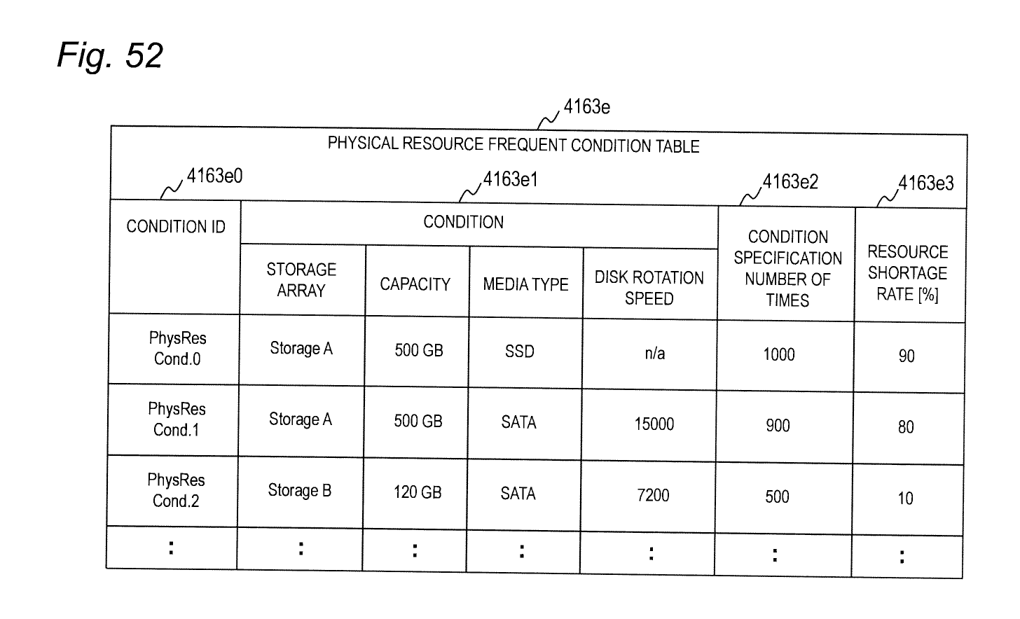

FIG. 52 is a diagram illustrating a configuration example of the physical resource frequent appearance condition table 4163e in the fifth embodiment. Since the configuration of the physical resource frequent appearance condition table 4163e is similar to the configuration of the volume frequent appearance condition table 4161e, the explanation will be omitted.

<Details of Data Processing>

Since most of the processing in this embodiment is equal to the processing contents of the first embodiment, a difference will be described below. A difference between the data processing in the first embodiment and the data processing in this embodiment is the processing in which the unnecessary resource specification program 4130e specifies a resource hardly matching the condition designated by a user from the resources of the storage array 1000 and the second storage array 6000. This difference will be described below.

<Identification Processing 4 of Unnecessary Resource>

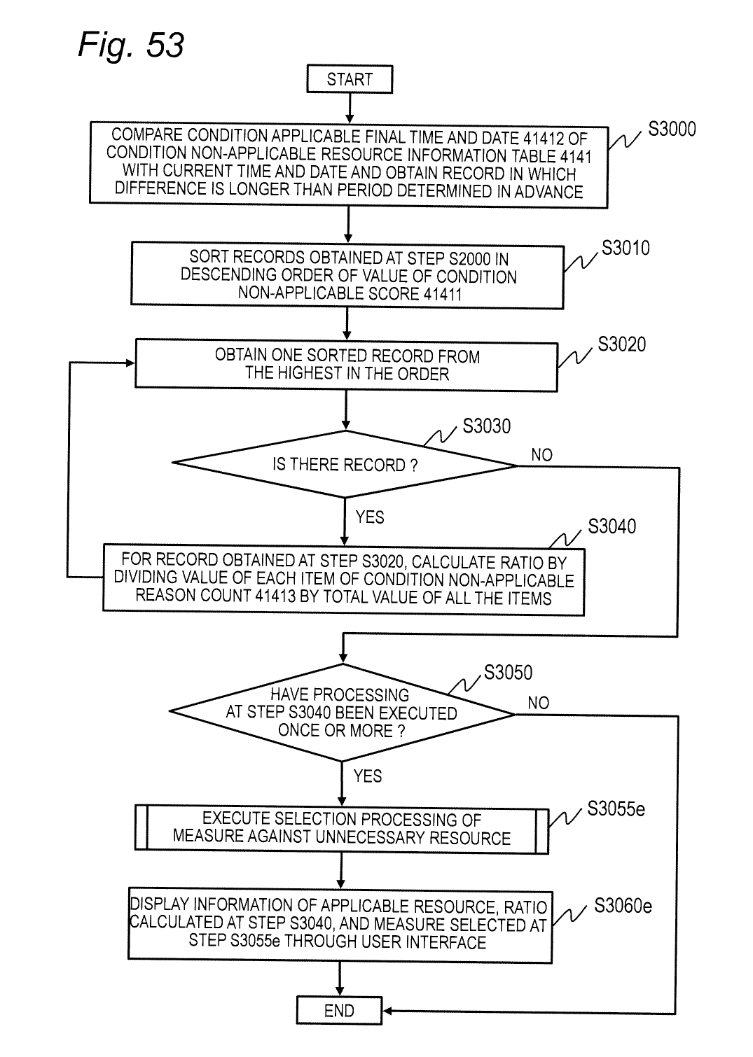

FIG. 53 is a flowchart for explaining processing when the unnecessary resource specification program 4130e specifies a resource hardly matching the condition designated by a user from the resources of the storage array 1000 and the second storage array 6000 in the fifth embodiment. Since most of the processing in FIG. 53 is similar to the processing in FIG. 24, a difference from the processing in FIG. 24 will be described.

In FIG. 53, if it is determined at Step S3050 that the processing at Step S3040 has been executed once or more, the unnecessary resource specification program 4130e proceeds to Step S3055e. At Step S3055e, the unnecessary resource specification program 4130e executes selection processing of a measure for the unnecessary resource. The contents of the processing will be described later.

Finally, at Step S3060e, the unnecessary resource specification program 4130e displays information of the applicable resource, a ratio calculated at Step S3040, and a measure selected at Step S3055e via the user interface. At Step S3060e, the measure selected at Step S3055e may be automatically executed by the configuration management program 4110.

<Selection Processing of Measure for Unnecessary Resource>

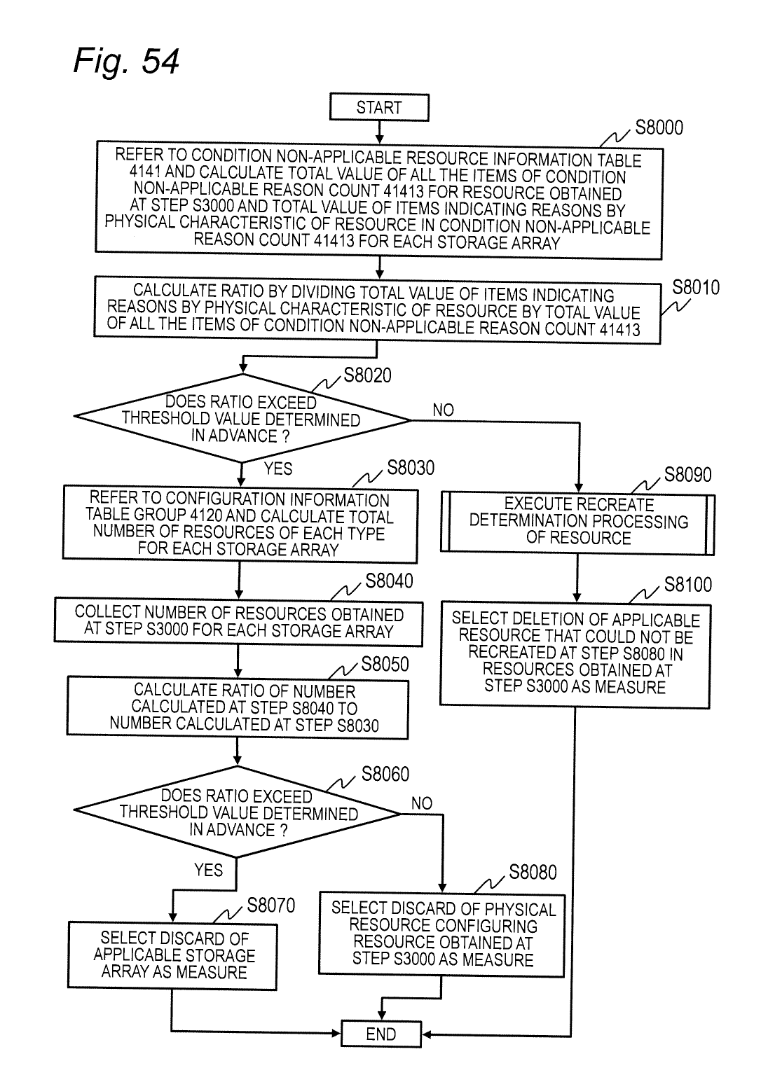

FIG. 54 is a flowchart for explaining processing when the unnecessary resource specification program 4130e selects a measure for improving utilization efficiency of a resource for the resource hardly matching the condition designated by a user in the fifth embodiment.

First, at Step S8000, the unnecessary resource specification program 4130e refers to the condition non-applicable resource information table 4141 and calculates a total value of all the items of the condition non-applicable reason count 41413 and a total value of the item indicating a reason (“media type=SATA”, “disk rotation speed slow” and the like) due to the physical characteristics of the resource in the condition non-applicable reason count 41413 for each storage array for the resources obtained at Step S3000.

The relationship between the resource and the storage array is found out by, if the resource is a logical volume, for example, comparing the resource ID 41410 of the condition non-applicable resource information table 4141 with the volume ID 41220 of the volume information table 4122 and obtaining the storage ID 41221 of the volume information table 4122 for a record in which these ID match. The same applies to the other resources such as a pool and a physical resource.

Subsequently, at Step S8010, the unnecessary resource specification program 4130e calculates a ratio by dividing a total value of the items indicating a reason due to the physical characteristic of the resource in the condition non-applicable reason count 41413 by a total value of all the items of the condition non-applicable reason count 41413. Subsequently, at Step S8020, the unnecessary resource specification program 4130e determines whether or not the ratio calculated at Step S8010 exceeds a threshold value determined in advance. If the threshold value is exceeded, the processing is made to proceed to Step S8030. If the threshold value is not exceeded, the processing is made to proceed to Step S8090.

At Step S8030, the unnecessary resource specification program 4130e refers to the configuration information table group 4120 and calculates the total number of resources of each type (logical volume, pool, physical resource and the like) for each storage array.

Subsequently, at Step S8040, the unnecessary resource specification program 4130e collects the number of resources obtained at Step S3000 in FIG. 53 for each storage array. Subsequently, at Step S8050, the unnecessary resource specification program 4130e calculates a ratio of the number calculated at Step S8040 to the number calculated at Step S8030.

Subsequently, at Step S8060, the unnecessary resource specification program 4130e determines whether or not the ratio calculated at Step S8050 exceeds a threshold value determined in advance. If the threshold value is exceeded, the processing is made to proceed to Step S8070. If the threshold value is not exceeded, the processing is made to proceed to Step S8080.

At Step S8070, the unnecessary resource specification program 4130e selects discard of the applicable storage array as a measure. At Step S8080, the unnecessary resource specification program 4130e selects discard of the physical resource configuring the resource obtained at Step S3000 in FIG. 53 as a measure. If the resource obtained at Step S3000 in FIG. 53 is the physical resource itself, discard of this can be employed as a measure.

Here, the unnecessary resource specification program 4130e refers to the physical resource frequent appearance condition table 4163e, calculates a value obtained by multiplying the value of the condition designation number of times 4163e2 by the resource shortage rate 4163e3 and by dividing the result by the constant 100, and obtains “capacity”, “media type”, and “disk rotation speed” of the condition 4163e1 for the physical resource whose value is the largest, and introduction of the physical resource matching the “capacity”, “media type”, and “disk rotation speed” instead of the physical resource to be discarded may be added as a measure.

At Step S8090, the unnecessary resource specification program 4130e executes resource remake determination processing. The contents of this processing will be described later. Finally, at Step S8100, the unnecessary resource specification program 4130e selects deletion of the resource which could not be remade at Step S8090 in the resources obtained at Step S3000 in FIG. 53 as a measure.

By performing as above, in the fifth embodiment, the processing in which the unnecessary resource specification program 4130e selects a measure for improving the utilization efficiency of the resource to the resource hardly matching the condition designated by the user is completed.

In the flow in FIG. 54, a part of the steps may be omitted. For example, Steps S8090 and S8100 may be omitted or Steps from S8030 to S8080 may be omitted.

<Resource Remake Determination Processing>

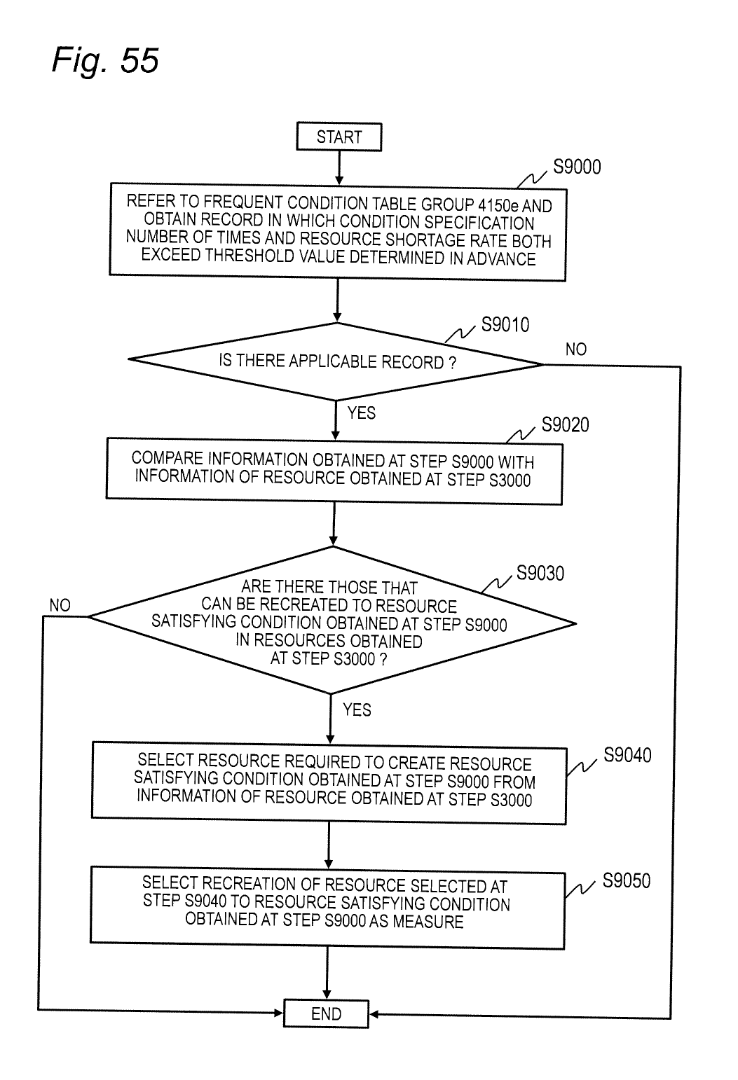

FIG. 55 is a flowchart for explaining processing (Step S8090) when the unnecessary resource specification program 4130e determines remaking of the applicable resource to a resource with another configuration as a measure for improving the utilization efficiency of the resource for the resource hardly matching the condition designated by the user in the fifth embodiment.

First, at Step S9000, the unnecessary resource specification program 4130e refers to the table group 4150e and obtains a record in which the condition designation number of times and the resource shortage rate both exceed threshold values determined in advance. Subsequently, at Step S9010, the unnecessary resource specification program 4130e determines whether or not there is an applicable record.

If there is a record (Step S9010: YES), the program proceeds to Step S9020. If there is no record (Step S9010: NO), this flow is finished.

Subsequently, at Step S9020, the unnecessary resource specification program 4130e compares the information obtained at Step S9000 with the information of the resource obtained at Step S3000 in FIG. 53.

Subsequently, at Step S9030, it is determined whether or not there is a resource that can be remade to a resource satisfying the condition obtained at Step S9000 in the resources obtained at Step S3000 in FIG. 53. If there is a resource that can be remade to a resource satisfying the condition obtained at Step S9000 (Step S9030: YES), it is moved to Step S9040. If there is no resource that can be remade to a resource satisfying the condition obtained at Step S9000 (Step S9030: NO), this flow is finished.

Subsequently, at Step S9040, the unnecessary resource specification program 4130e selects a resource required to create a resource satisfying the condition obtained at Step S9000 from the information of the resource obtained at Step S3000 in FIG. 53. Finally, at Step S9050, the unnecessary resource specification program 4130e selects remaking of the resource selected at Step S9040 to a resource satisfying the condition obtained at Step S9000 as a measure.

Through the above-described processing, the processing is completed in which the unnecessary resource specification program 4130e determines remaking of the resource hardly matching the condition designated by the user to a resource with another configuration as a measure for improving the utilization efficiency of the resource.

Here, a specific example of remaking of a resource obtained at Step S3000 in FIG. 53 to a resource satisfying the condition obtained at Step S9000 will be described.

(i) Example of Remaking of Logical Volume to Logical Volume with Large Capacity

The unnecessary resource specification program 4130e extracts all the information of the logical volume with the largest value (hereinafter noted as remaking target volume information) in the item of “capacity is small” in all the items in the condition non-applicable reason count 41413 of the condition non-applicable resource information table 4141, targeting the information of all the logical volumes obtained at Step S3000 in FIG. 53.

Subsequently, the unnecessary resource specification program 4130e extracts all the information of the logical volume with the type of “Basic” in the remaking target volume information by referring to the configuration information table group 4120. Moreover, the unnecessary resource specification program 4130e refers to the configuration information table group 4120 and groups the information of the applicable volume so that the storage ID, the pool ID, the RAID level, the media type, and the disk rotation speed become the same. Finally, the unnecessary resource specification program 4130e remakes the whole of or a part of the logical volume for each group to a logical volume with a large capacity.

Methods of remaking some logical volumes into a logical volume with a large capacity include a method in which, after the capacity assigned to a logical volume is returned to a free capacity of a pool by deleting some logical volumes, a logical volume with a desired capacity is newly created from the applicable pool and a method of realizing that by using a capacity expanding function of the logical volume of the storage array, but they are not limiting.

Moreover, methods of determining the size of a desired capacity include a method in which the volume frequent appearance condition table 4161e is referred to, a value is calculated by multiplying the value of the condition designation number of times 4161e2 by the value of the resource shortage rate 4161e3 and dividing the result by the constant 100 for the logical volume with the value of “type” in the condition 4161e1 is “Basic”, and the value of the “capacity” of the condition 4161e1 of a record in which the applicable value is the largest is determined to be a desired capacity.

In this case, it is possible to use as a target only those whose “RAID level”, “media type”, and “disk rotation speed” of the condition 4161e1 match the “RAID level”, “media type”, and “disk rotation speed” of the remaking target volume information as a target.

(ii) Example of Remaking of Capacity of Logical Volume to Free Capacity of Pool

The unnecessary resource specification program 4130e refers to the pool frequent appearance condition table 4162e, calculates a value obtained by multiplying the value of the condition designation number of times 4162e2 by the value of the resource shortage rate 4162e3 and by dividing the result by the constant 100 for the pool whose value of “type” of the condition 4162e1 is “Automated Tiering” and obtains the “RAID level”, “media type”, and “disk rotation speed” of the pool whose applicable value is the largest (hereinafter noted as capacity expansion target pool).

Subsequently, the unnecessary resource specification program 4130e obtains the information of all the logical volumes matching the “RAID level”, “media type”, and “disk rotation speed” of the capacity expansion target pool from the information of all the logical volumes obtained at Step S3000 in FIG. 53. Finally, the unnecessary resource specification program 4130e remakes the whole of or a part of the applicable logical volume to a free capacity of the capacity expansion target pool.

Methods of remaking the logical volume to a free capacity of a capacity expansion target pool include, in the case of a storage array in which the pool is comprised of a logical volume, for example, a method of adding a logical volume to a pool. Moreover, in the case of a storage array in which a pool comprises a physical resource, there is a method of adding a physical resource (physical storage area) configuring the applicable pool to a capacity expansion target pool by deleting the logical volume and then deleting a pool of a cut-out source of the logical volume.

Since another logical volume is cut out of the pool of a cut-out source of the logical volume, there can be a case where the applicable pool cannot be deleted. In such a case, the applicable pool can be deleted after another logical volume is migrated to another pool by using a volume migration function of the storage array.

The volume migration function is a function of migrating data stored in the logical volume to another logical volume without changing a configuration of an I/O access path in a host computer using a logical volume of the storage array. The volume migration function first copies data from a logical volume to another logical volume and then, deletes the data in the logical volume of the copy source.

Address management of data at a copy source and a copy destination is processed by an address management program of the storage array. In the case of an access to the address from the host computer during data migration, if it is a data reading request, an access processing program provides data of an address managed by the address management program to a host. If it is data writing, the writing data is held in a cache memory and the data is written in a logical volume of a migration destination later. By performing the above-described processing, replacement of the logical volumes is realized.

Moreover, in order to remake the logical volume 6110 of the second storage array 6000 to a free capacity of the capacity expansion target pool 1120 of the storage array 1000, there is a method in which the logical volume 6110 of the second storage array 6000 is virtualized to the storage array 1000 by using the storage virtualization program 1213 of the storage array 1000, for example, and the capacity is added to the capacity expansion target pool.

<Example of User Interface Relating to Display of Unnecessary Resource>

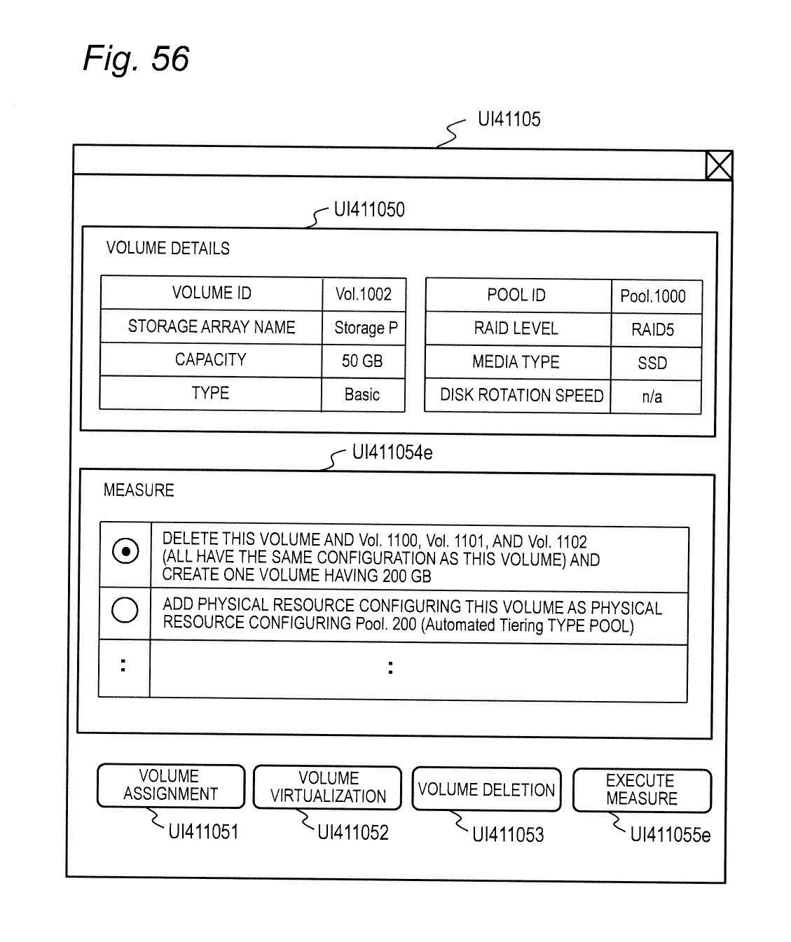

FIG. 56 is a diagram illustrating a configuration example of the user interface of the unnecessary resource specification program 4130e according to the fifth embodiment. FIG. 56 corresponds to the user interface for indicating detailed information of an unnecessary resource candidate and a measure for improving utilization efficiency of the resource.

The user interface in FIG. 56 is the one expanded from the user interface in FIG. 26 so that a measure for improving the utilization efficiency of the resource is displayed. The user interface in FIG. 56 can be called via a link configured in the ID of a resource in the list UI411040 of the unnecessary resource candidates illustrated in FIG. 25 similarly to the user interface in FIG. 26.

In FIG. 56, the user interface UI41105 which displays a list of unnecessary resource candidates includes an area UI411050 for indicating details of a logical volume and an area UI411054e for indicating a measure for improving utilization efficiency of the resource.

The user interface UI41105 further includes, as constituent elements, a button UI411051 for instructing assignment of a logical volume to the host computer, a button UI411052 for instructing virtualization of the logical volume, a button UI411053 for instructing deletion of the logical volume, and a button UI411055e for instructing execution of a measure indicated on the area UI411054e for indicating a measure for improving the utilization efficiency of the resource.

Since an area UI411050 for indicating the details of the logical volume, a button UI411051 for instructing assignment of the logical volume to the host computer, a button UI411052 for instructing virtualization of the logical volume, and a button UI411053 for instructing deletion of the logical volume are similar to those in FIG. 26, the explanation will be omitted.

The area UI411054e for indicating a measure for improving the utilization efficiency of the resource includes a button for selecting a measure and an area for indicating the contents of a measure as constituent elements. In the area for indicating the contents of a measure, a measure determined to be feasible by processing illustrated in FIGS. 54 and 55 is indicated.

The button UI411055e for instructing execution of a measure indicated in the area UI411054e for indicating the measure for improving the utilization efficiency of the resource is a button for instructing execution of the measure selected by the user in the area UI411054e for indicating the measure for improving the utilization efficiency of the resource via the configuration management program 4110.

<Conclusion>

In the fifth embodiment, the management computer records the number of accumulated times for each search condition designated by the user and a ratio that the resource matching the condition does not exist as the result of a search for the resource on the basis of the condition. The management computer specifies a resource having a high frequency of being searched and a good possibility of not existing (hereinafter noted as insufficient resource) on the basis of the information.

The management computer determines a measure for making the management cost and the utilization efficiency of the resource proper on the basis of information of a resource having difficulty in matching the condition designated by the user and the insufficient resource. Methods of realizing this may be remaking of a resource having difficulty in matching the condition to an insufficient resource or deletion of a resource having difficulty in matching the condition, for example.

In the case of a logical volume, for example, one or more logical volumes having difficulty in matching the condition due to a small capacity may be deleted and a new logical volume may be generated in accordance with the capacity of the insufficient logical volume.

Moreover, if a free capacity of a pool is insufficient, a logical volume cut out of the pool may be deleted, a physical resource released by deletion of another pool may be added to the pool, or a logical volume of another storage array is virtualized as a capacity of the storage array including the pool and this may be added to the pool.

Furthermore, when a pool is to be remade to another configuration, if the pool cannot be remade due to a reason that the logical volume cut out of the pool is used by the host computer or the like, the logical volume may be migrated to another pool by using a volume migration technology and then, the configuration of the pool may be remade.

Moreover, in the case of a resource having difficulty in matching the condition due to a physical characteristic of the resource, a measure can be taken that the physical resource configuring the resource is discarded. Moreover, if a ratio of such a resource occupying in all the resources of the storage array is large, discard of the storage array may be employed as a measure.

(6) Others

The present invention can be also realized by a program code of software realizing the functions of the embodiments. In this case, a storage medium recording the program code is provided to the system or the device, and a computer (or a CPU or a MPU) of the system or the device reads out the program code stored in the storage medium.

In this case, the program code itself read out of the storage medium realizes the functions of the above-described embodiments, and the program code itself and the storage medium storing it configure the present invention. As a storage medium for providing such a program code, a flexible disk, a CD-ROM, a DVD-ROM, a hard disk, an optical disk, a magneto-optical disk, a CD-R, a magnetic tape, a non-volatile storage card, a ROM and the like are used, for example.

Moreover, OS (operating system) running on the computer may execute a part of or the whole of the actual processing on the basis of an instruction of the program code so that the functions of the above-described embodiments are realized by the processing. Furthermore, after the program code read out of the storage medium is written in the memory on the computer, the CPU of the computer or the like may execute a part of or the whole of the actual processing so as to realize the functions of the above-described embodiments by the processing on the basis of an instruction of the program code.

Moreover, by distributing the program code of the software for realizing the functions of the embodiments via a network, the program code may be stored in storage means such as a hard disk, memory and the like of the system or the device or a storage medium such as CD-RW, CD-R and the like so that the computer (or the CPU or the MPU) of the system or the device reads out and execute the program code stored in the storage means or the storage medium.

Finally, it should be understood that the process and technology described herein do not substantially relate to any specific device but can be implemented in any appropriate combination of components. Furthermore, various types of general-purpose devices can be used in accordance with teaching described herein.

It might be understood that construction of a dedicated device is advantageous in executing steps of the methods described here. Moreover, various inventions can be formed by appropriate combinations of the plurality of constituent elements disclosed in the embodiments. For example, some constituent elements may be deleted from all the constituent elements illustrated in the embodiments.

Furthermore, the constituent elements across the different embodiments may be combined as appropriate. The present invention has been described in relation with the specific examples but these are not for limitation but for explanation from all the viewpoints. Those skilled in this field may understand that there are a large number of combinations of appropriate hardware, software, and firmware in putting the present invention into practice. For example, the above-described software can be implemented with a wide range of programs or script languages such as assembler, C/C++, perl, Shell, PHP, Java (registered trademark) and the like.

Moreover, in the above-described embodiments, the control lines and information lines considered to be necessary in explanation are illustrated and all the control lines or information lines on the product are not necessarily illustrated. All the configurations may be mutually connected.

In addition, other implementations of the present invention will be made obvious for those ordinarily skilled in this technical field from observation on the designation and embodiments of the present inventions disclosed here. The various aspects and/or components of the described embodiments can be used singularly or in any combination in a computerized storage system having the function of managing data. The specification and specific examples are only typical ones and the scope and spirit of the present invention will be made clear in the appended claims.

### REFERENCE SIGNS LIST

1000 storage array
1100 disk drives
1110 logical volume
1120 pool
1121 physical resource
1200 disk controller
1210 memory
1211 storage information providing program
1212 storage configuration information table group
1213 storage virtualization program
1214 storage failure notification program
1220 controller
1230, 2300 interface (I/F)(A)
1240 interface (I/F)(B)
1250 disk interface (disk I/F)
2000 host computer
2100 memory
2110 application program
2120 host information providing program
2200 controller
2300 interface (I/F)(A)
2400 interface (I/F)(B)
3000 switch device
3100 interface (I/F)(A)
3200 interface (I/F)(B)
4000, 4000b, 4000c, 4000d, 4000e management computer
4100 memory
4110, 4110b, 4110d configuration management program
4120 configuration information table group
4121 storage information table
4122 volume information table
4123 pool information table
4124 physical resource information table
4125 pool/resource related information table
4126 host information table
4127 volume assignment information table
4130, 4130b, 4130c, 4130e unnecessary resource specification program
4140, 4140b table group for unnecessary resource specification
4141 condition non-applicable resource information table
4142b management operation execution frequency table
4143b condition non-applicable number of times table for each management operation
4144b unnecessary resource determination threshold value table
4150c management authority information table group
4151c user information table
4152c resource group information table
4153c resource/resource group correspondence information table
4154c user/resource group correspondence information table
4160e frequent appearance condition table group
4161e volume frequent appearance condition table
4162e pool frequent appearance condition table
4163e physical resource frequent appearance condition table
4200 controller
4300 interface (I/F)
5000 switch device
5100 interface (I/F)(A)
5200 interface (I/F)(B)
5300 interface (I/F)(C)
6000 second storage array
6100 disk drives
6110 logical volume
6120 pool
6121 physical resource
6200 disk controller
6210 memory
6220 controller
6230 interface (I/F)(A)
6240 interface (I/F)(B)
6250 disk interface (disk I/F)

What is claimed is:

1. A computer system comprising:
one or more storage arrays providing a plurality of storage resources; and
a management system managing the one or more storage arrays,
wherein the management system stores configuration information of the plurality of storage resources,
wherein the management system specifies a non-applicable free storage resource for a configuration condition including one or more predesignated condition items in response to a predesignated event and records information of the specified free storage resource and a non-applicable reason in condition non-applicable storage resource information,
wherein the management system repeats the specifying and the recording in response to the predesignated event, and
wherein the management system selects a free storage resource applicable to a predesignated unnecessary storage resource condition from the condition non-applicable storage resource information after the repetition as an unnecessary storage resource candidate.

2. A computer system according to claim 1,
wherein the management system executes the specifying and the recording in a search for a free storage resource applicable to the configuration condition, which is the predesignated event.

3. A computer system according to claim 2,
wherein the management system stores failure management information managing a failure situation of the plurality of storage resources,
wherein the management system executes the specifying and the recording regardless of presence of a failure, and
wherein the management system presents a free storage resource applicable to the configuration condition to a user excluding storage resources in which a failure occurs.

4. A computer system according to claim 2,
wherein the configuration condition includes indispensable condition items and optional condition items which can be selected by a user,
wherein different weights are defined for the indispensable condition items and the optional condition items,
wherein the management system calculates a non-applicable score indicating a degree of difficulty in satisfying the configuration condition based on the number of non-applicable indispensable condition items, the number of non-applicable optional condition items and the different weights for each free storage resource not applicable to the configuration condition in the repeated search and records the non-applicable score in the condition non-applicable storage resource information, and
wherein the management system executes at least one of selection of the unnecessary storage resource candidate based on the non-applicable score and presentation of the non-applicable score to the user.

5. A computer system according to claim 2,
wherein the management system calculates a non-applicable score indicating a degree of difficulty in satisfying the configuration condition for each storage resource not applicable to the configuration condition in the repeated search based on the number of other storage resources applicable to each condition item to which a target storage resource is not applicable, and
wherein the management system executes at least one of selection of the unnecessary storage resource candidate based on the non-applicable score and presentation of the non-applicable score to the user.

6. A computer system according to claim 2,
wherein, in executing a plurality of types of management operations by using a storage resource applicable to the configuration condition and usable, the management system records the number of accumulated times of execution of each of the plurality of types of management operations,
wherein the management system records the number of accumulated times of being non-applicable to the configuration condition of each of the plurality of types of management operations for each free storage resource non-applicable to the configuration condition,
wherein the management system calculates a threshold value based on the number of accumulated times of execution of each of the plurality of types of management operations and a ratio of the number of execution times of each of the plurality of types of management operations to the number of accumulated execution times of the plurality of types of management operations,
wherein the management system calculates a score for a first free storage resource non-applicable to the configuration condition based on the number of accumulated times of being non-applicable to each of the configuration conditions of the plurality of types of management operations for the first free storage resource and a ratio of the number of accumulated execution times of each of the plurality of types of the management operations to the number of accumulated execution times of the plurality of types of the management operations for the first free storage resource, and
wherein the unnecessary storage resource condition includes the score exceeding the threshold value.

7. A computer system according to claim 1,
wherein, the management system stores storage resource/user management information managing one or more users having a management authority of the plurality of storage resources and user management information managing users,
wherein the management system refers to the storage resource/user management information and specifies one or more user having the management authority of a free storage resource satisfying the unnecessary storage resource condition,
wherein the management system determines, if a plurality of users have the management authority of the free storage resource satisfying the unnecessary storage resource condition, whether or not there is a higher-order user of the plurality of users by referring to the user management information,
wherein the management system determines the higher-order user as a user to whom the free storage resource information satisfying the unnecessary storage resource condition is presented in a case where there is the higher-order user,
wherein the management system determines the plurality of users as users to which the free storage resource information satisfying the unnecessary storage resource condition is presented in a case where there is no higher-order user, and
wherein the management system presents information of the free storage resource satisfying the unnecessary storage resource condition to the determined user to which the information is presented.

8. A computer system according to claim 2,
wherein, the management system changes the configuration condition in a case where a free storage resource applicable to the configuration condition is not found in the search and searches for a free storage resource applicable to the changed configuration condition, and
wherein, the management system presents the changed configuration condition and the result of the search under the changed configuration condition to a user.

9. A computer system according to claim 1,
wherein, the management system refers to the condition non-applicable storage resource information to determine a measure for free storage resources provided by the one or more storage arrays, and
wherein the management system executes at least one of presentation of the determined measure to a user and execution of the determined measure.

10. A computer system according to claim 9,
wherein, the management system stores number of times information of each of non-applicable reasons of each storage resource in the condition non-applicable storage resource information,
wherein the management system refers to the number of times information of each of the non-applicable reasons of each storage array in the condition non-applicable storage resource information to select a storage array as a discard candidate based on number of times information of a non-applicable reason for a physical characteristic of an unnecessary storage resource candidate of each storage array, and
wherein the management system selects, as the measure, either one of discard of the storage array as a discard candidate and discard of a physical storage resource giving the unnecessary storage resource candidate in the storage array as a discard candidate based on the number of unnecessary storage resource candidates in the storage array as a discard candidate.

11. A computer system according to claim 9,
wherein the predesignated event is a search for a free storage resource applicable to the configuration condition,
wherein the management system records, in the repeated search, the designation number of times of each configuration condition, which is the number of times designated for each configuration condition, and a resource shortage rate, which is a ratio at which an applicable storage resource does not exist in the search for each configuration condition,
wherein the management system species a depleted storage resource based on the recorded designation number of times of each configuration condition and the resource shortage rate,
wherein the management system determines whether or not the depleted storage resource can be created from the unnecessary storage resource candidate based on the configuration information of the unnecessary storage resource candidate in the stored configuration information, and
wherein, if the determination is positive, the management system determines, as the measure, that the depleted storage resource is created from the unnecessary storage resource candidate.

12. A computer system according to claim 11,
wherein the management computer expands a capacity of the unnecessary storage resource candidate to a capacity determined based on the capacity of the depleted storage resource when the depleted storage resource is to be created from the unnecessary storage resource candidate.

13. A computer system according to claim 11,
wherein the management computer deletes one or more storage resources in unnecessary storage resource candidates so as to release a physical storage area and creates the depleted storage resource by using the released physical storage area based on the configuration of the depleted storage resource.

14. A computer system according to claim 11,
wherein, in the plurality of storage arrays, a first storage array has a storage resource virtualization function of virtualizing a storage resource of a second storage array as a storage resource of the first storage array, and
wherein the management computer configures the depleted storage resource on the first storage array by virtualizing one or more storage resources in the unnecessary resource candidates in the second storage array as one or more storage resources in the first storage array.

15. A computer system according to claim 11,
wherein the plurality of storage arrays have a function of migrating data stored in a storage resource to another storage resource, and
wherein the management computer migrates data stored in a first storage resource obstructing creation of the depleted storage resource from a first unnecessary storage resource candidate to a second storage resource and then, releases a physical storage area by deleting the first unnecessary storage resource candidate and the first storage resource, and creates the depleted storage resource by using the released physical storage area based on the configuration of the depleted storage resource.
